(19) United States
(12) Patent Application Publication
(10) Pub. No.: US 2015/0284883 A1
(43) Pub. Date: Oct. 8, 2015

(54) WOVEN MAGNETIC BOARDS

(71) Applicant: Phillip Grotepas, Herriman, UT (US)

(72) Inventor: Phillip Grotepas, Herriman, UT (US)

(21) Appl. No.: 14/510,662

(22) Filed: Oct. 9, 2014

Related U.S. Application Data
(60) Provisional application No. 61/888,870, filed on Oct. 9, 2013.

(51) Int. Cl. D03D 15/00; D06M 15/227; D03D 23/00; H01F 7/02

(52) U.S. Cl. CPC D03D 15/00; H01F 7/02; D06M 15/227; D03D 23/00; D03D 2700/80; D10B 2101/20

(57) ABSTRACT

A woven metallic canvas is disclosed that may include a plurality of horizontal metallic strips disposed within a frame and a plurality of vertical metallic strips disposed within the frame and woven together with the horizontal metallic strips.

### FIELD

This disclosure relates generally to woven magnetic boards.

### SUMMARY

Embodiments described herein include a woven metallic canvas that may include a plurality of horizontal metallic strips disposed within a frame and a plurality of vertical metallic strips disposed within the frame and woven together with the horizontal metallic strips. The plurality of horizontal metallic strips and/or the plurality of vertical metallic strips may be oxidized and/or rust treated.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1 illustrates a configuration of a magnet board according to at least one embodiment described herein.

FIG. 1A illustrates a different view of the magnet board illustrated in FIG. 1.

FIG. 1B illustrates a backside or under side of the magnet board illustrated in FIG. 1, and illustrates a dado groove channel and/or a diagonal drilled hole(s) configuration that may be used on the frame according to at least one embodiment described herein.

FIG. 1C illustrates a backside or under side of the magnet board illustrated in FIG. 1, and illustrates a T-Groove dado channels and/or a diagonal drilled hole(s) configuration that may be used on the frame according to at least one embodiment described herein.

FIG. 2 illustrates a configuration of a magnet board according to at least one embodiment described herein.

FIG. 2A, FIG. 2B and FIG. 2C illustrate a different view of the magnet board illustrated in FIG. 2.

FIG. 2D illustrates a backside or under side of the magnet board illustrated in FIG. 1, and illustrates a dado groove channel and/or a diagonal drilled hole(s) configuration that may be used on the frame according to at least one embodiment described herein.

FIG. 2E illustrates a backside or under side of the magnet board illustrated in FIG. 1, and illustrates a T-Groove dado channels and/or a diagonal drilled hole(s) configuration that may be used on the frame according to at least one embodiment described herein.

FIG. 3 illustrates a configuration of a magnet board according to at least one embodiment described herein.

FIG. 3A illustrates a different view of the magnet board illustrated in FIG. 3.

FIG. 3B illustrates a backside or under side of the magnet board illustrated in FIG. 1, and illustrates a dado groove channel and/or a diagonal drilled hole(s) configuration that may be used on the frame according to at least one embodiment described herein.

FIG. 3C illustrates a backside or under side of the magnet board illustrated in FIG. 1, and illustrates a T-Groove dado channels and/or a diagonal drilled hole(s) configuration that may be used on the frame according to at least one embodiment described herein.

FIG. 4 illustrates a configuration of a magnet board according to at least one embodiment described herein.

FIG. 4A illustrates a different view of the magnet board illustrated in FIG. 4.

FIG. 4B illustrates a backside or under side of the magnet board illustrated in FIG. 1, and illustrates a dado groove channel and/or a diagonal drilled hole(s) configuration that may be used on the frame according to at least one embodiment described herein.

FIG. 4C illustrates a backside or under side of the magnet board illustrated in FIG. 1, and illustrates a T-Groove dado channels and/or a diagonal drilled hole(s) configuration that may be used on the frame according to at least one embodiment described herein.

FIG. 5 illustrates a configuration of a magnet board according to at least one embodiment described herein.

FIG. 5A illustrates a different view of the magnet board illustrated in Figure5.

FIG. 5B illustrates a backside or under side of the magnet board illustrated in FIG. 1, and illustrates a dado groove channel and/or a diagonal drilled hole(s) configuration that may be used on the frame according to at least one embodiment described herein.

FIG. 5C illustrates a backside or under side of the magnet board illustrated in FIG. 1, and illustrates a T-Groove dado channels and/or a diagonal drilled hole(s) configuration that may be used on the frame according to at least one embodiment described herein.

FIG. 6 illustrates a configuration of a magnet board according to at least one embodiment described herein.

FIG. 6A illustrates a different view of the magnet board illustrated in FIG. 6.

FIG. 6B illustrates a backside or under side of the magnet board illustrated in FIG. 1, and illustrates a dado groove channel and/or a diagonal drilled hole(s) configuration that may be used on the frame according to at least one embodiment described herein.

FIG. 6C illustrates a backside or under side of the magnet board illustrated in FIG. 1, and illustrates a T-Groove dado channels and/or a diagonal drilled hole(s) configuration that may be used on the frame according to at least one embodiment described herein.

FIG. 7 illustrates a configuration of a magnet board according to at least one embodiment described herein.

FIG. 7A illustrates a different view of the magnet board illustrated in FIG. 7.

FIG. 7B illustrates a backside or under side of the magnet board illustrated in FIG. 1, and illustrates a dado groove channel and/or a diagonal drilled hole(s) configuration that may be used on the frame according to at least one embodiment described herein.

FIG. 7C illustrates a backside or under side of the magnet board illustrated in FIG. 1, and illustrates a T-Groove dado channels and/or a diagonal drilled hole(s) configuration that may be used on the frame according to at least one embodiment descry bed herein.

FIG. 8 illustrates a configuration of a magnet board according to at least one embodiment described herein.

FIG. 8A illustrates a different view of the magnet board illustrated in FIG. 8.

FIG. 8B illustrates a backside or under side of the magnet board illustrated in FIG. 1, and illustrates a dado groove channel and/or a diagonal drilled hole(s) configuration that may be used on the frame according to at least one embodiment described herein.

FIG. 8C illustrates a backside or under side of the magnet board illustrated in FIG. 1, and illustrates a T-Groove dado channels and/or a diagonal drilled hole(s) configuration that may be used on the frame according to at least one embodiment described herein.

FIG. 9 illustrates a configuration of a magnet board according to at least one embodiment described herein.

FIG. 9A illustrates a different view of the magnet board illustrated in FIG. 9.

FIG. 9B illustrates a backside or under side of the magnet board illustrated in FIG. 1, and illustrates a dado groove channel and/or a diagonal drilled hole(s) configuration that may be used on the frame according to at least one embodiment described herein.

FIG. 9C illustrates a backside or under side of the magnet board illustrated in FIG. 1, and illustrates a T-Groove dado channels and/or a diagonal drilled hole(s) configuration that may be used on the frame according to at least one embodiment described herein.

FIG. 10 illustrates a stile profile without the dado groove's or T-Groove dados according to at least one embodiment described herein.

FIG. 10A illustrates a frames stile profile with only one ¾″×¾″ dado groove according to at least one embodiment described herein.

FIG. 10B illustrates a stile profile with only one T-Groove dado according to at least one embodiment described herein.

FIG. 10C illustrates a frames stile profile with the ¾″×¾″ dado groove and the ⅜″×¾″ dado groove according to at least one embodiment described herein.

FIG. 10D illustrates a frames stile profile with the T-Groove dado and the ⅜″×¾″ dado groove according to at least one embodiment described herein.

FIG. 11 illustrates a frames rail ends profile details according to at least one embodiment described herein.

FIG. 12 illustrates a frames stile and rail, tongue and grove glue up profile details according to at least one embodiment described herein.

FIG. 13 illustrates an example of a magnetic display configuration using picture frames, two magnetized shelves and a number of arts-n-crafts blocks sitting on top of the top shelf according to at least one embodiment described herein.

FIG. 13A illustrates an example of a magnetic display configuration using two shelves according to at least one embodiment described herein.

FIG. 13B illustrates an example of a magnetic display configuration using two shelves according to at least one embodiment described herein.

FIG. 14 illustrates an example of a possible layout from the backside view of the frame of wood filler pieces and the placement and retention of magnets according to at least one embodiment described herein.

FIG. 14A illustrates an example of a possible layout from the top rails side view of the frame which includes a top shelf, the wood filler pieces and the placement and retention of magnets according to at least one embodiment described herein.

FIG. 15 illustrates a configuration of a magnet board according to at least one embodiment described herein.

FIG. 15A illustrates a different view of the magnet board illustrated in FIG. 15.

FIG. 15B illustrates a backside or under side of the magnet board illustrated in FIG. 1, and illustrates a dado groove channel and/or a diagonal drilled hole(s) configuration that may be used on the frame according to at least one embodiment described herein.

FIG. 15C illustrates a backside or under side of the magnet board illustrated in FIG. 1, and illustrates a T-Groove dado channels and/or a diagonal drilled hole(s) configuration that may be used on the frame according to at least one embodiment described herein.

FIG. 16 illustrates a configuration of a magnet board according to at least one embodiment described herein.

FIG. 16A illustrates a different view of the magnet board illustrated in FIG. 16.

FIG. 16B illustrates a backside or under side of the magnet board illustrated in

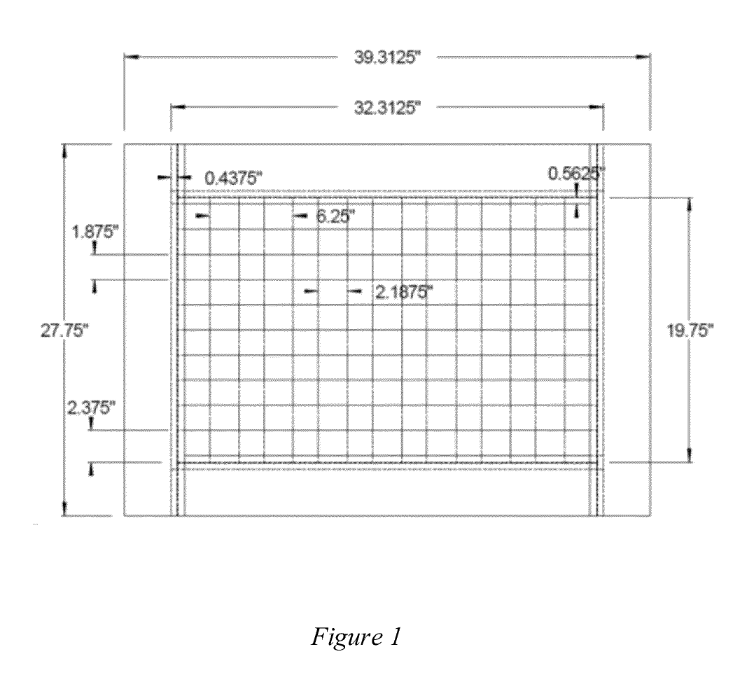

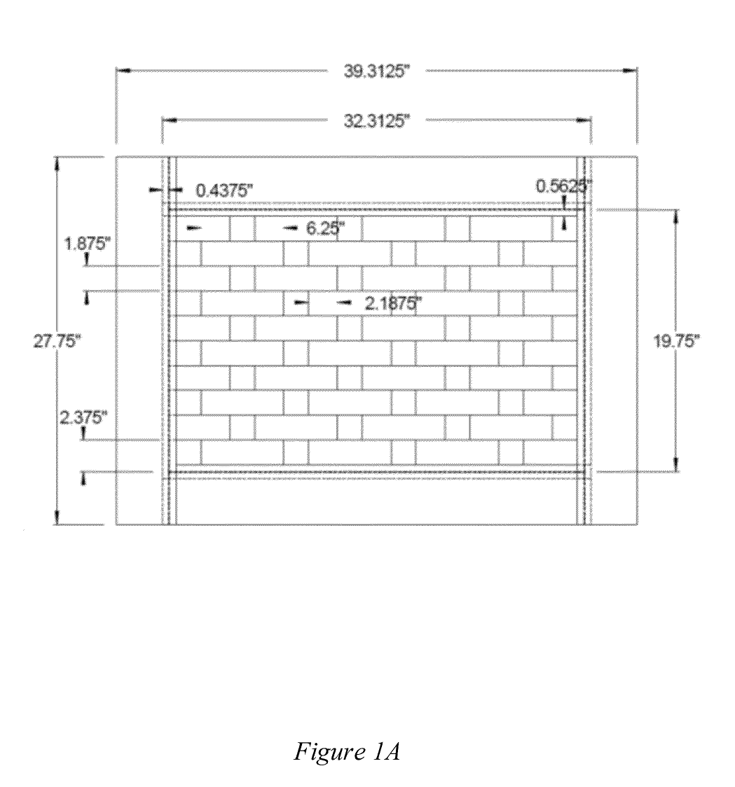

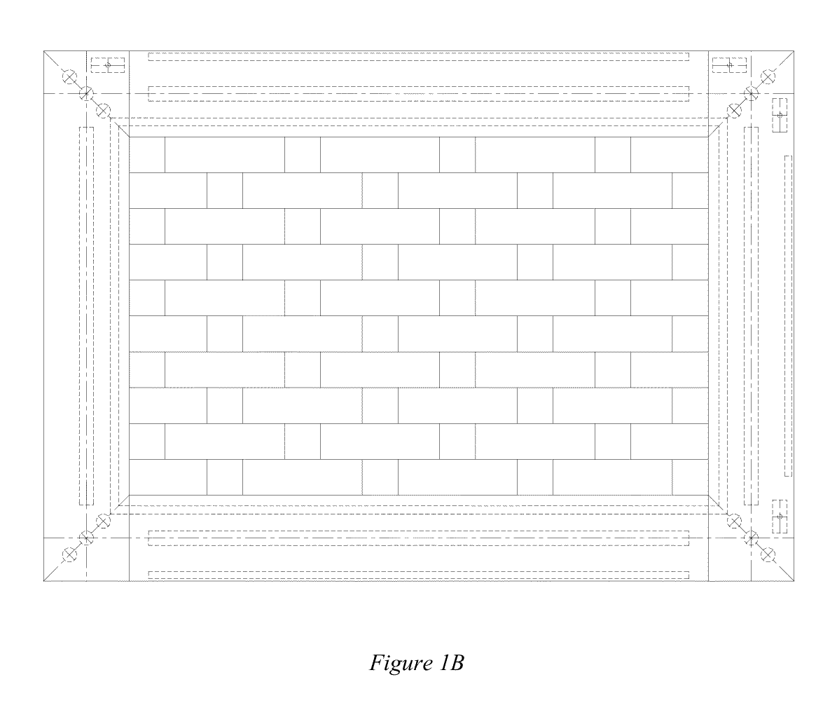

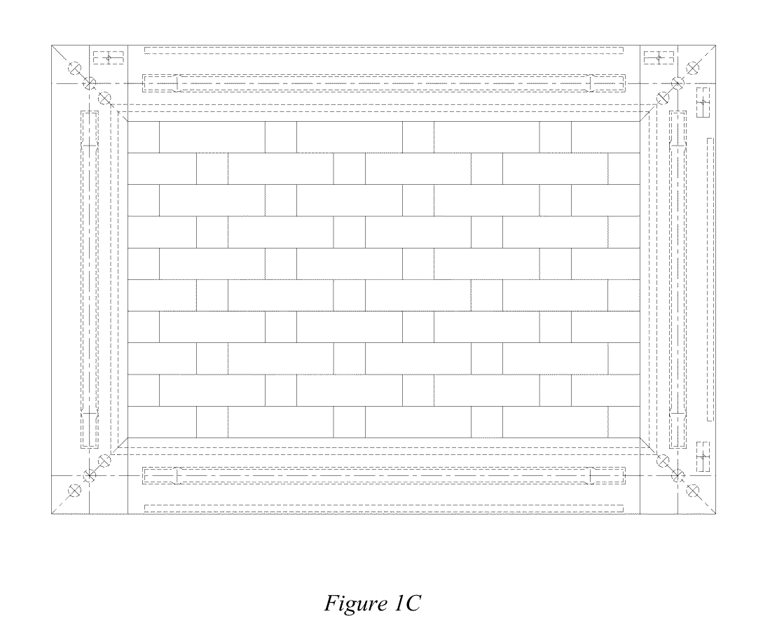

FIG. 1, and illustrates a dado groove channel and/or a diagonal drilled hole(s) configuration that may be used on the frame according to at least one embodiment described herein.

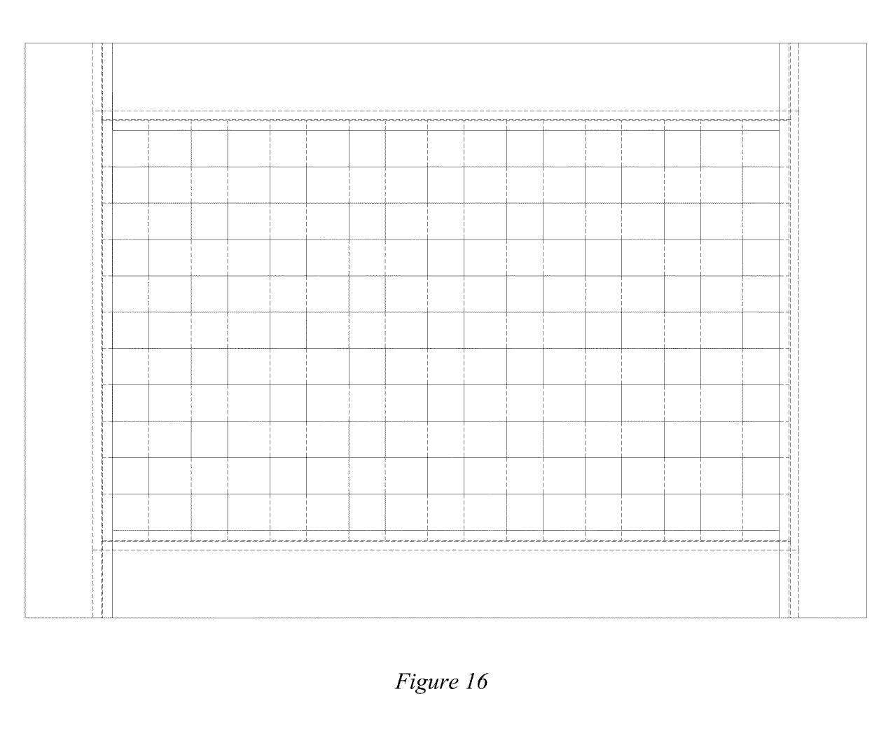

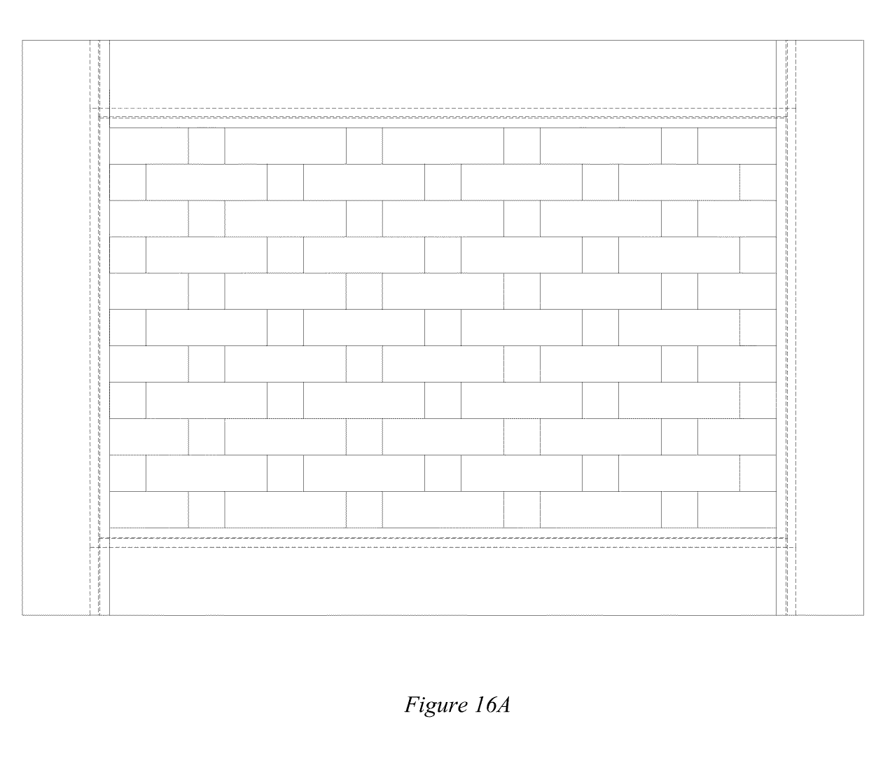

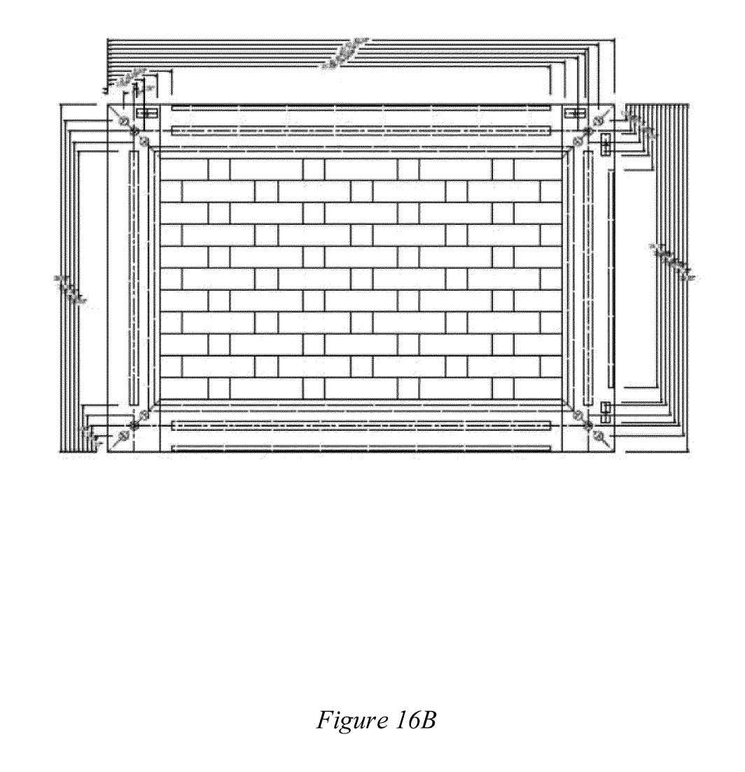

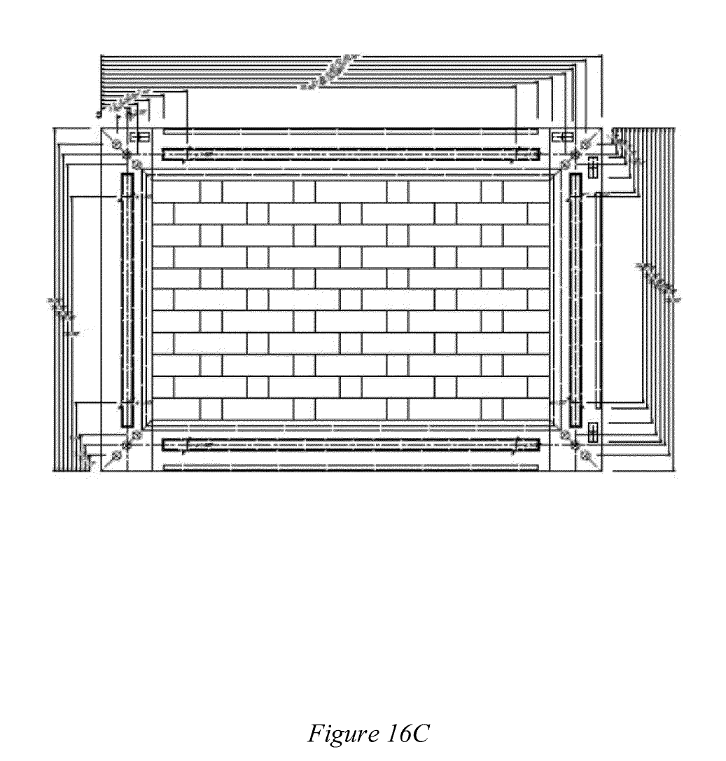

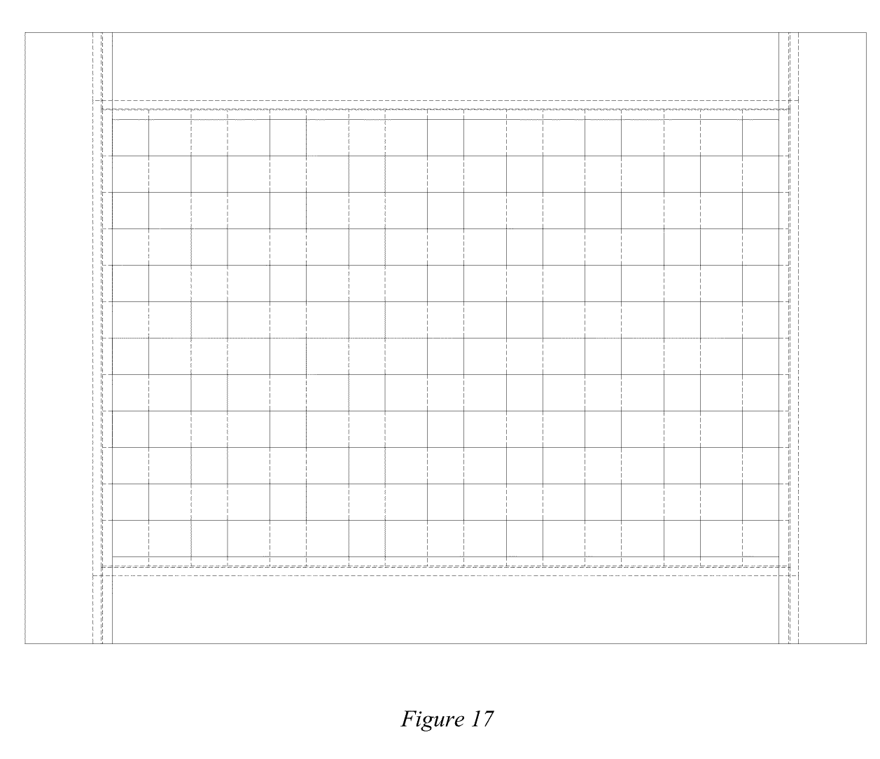

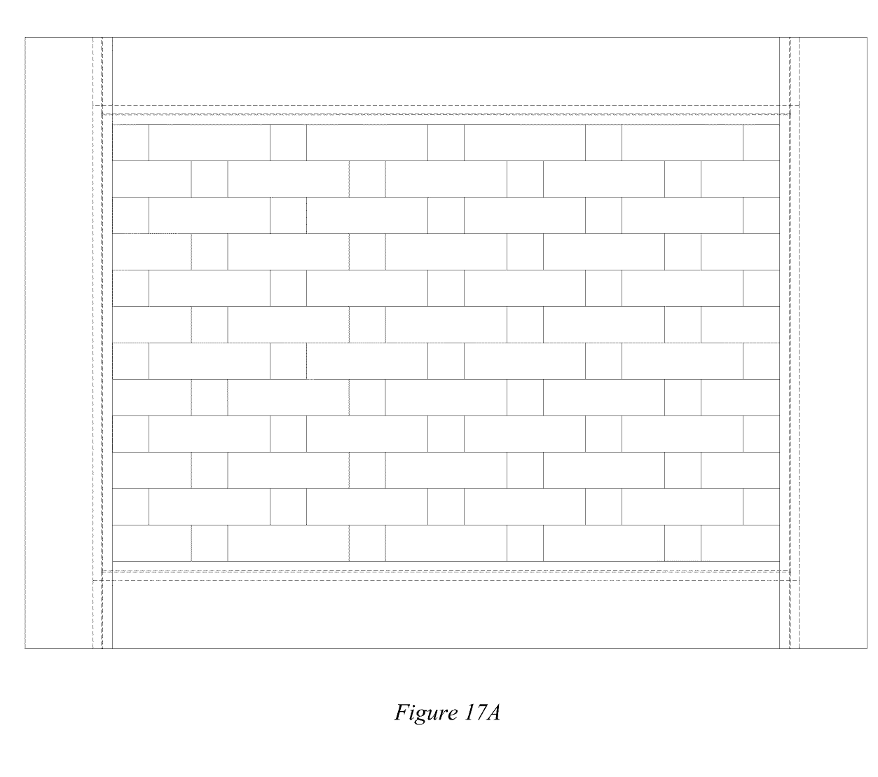

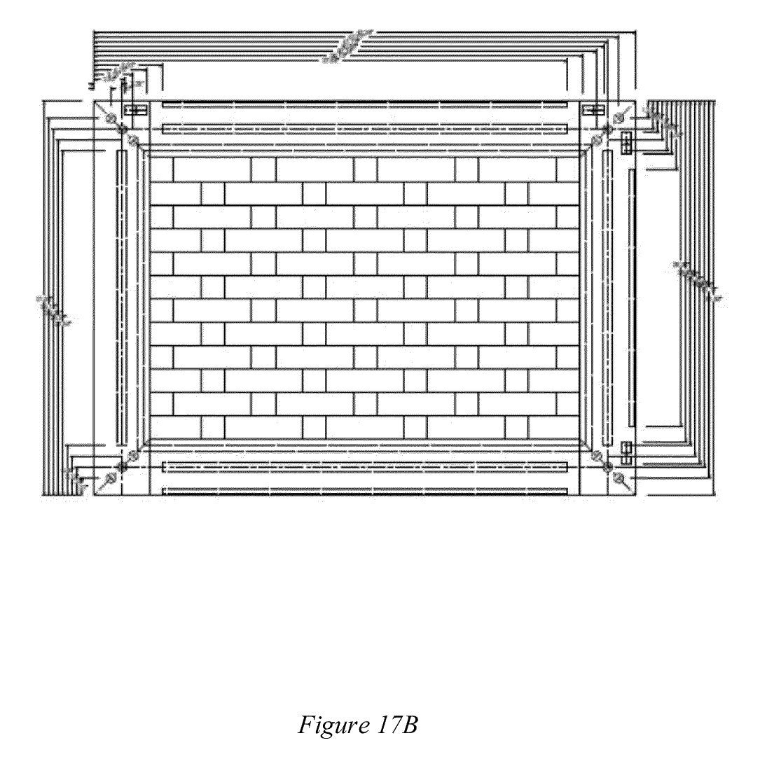

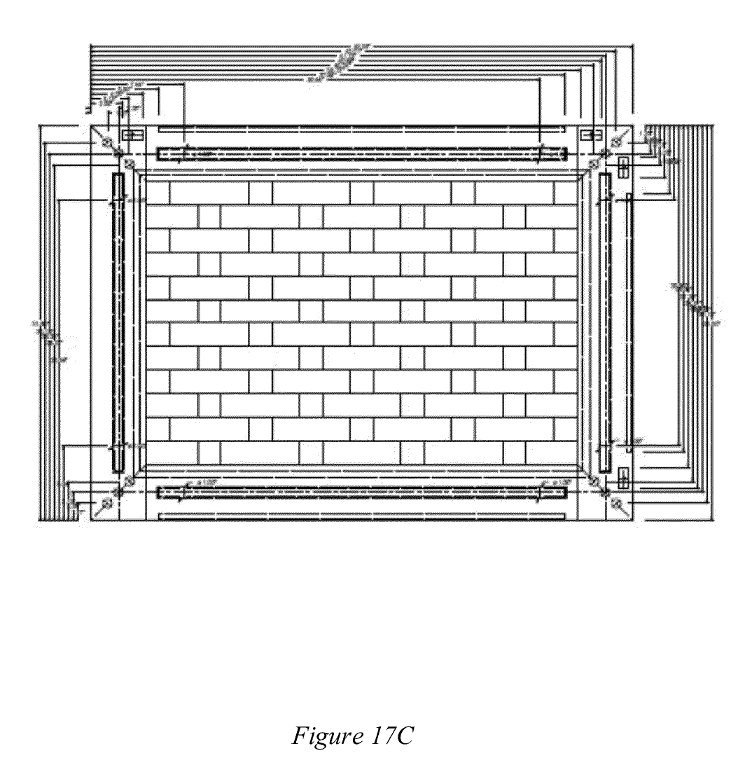

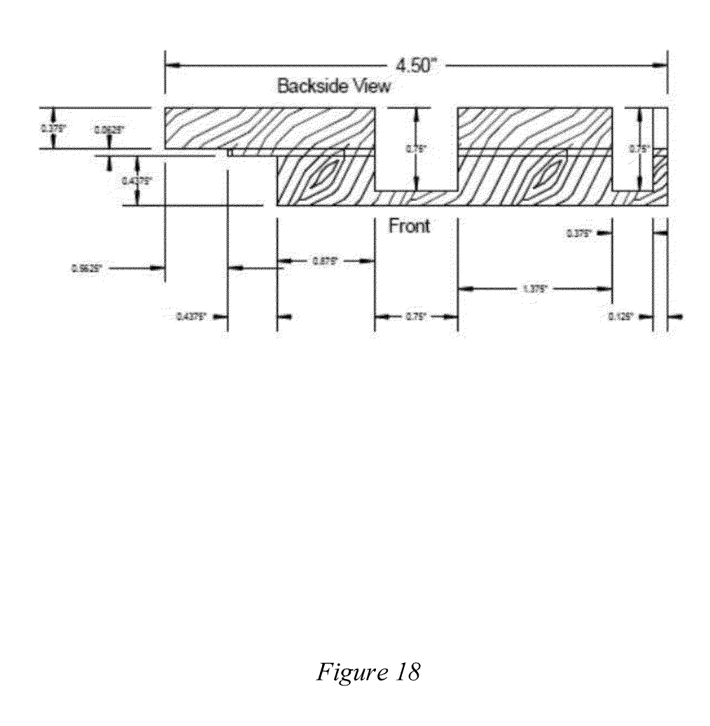

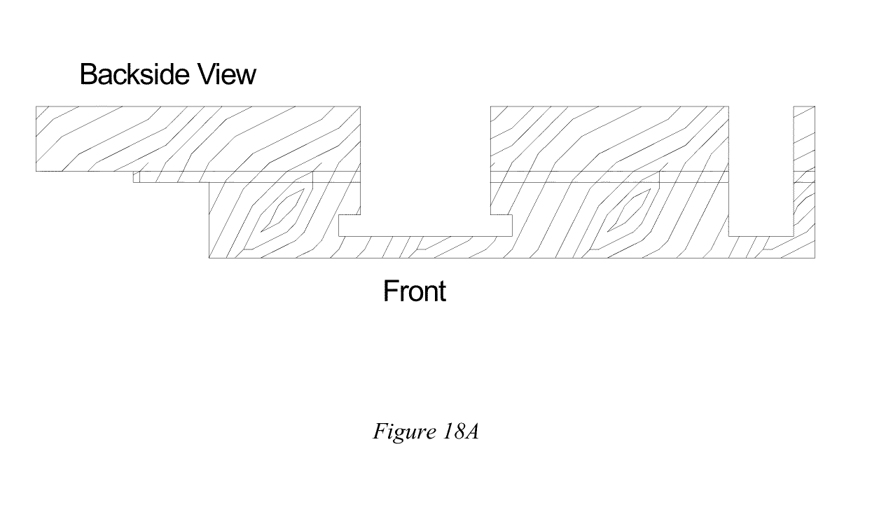

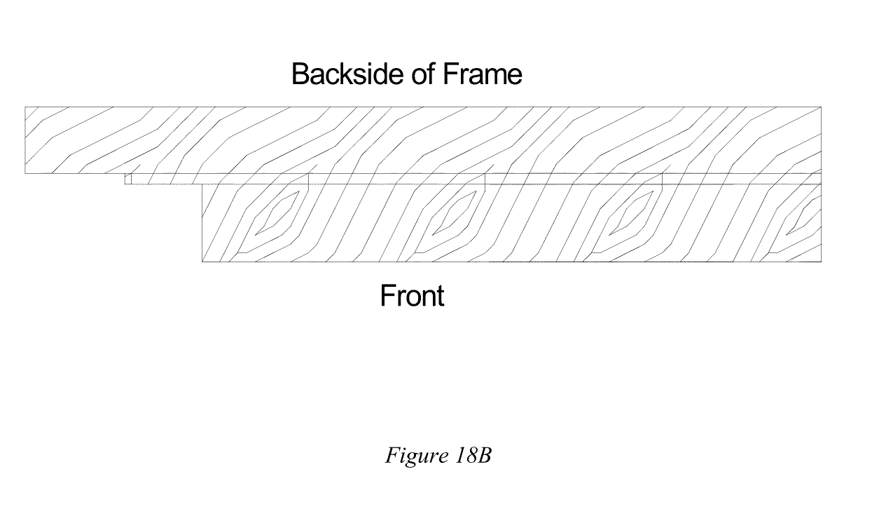

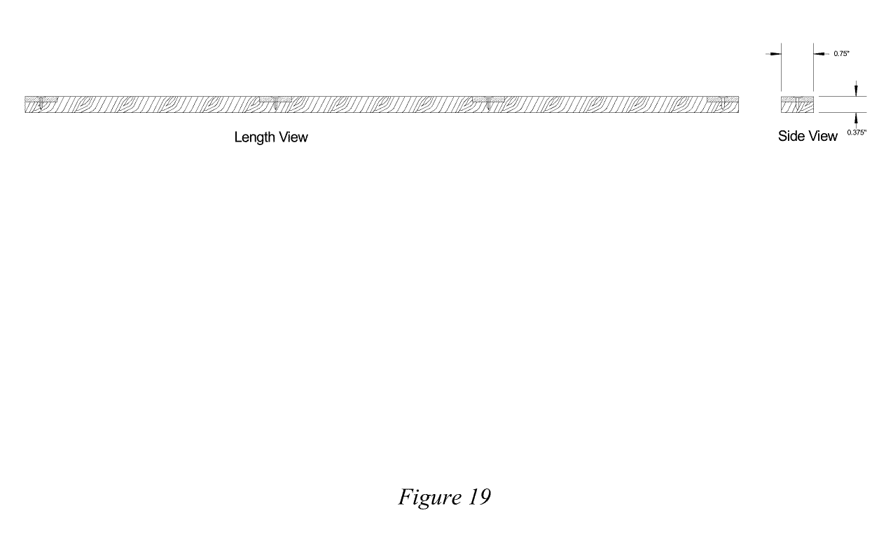

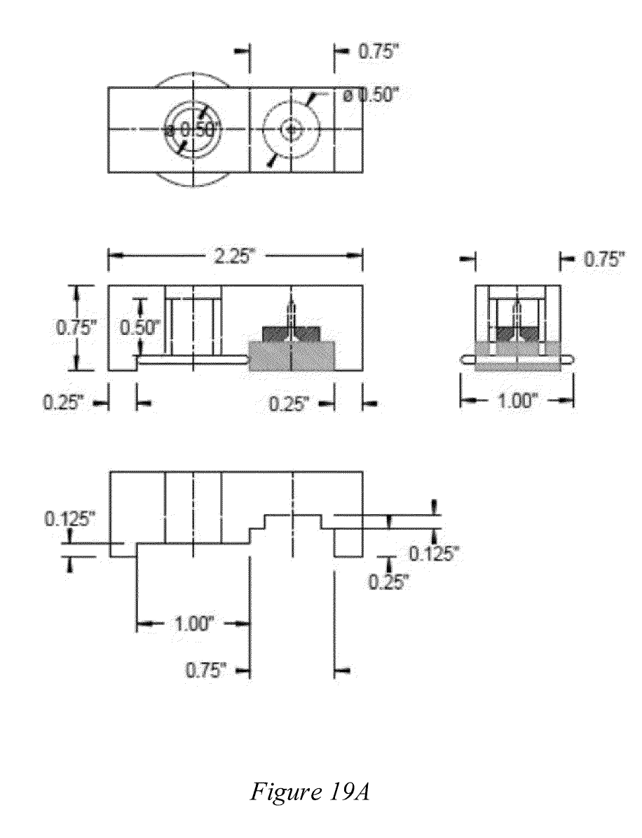

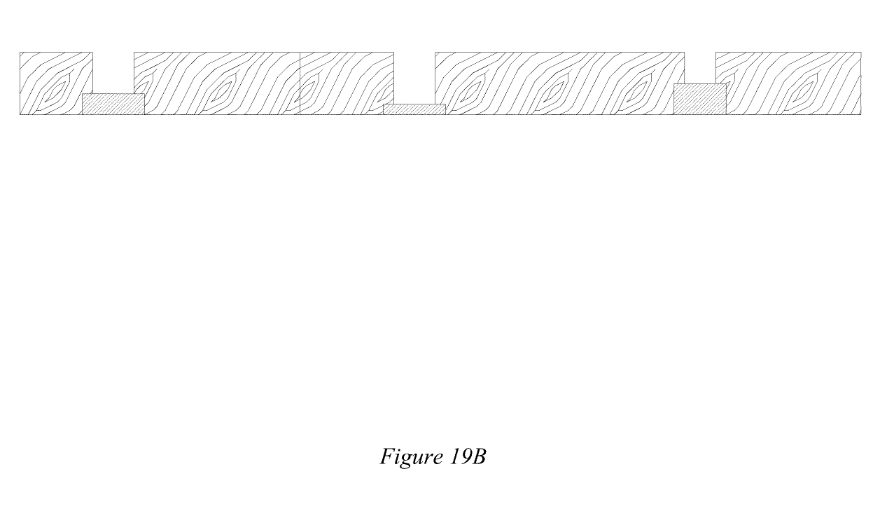

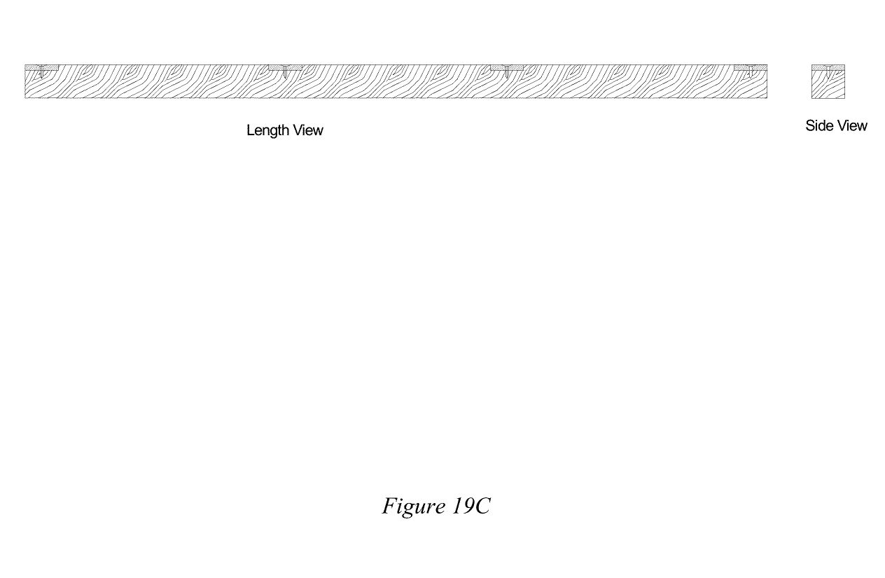

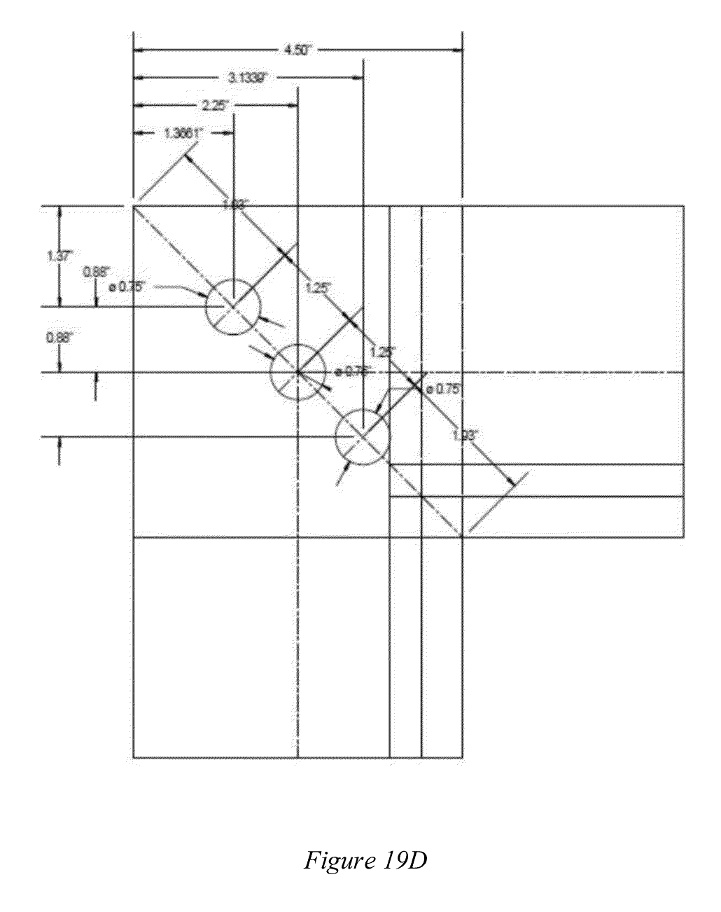

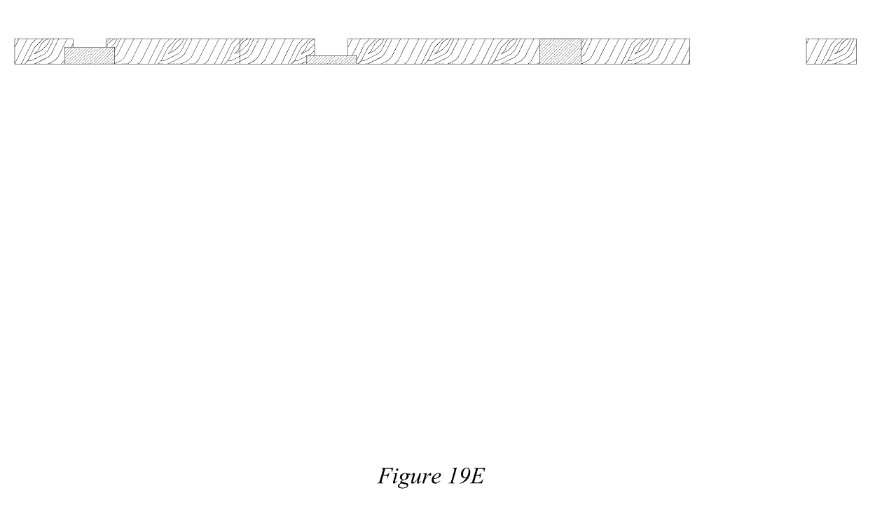

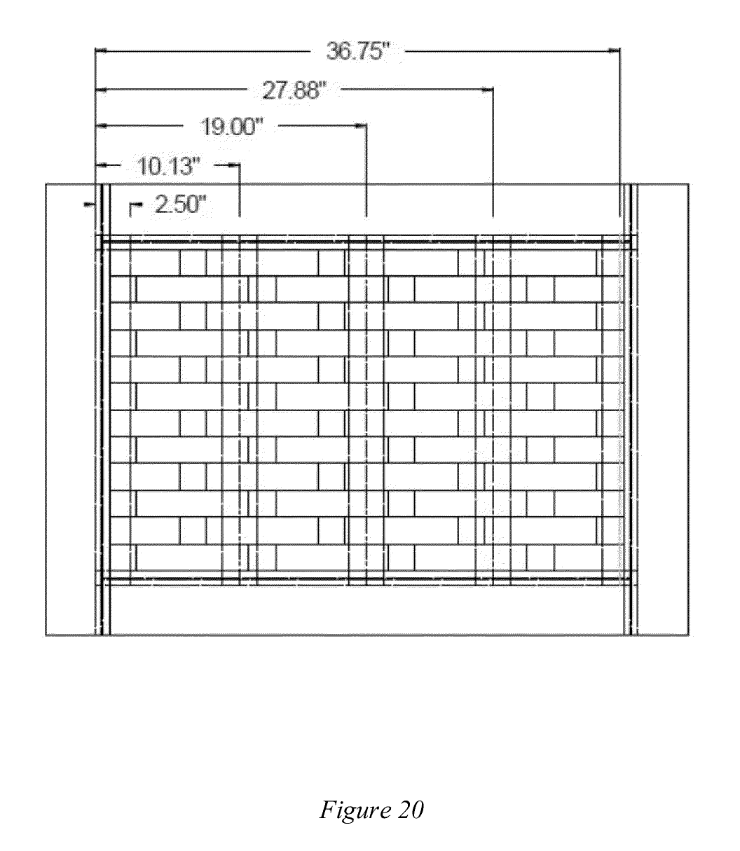

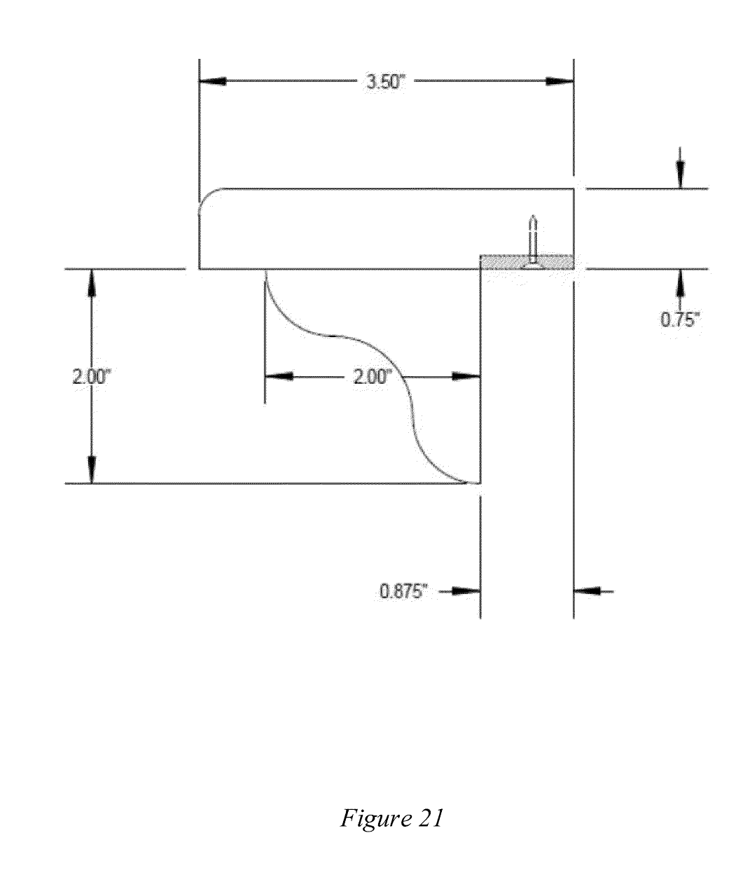

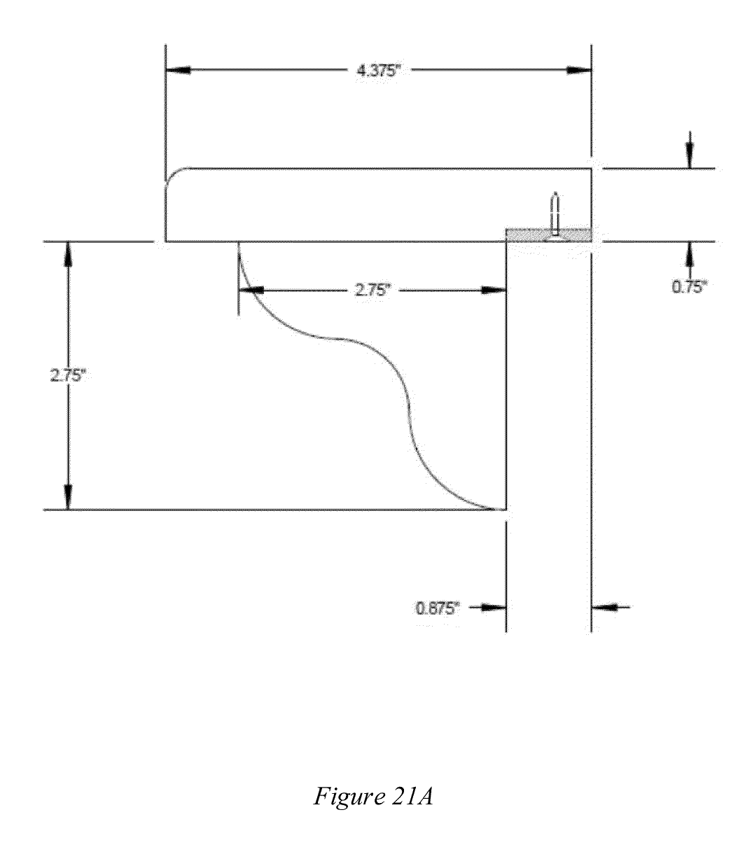

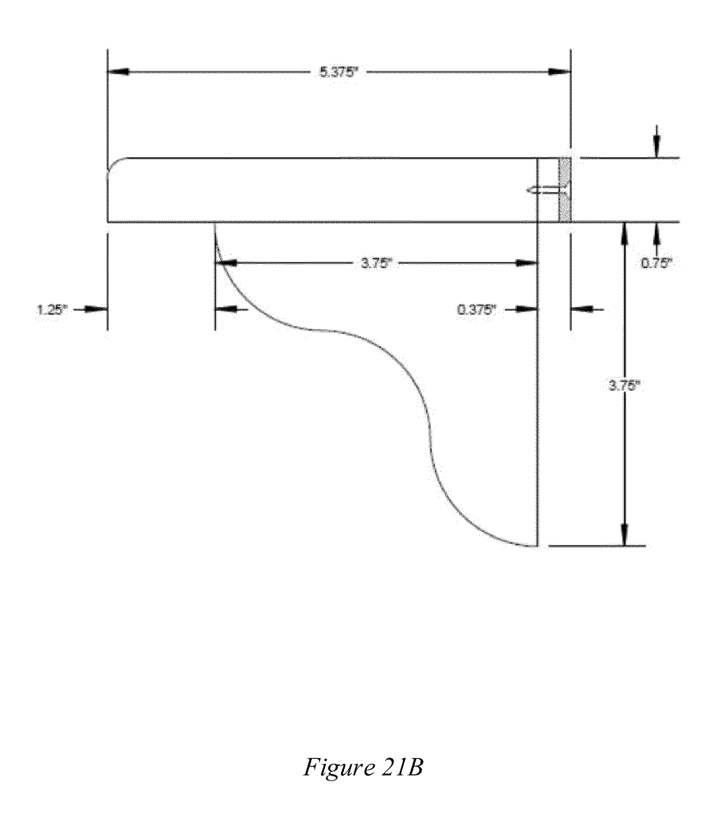

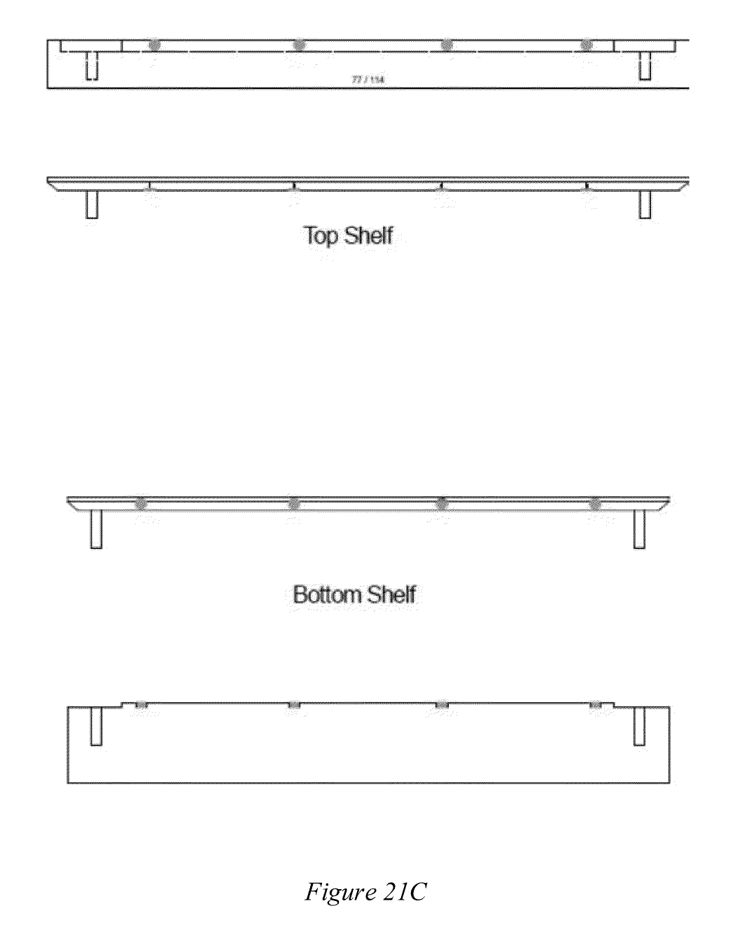

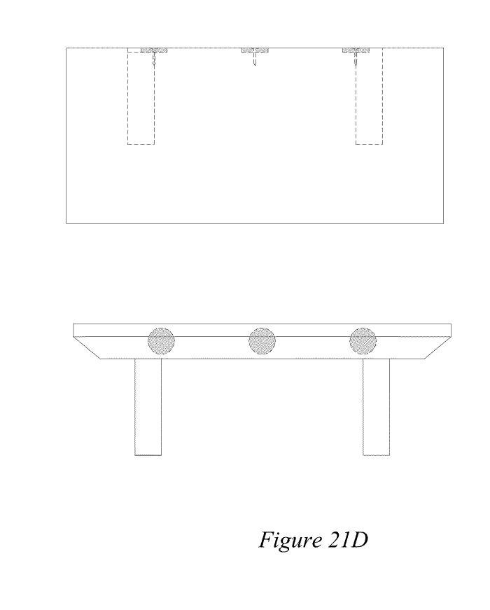

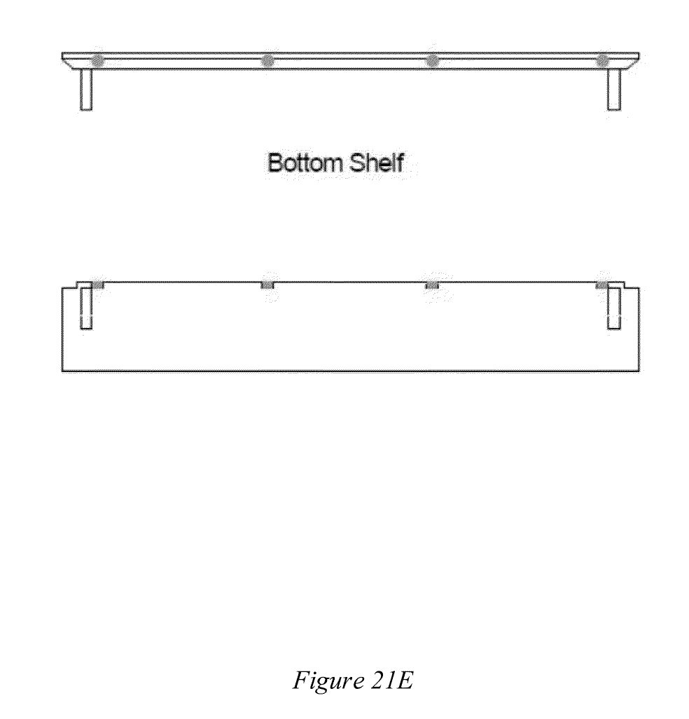

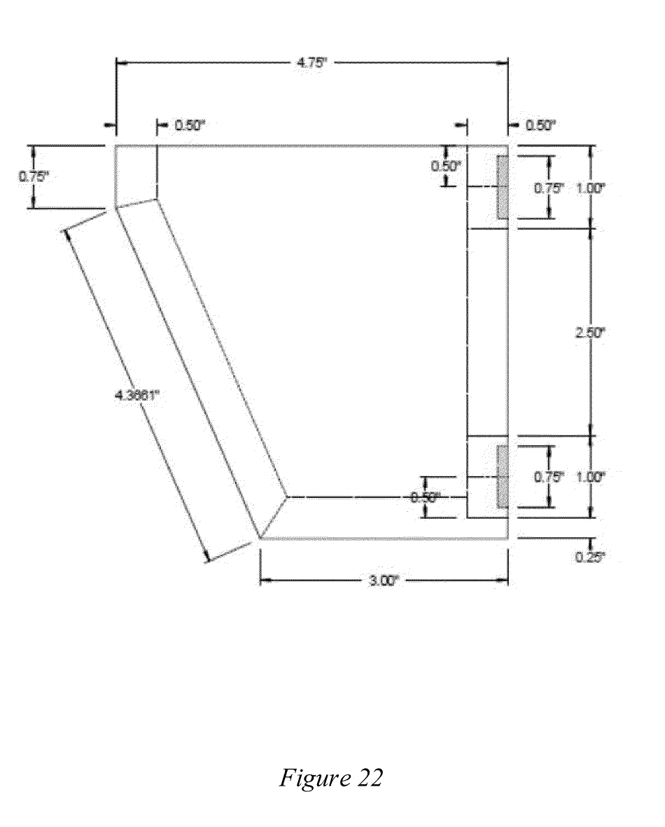

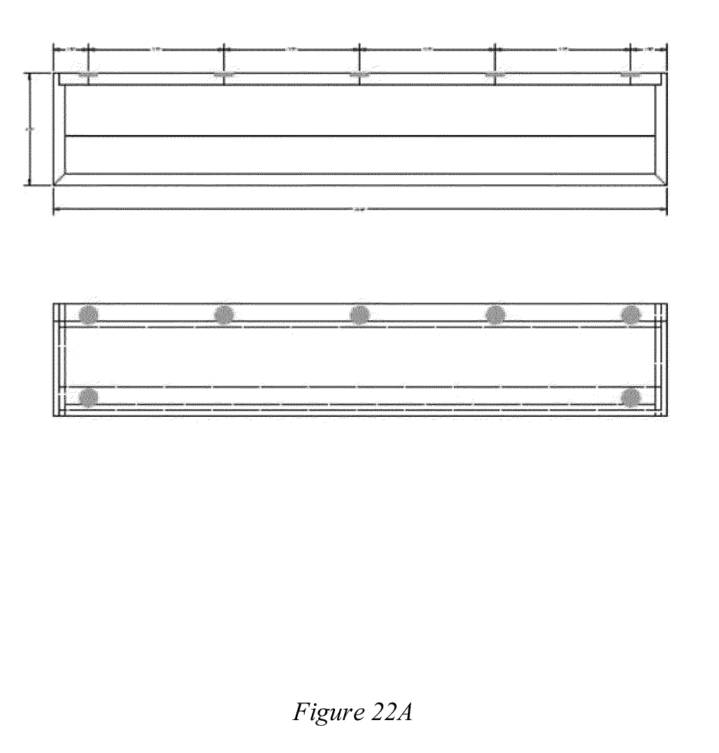

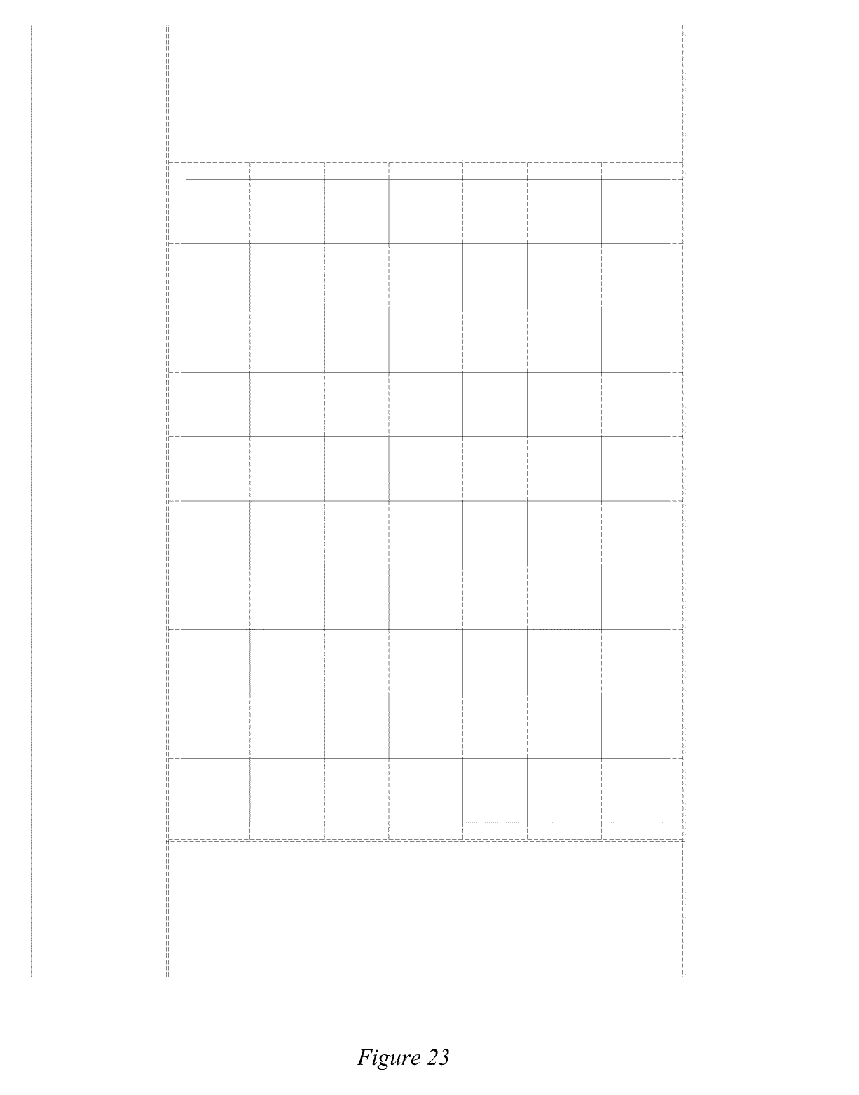

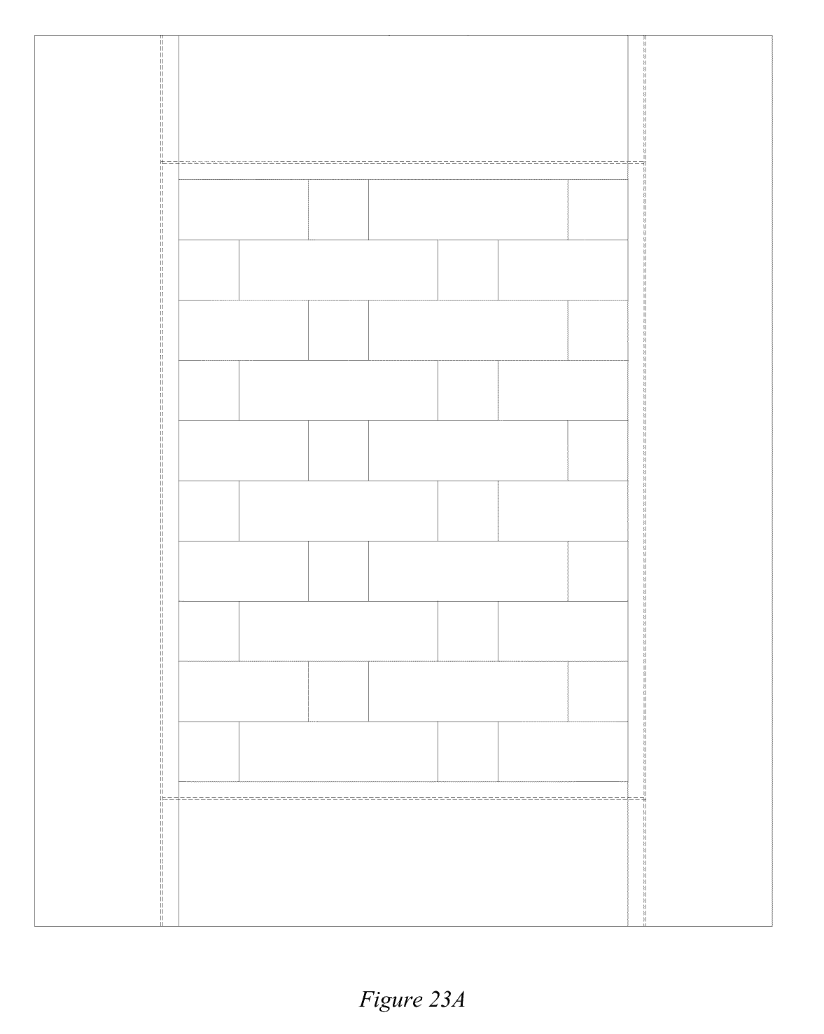

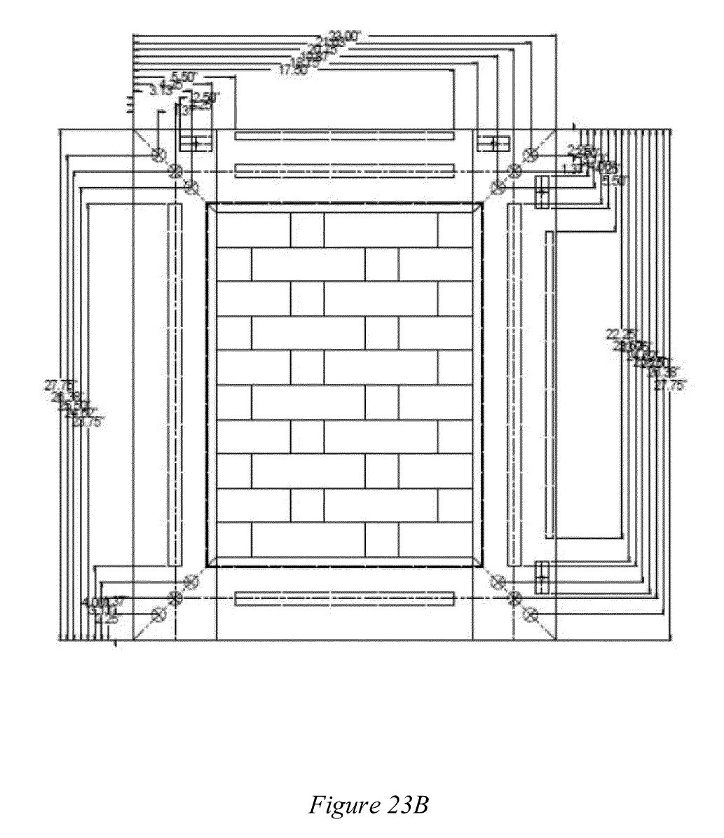

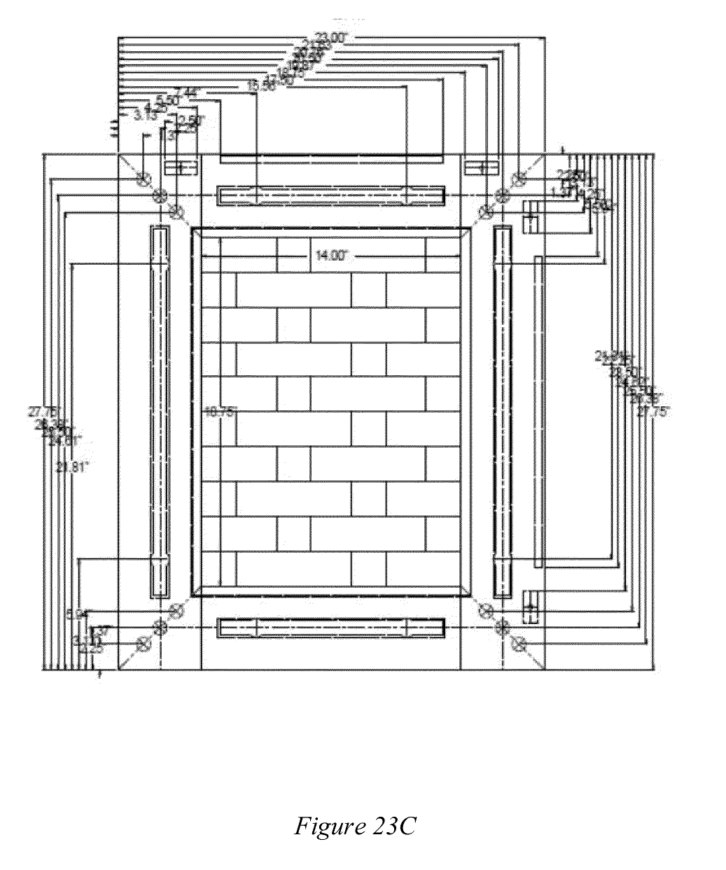

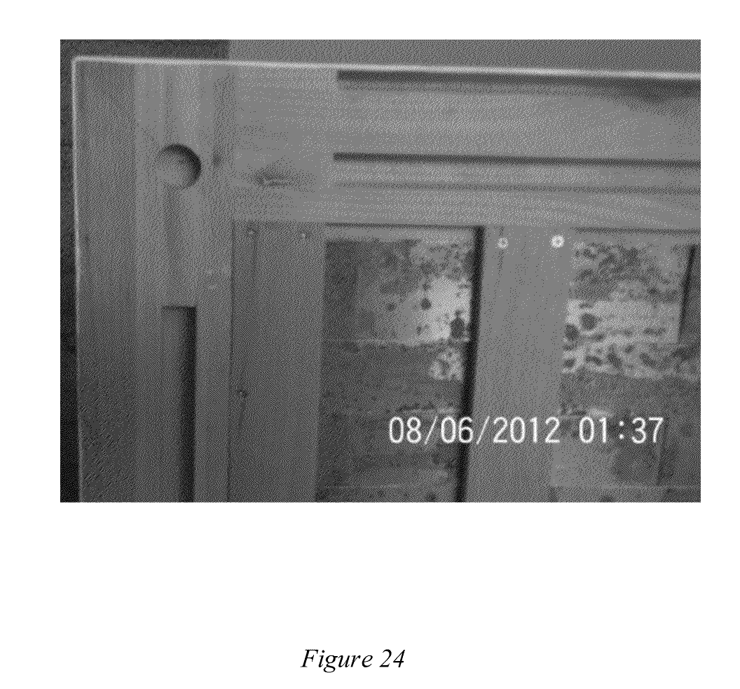

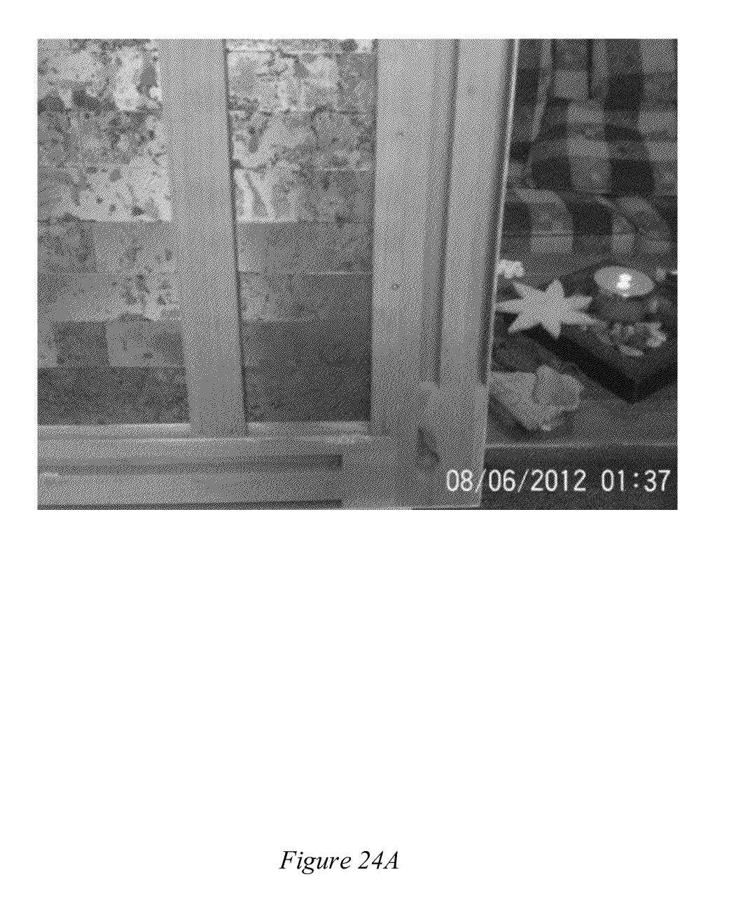

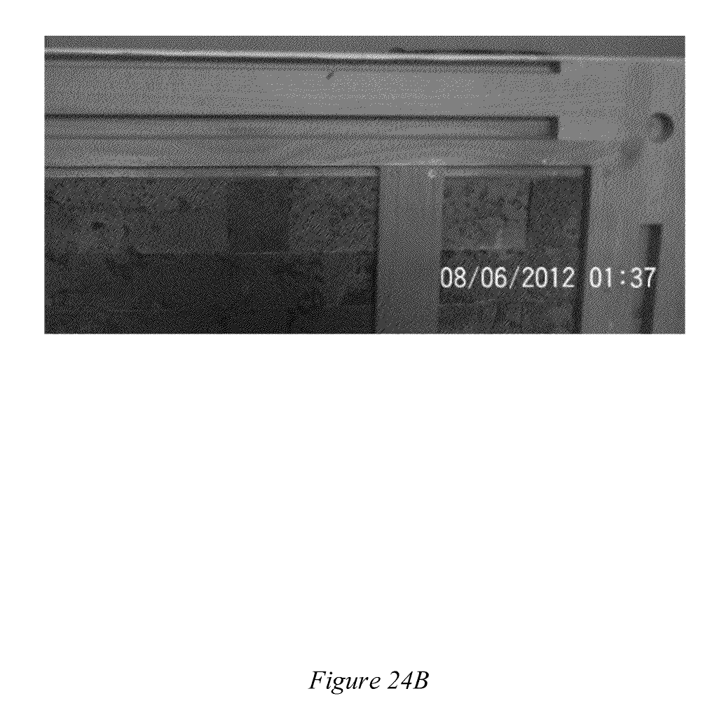

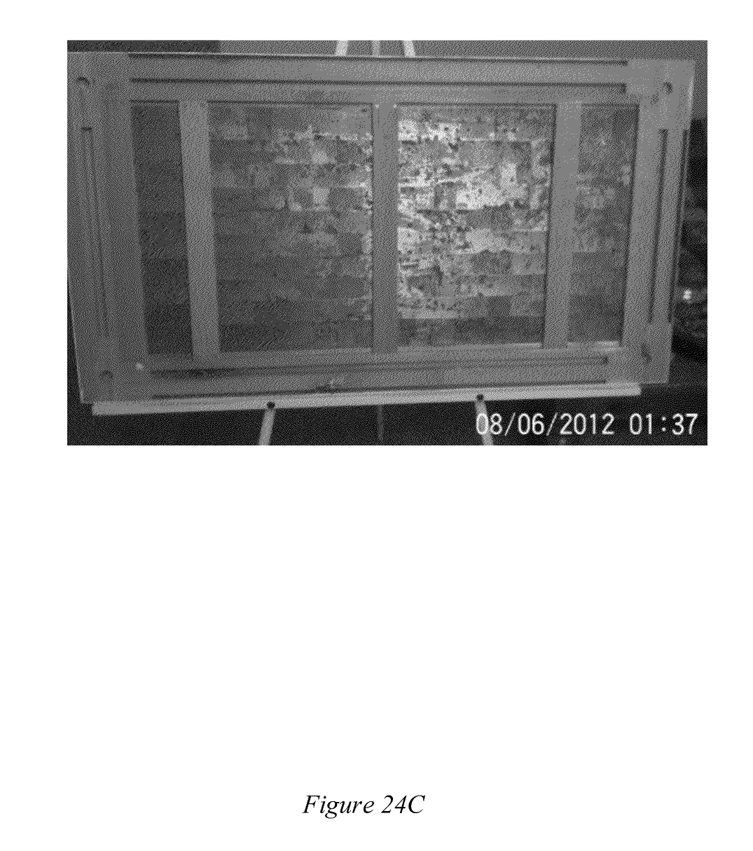

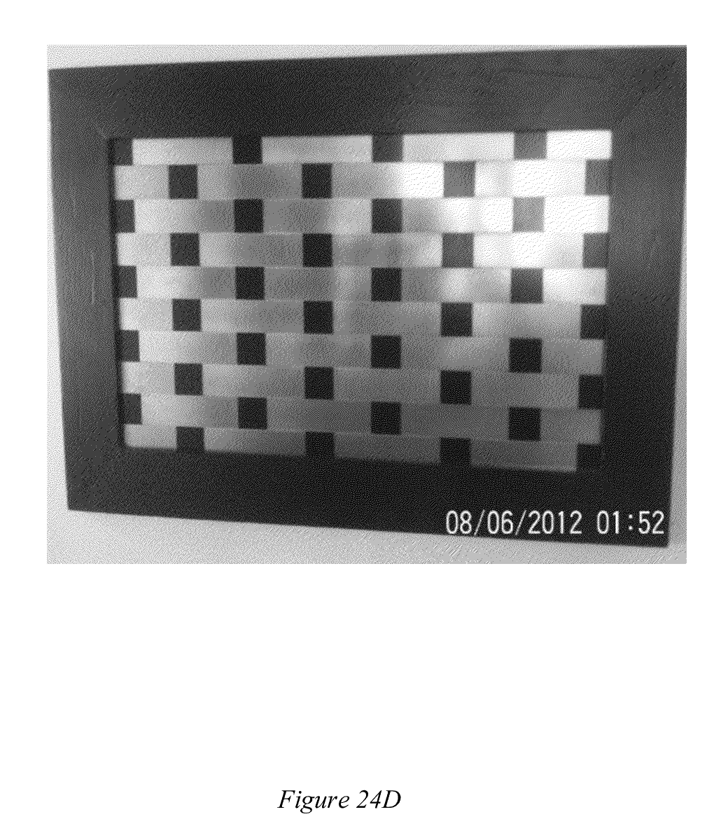

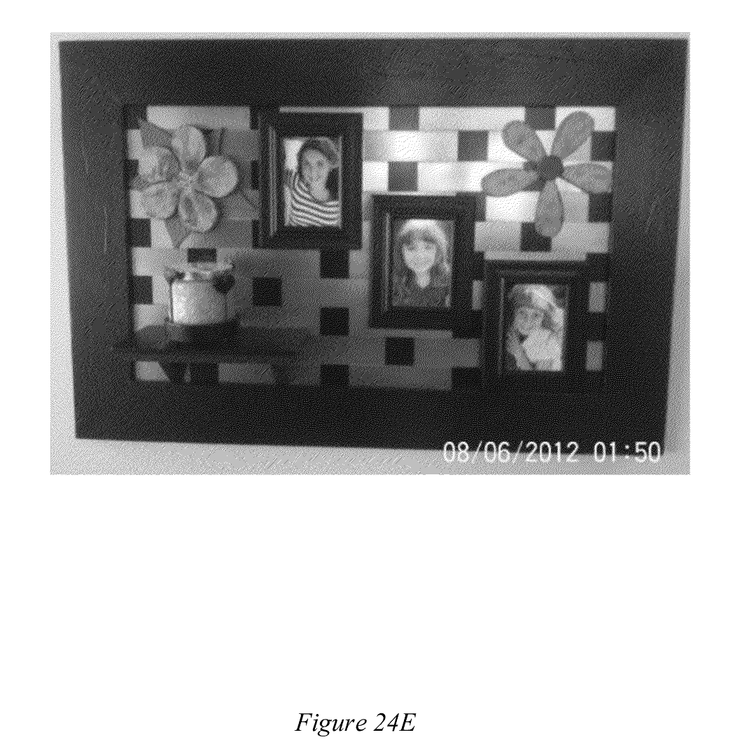

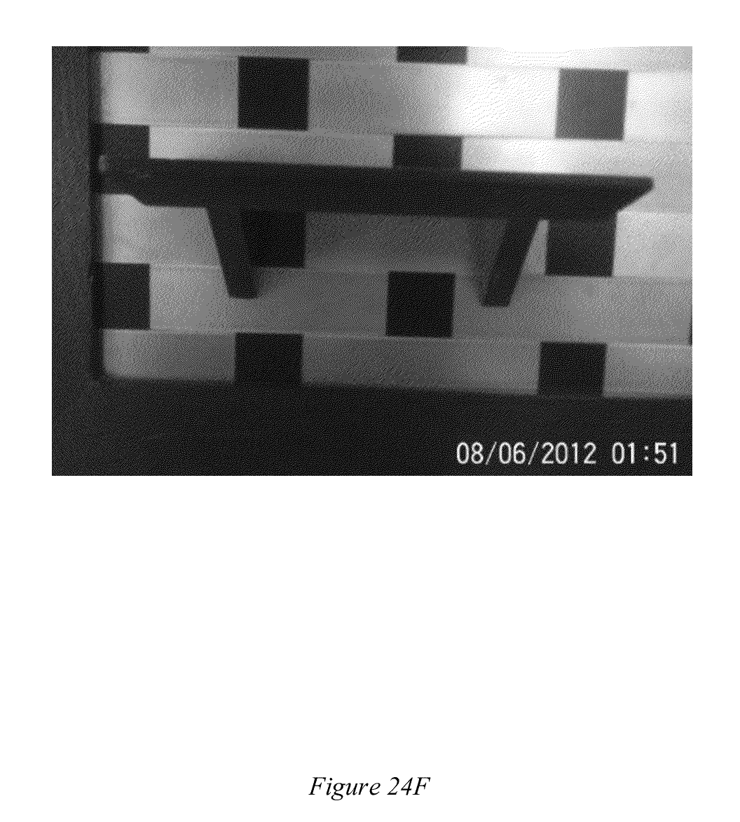

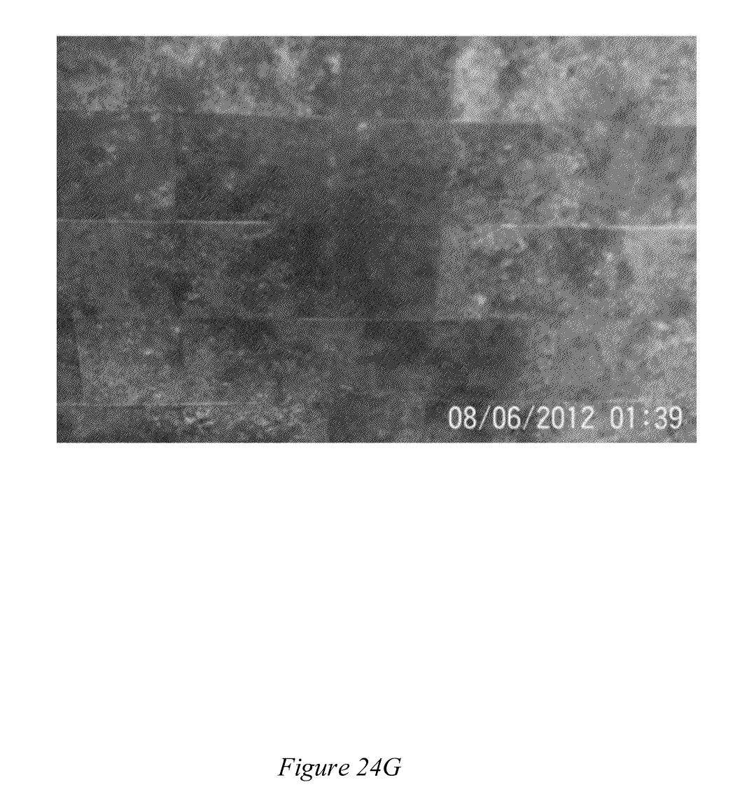

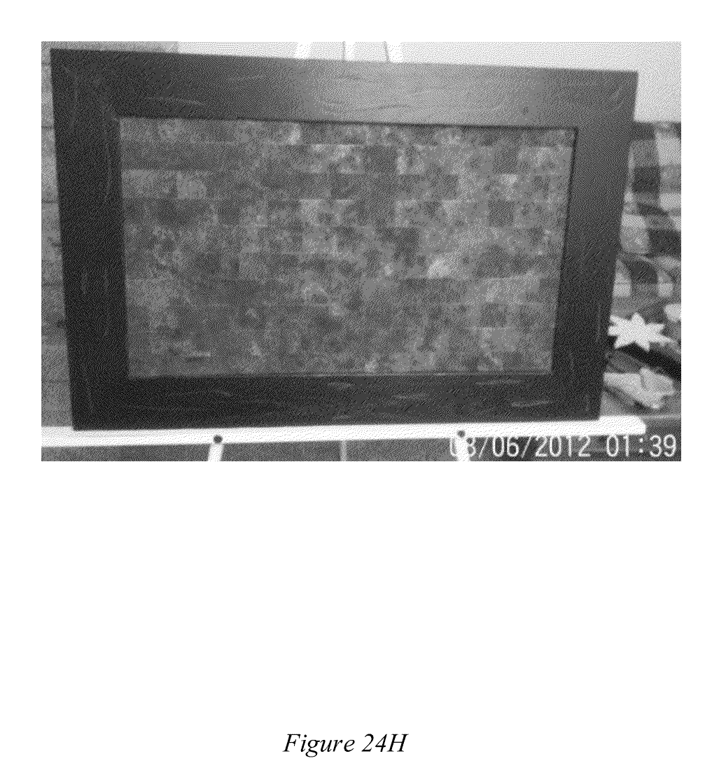

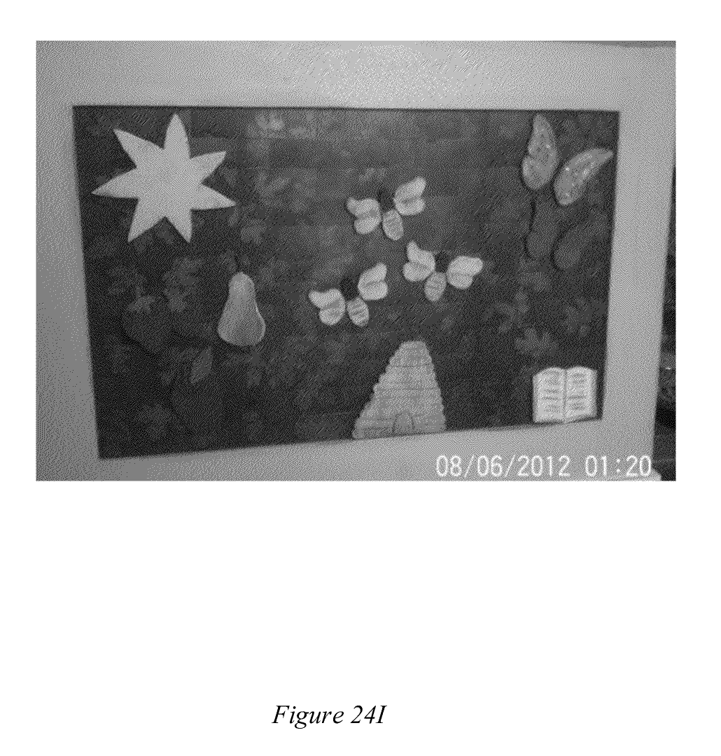

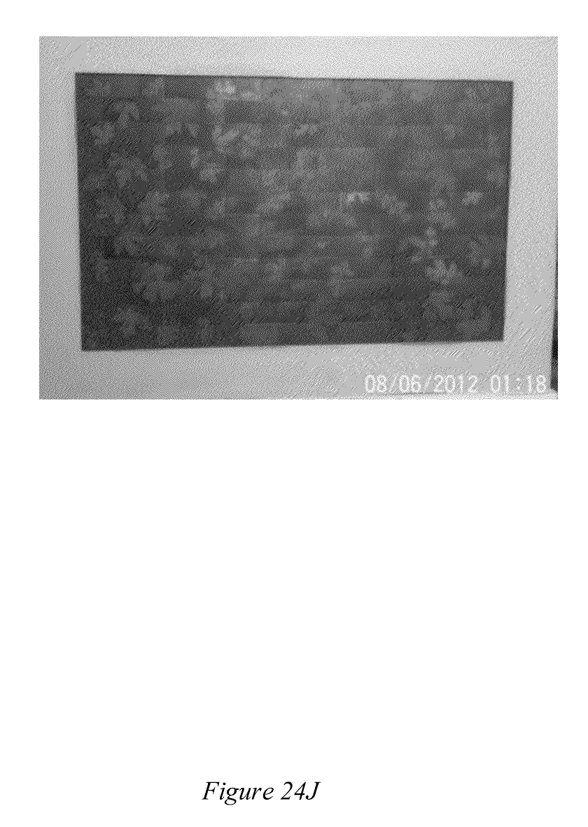

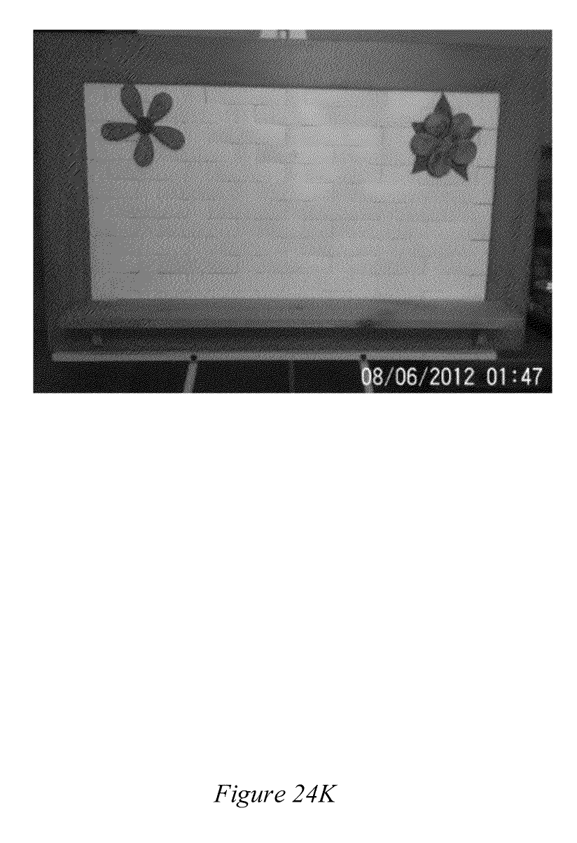

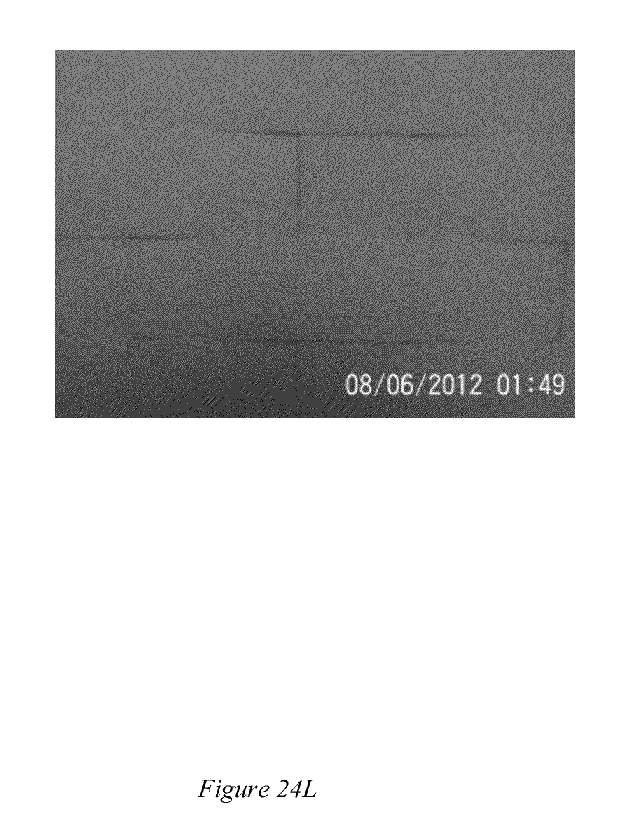

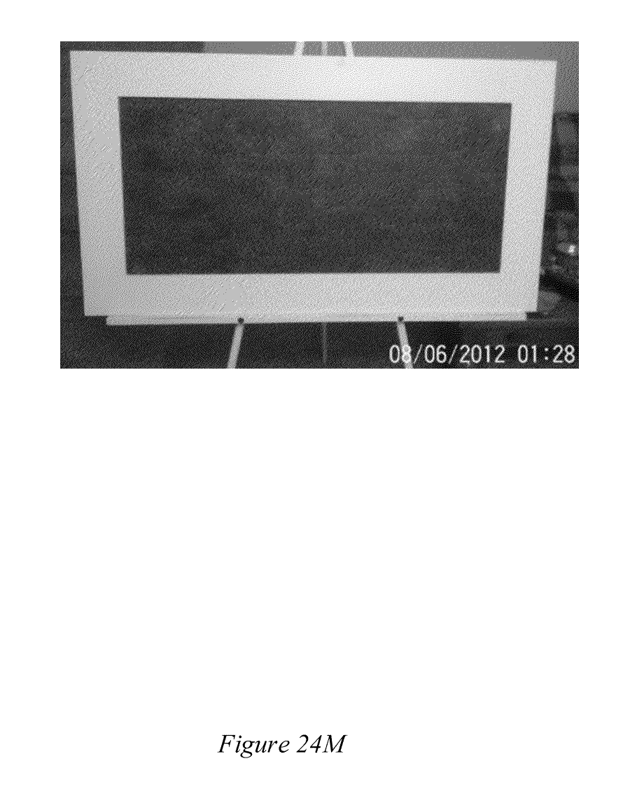

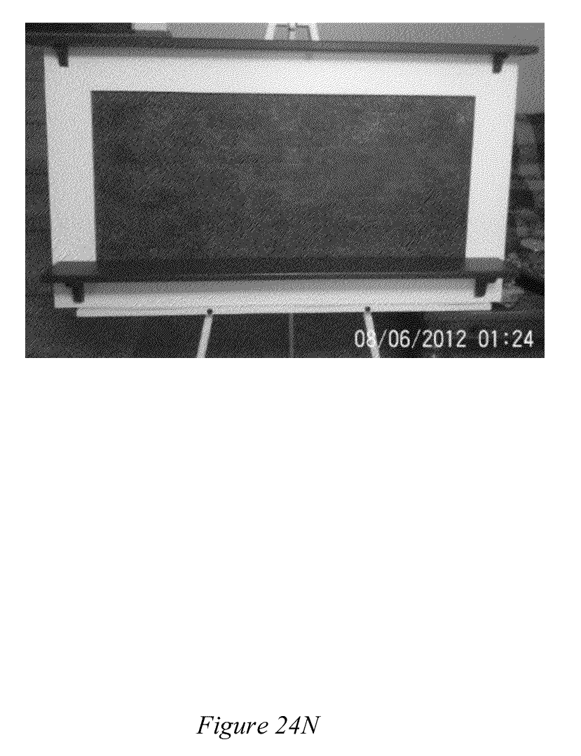

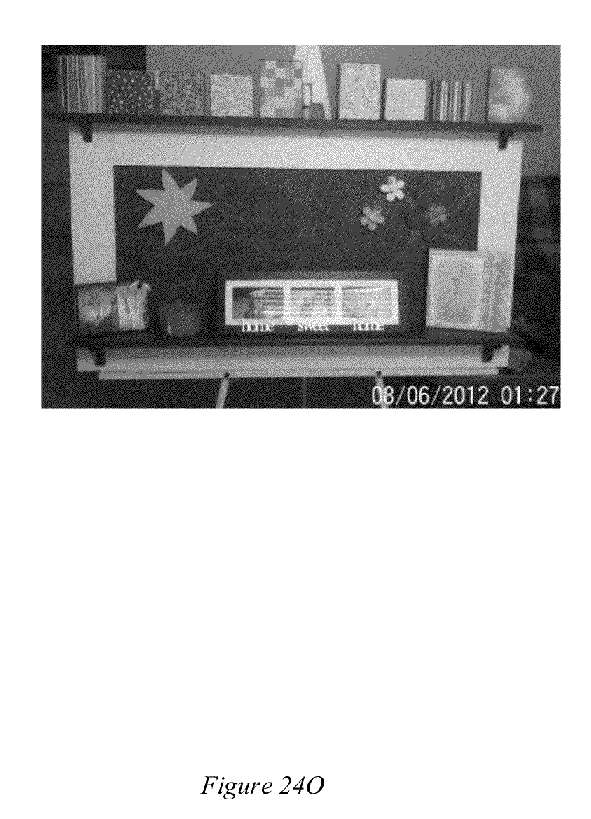

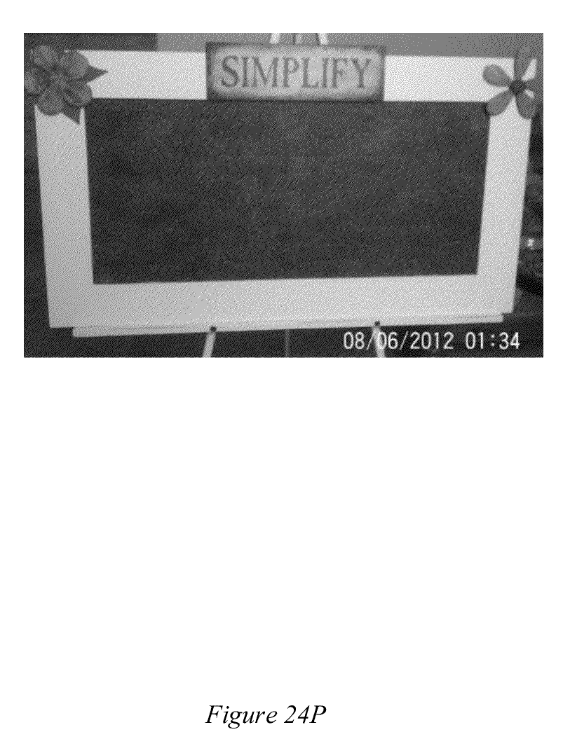

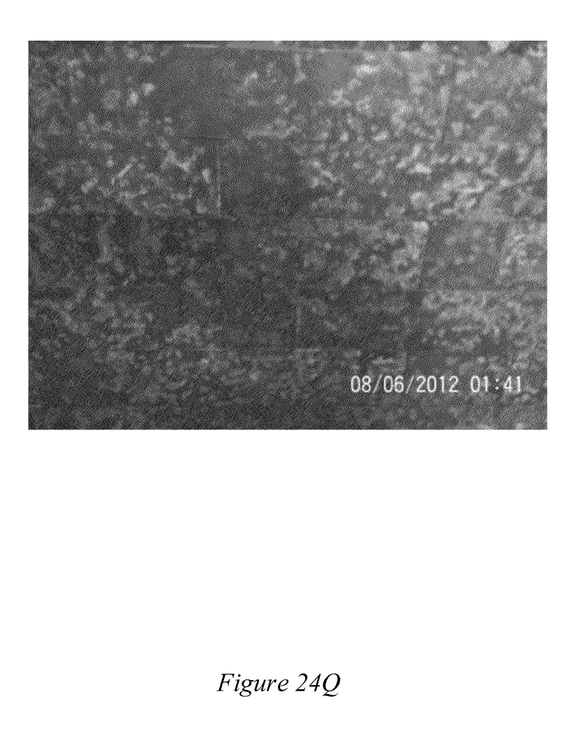

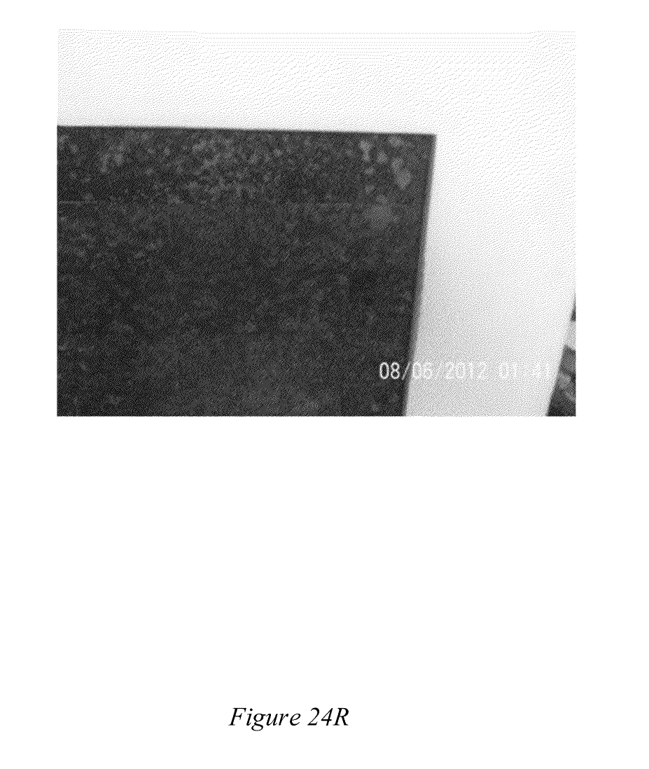

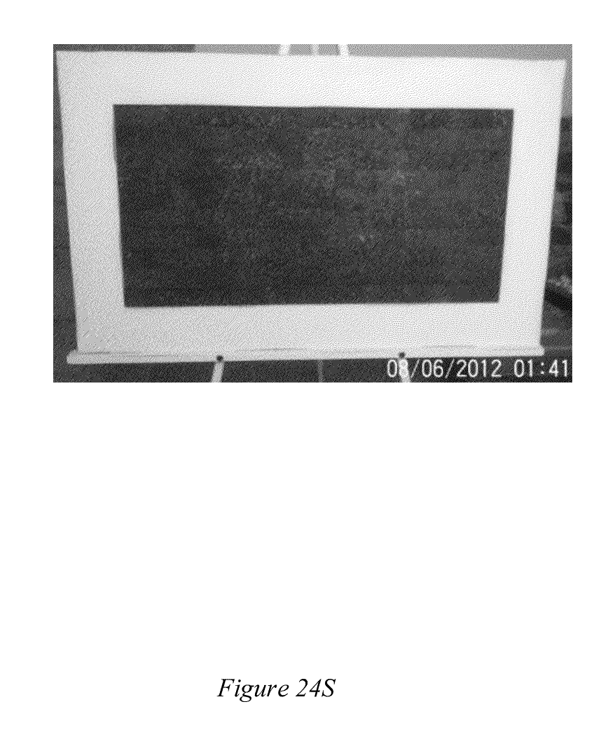

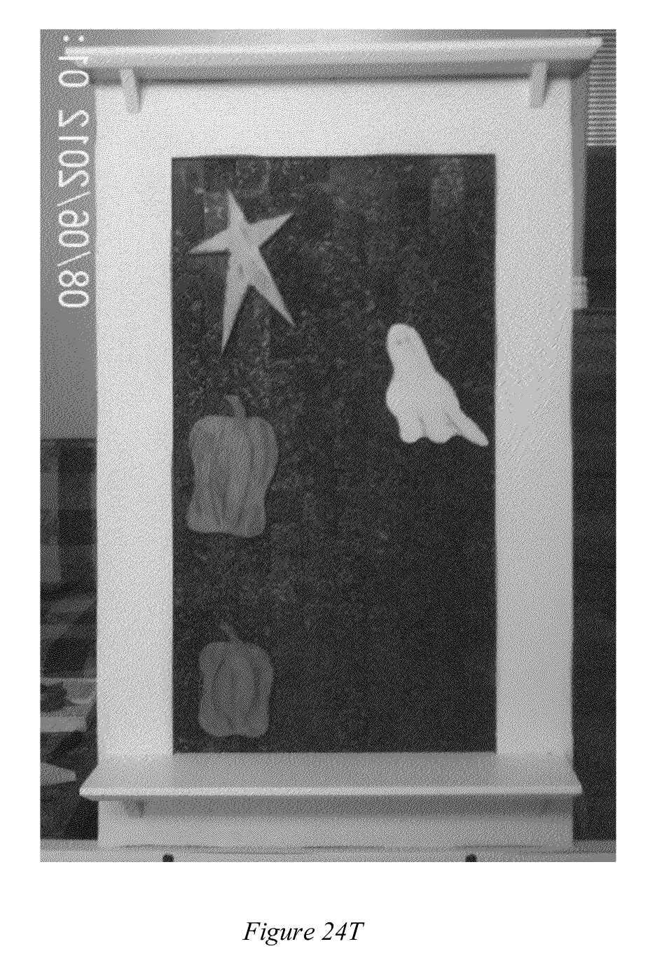

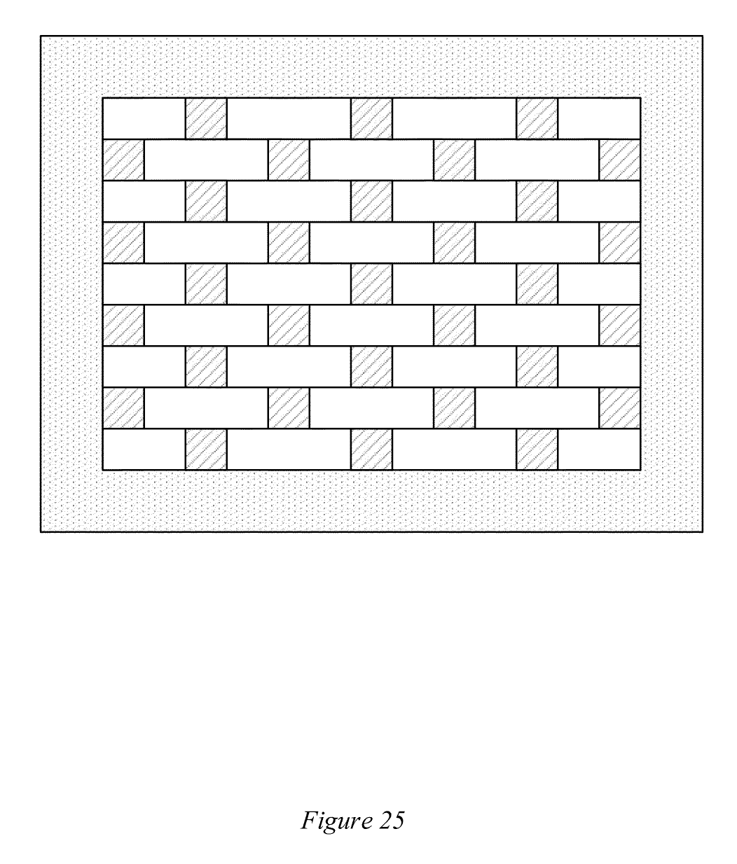

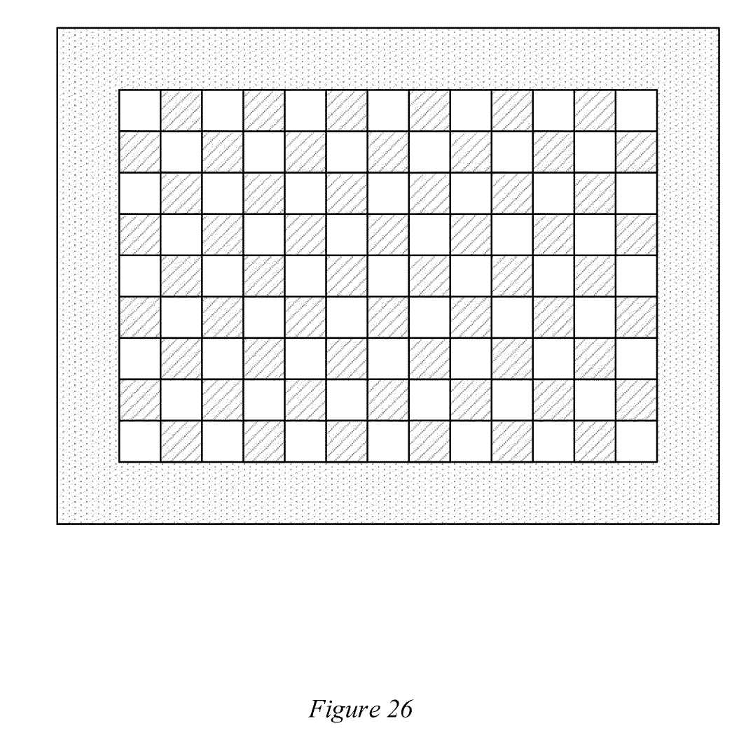

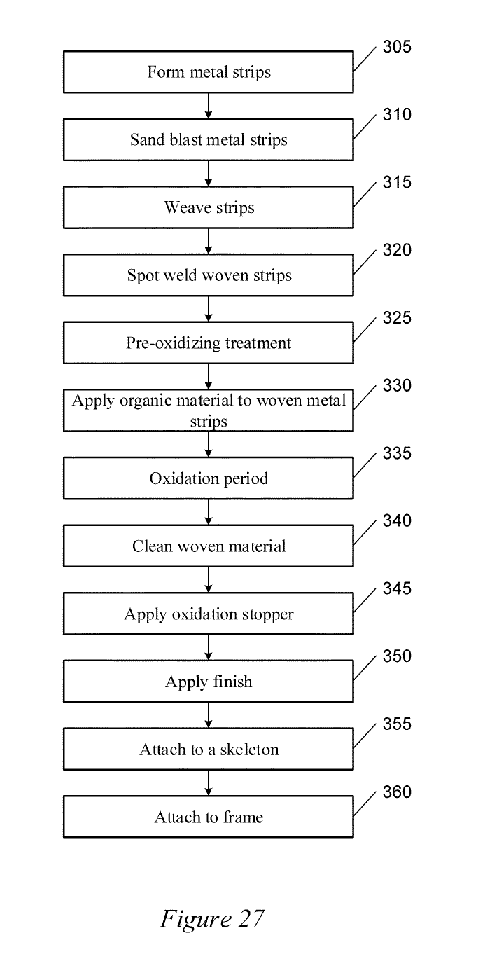

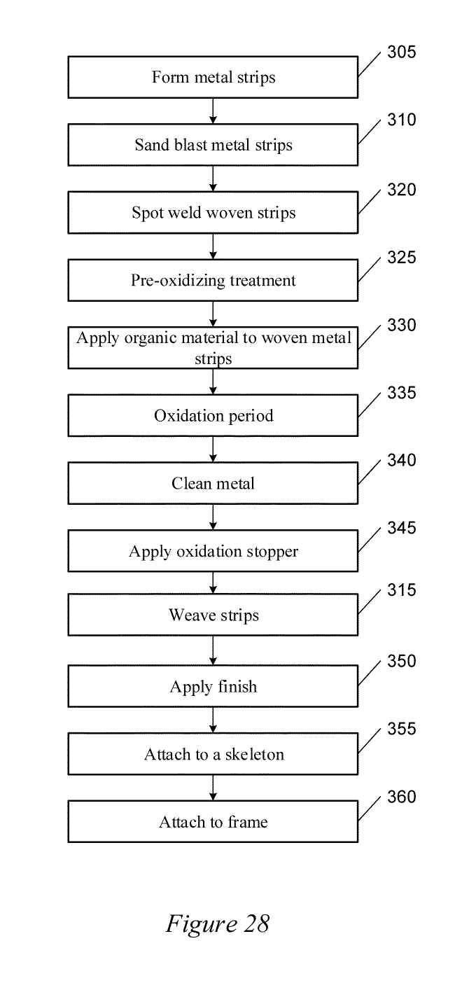

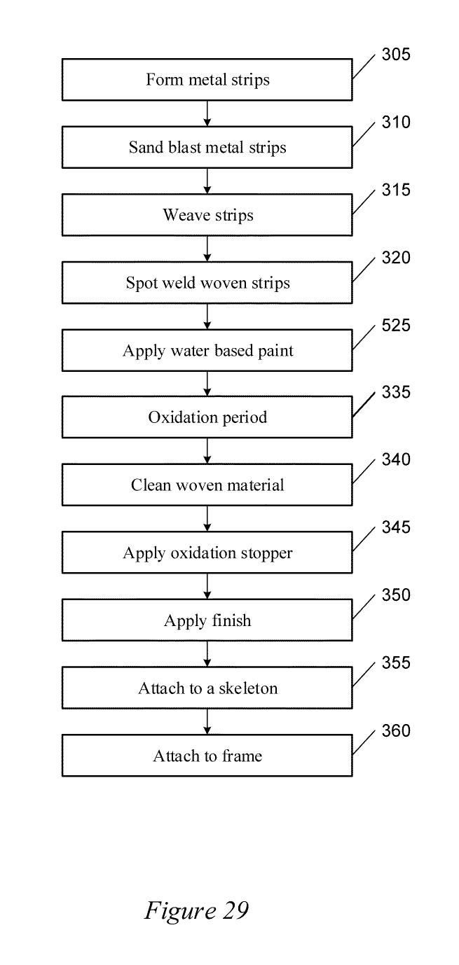

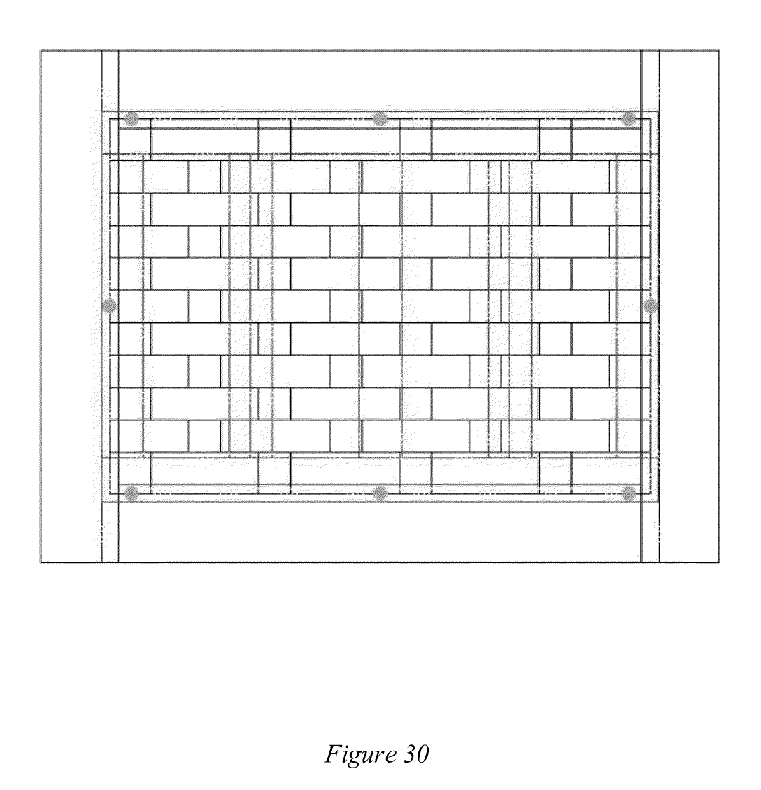

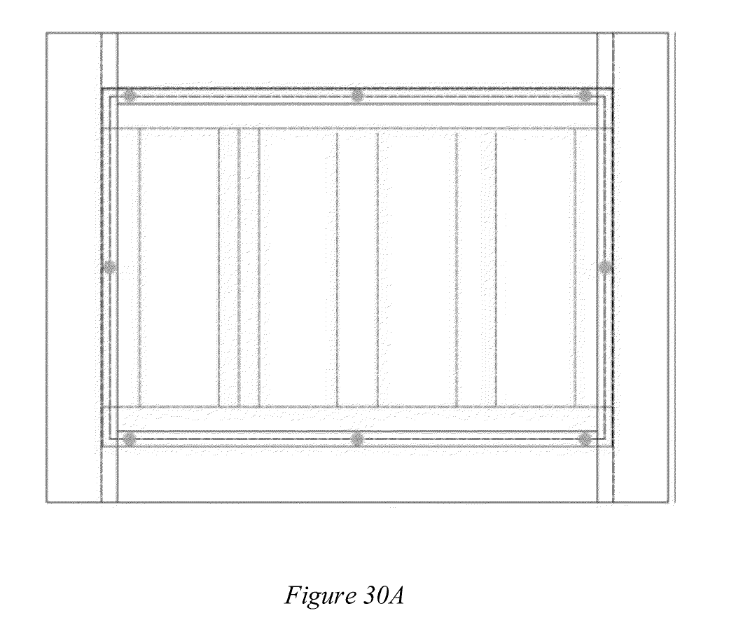

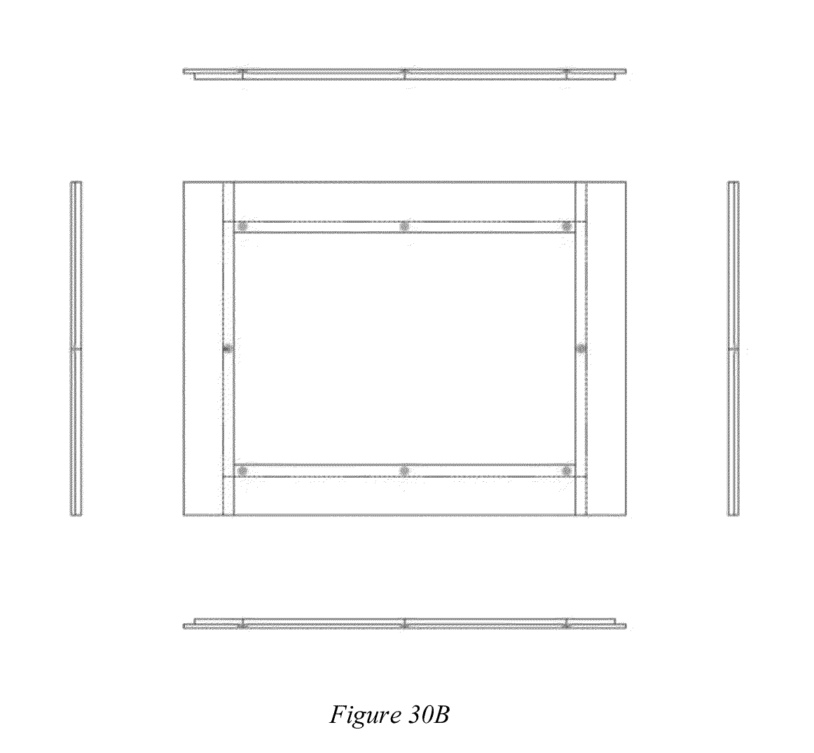

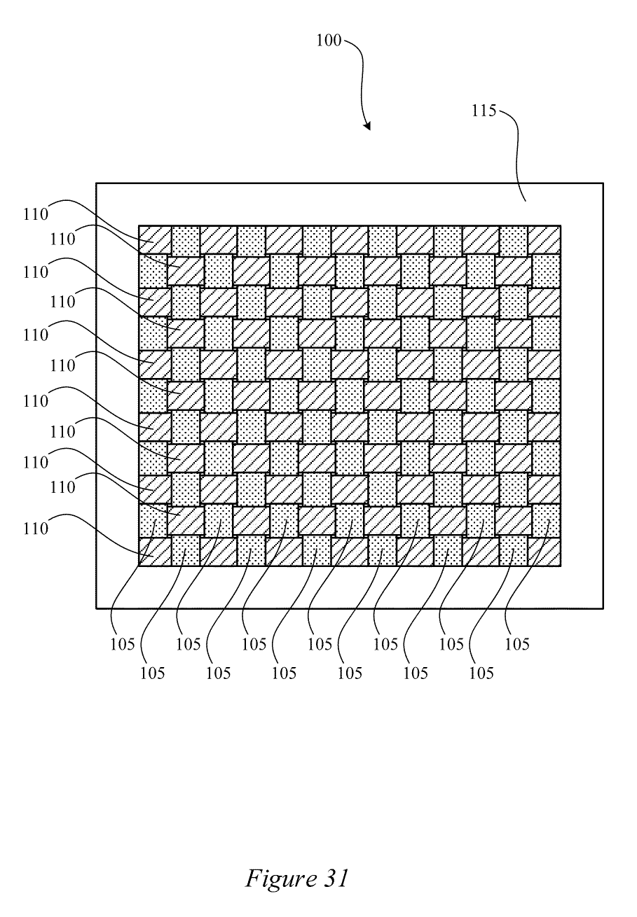

FIG. 16C illustrates a backside or under side of the magnet board illustrated in FIG. 1, and illustrates a T-Groove dado channels and/or a diagonal drilled hole(s) configuration that may be used on the frame according to at least one embodiment described herein.

FIG. 17 illustrates a configuration of a magnet board according to at least one embodiment described herein.

FIG. 17A illustrates a different view of the magnet board illustrated in FIG. 17.

FIG. 17B illustrates a backside or under side of the magnet board illustrated in FIG. 1, and illustrates a dado groove channel and/or a diagonal drilled hole(s) configuration that may be used on the frame according to at least one embodiment described herein.

FIG. 17C illustrates a backside or under side of the magnet board illustrated in FIG. 1, and illustrates a T-Groove dado channels and/or a diagonal drilled hole(s) configuration that may be used on the frame according to at least one embodiment described herein.

FIG. 18 illustrates a rail ends profile, showing both dado groove channels according to at least one embodiment described herein.

FIG. 18A illustrates a rail ends profile, showing the T-groove channel and the outside edge dado groove channel according to at least one embodiment described herein.

FIG. 18B illustrates a rail ends profile without any dado groove channels or T-groove channel and the outside edge dado groove channel according to at least one embodiment described herein.

FIG. 19 illustrates a configuration of the top ⅜″×¾″ magnet modular that is placed into the dado groove channel. It illustrates a retention and placement of magnets according to at least one embodiment described herein.

FIG. 19A illustrates a single magnet modular that retains a single magnet and is used in the T-groove channel according to at least one embodiment described herein.

FIG. 19B illustrates a possible layout configuration of how wood filler pieces and magnets are placed and retained in the dado groove channels according to at least one embodiment described herein.

FIG. 19C illustrates a possible layout configuration of the dado groove channel Neodymium Magnet modular which contains magnets and is placed and retained in the dado groove channels according to at least one embodiment described herein.

FIG. 19D illustrates a corner drawing of the 3 drilled out holes located in the corners of the frame. These holes are used for the placement and retention of magnets, for example, Neodymium Magnets, according to at least one embodiment described herein.

FIG. 19E illustrates a use of the wood filler pieces and the way they retain a hold Neodymium magnets, and the different sizes of wood filler pieces according to at least one embodiment described herein.

FIG. 20 illustrates a layout view of the retention stop material for the installation of the woven metal canvas according to at least one embodiment described herein.

FIG. 21 illustrates a side profile view of a top rail shelf or a top stile shelf according to at least one embodiment described herein.

FIGS. 21A and 21B illustrate a side profile view of a top rail shelf and a bottom rail shelf or a bottom stile shelf according to at least one embodiment described herein.

FIG. 21C illustrates a front view layout of the top shelf and the bottom shelf according to at least one embodiment described herein.

FIG. 21D illustrates a front view and bird's eye view of a small magnetic shelf for the Woven Metal Canvas according to at least one embodiment described herein.

FIG. 21E illustrates a side profile view of a bottom rail shelf or a bottom stile shelf according to at least one embodiment described herein.

FIG. 22 illustrates a side profile view of a magnetic floral arrangement container shelf according to at least one embodiment described herein.

FIG. 22A illustrates a front and bird's eye view of the magnetic floral arrangement container shelf according to at least one embodiment described herein.

FIG. 23 illustrates a configuration of a magnet board according to at least one embodiment described herein.

FIG. 23A illustrates a different view of the magnet board illustrated in FIG. 23.

FIG. 23B illustrates a backside or under side of the magnet board illustrated in FIG. 1, and illustrates a dado groove channel and/or a diagonal drilled hole(s) configuration that may be used on the frame according to at least one embodiment described herein.

FIG. 23C illustrates a backside or under side of the magnet board illustrated in FIG. 1, and illustrates a T-Groove dado channels and/or a diagonal drilled hole(s) configuration that may be used on the frame according to at least one embodiment described herein.

FIG. 24 illustrates an image picture of a backside corner of a frame, it illustrates a top rail with the 2 dado groove channels, one hole in the corner out of the 3 that can be present, and the single dado groove channel on the stile according to at least one embodiment described herein.

FIG. 24A illustrates an image picture of a backside corner, depicting the 2 dado groove channels in the stile and the 2 dado groove channels in the rail of the frame according to at least one embodiment described herein.

FIG. 24B illustrates a backside of a frame depicting the stop material that may anchor the woven metal canvas into place, along with the dado groove channels and the single drilled hole according to at least one embodiment described herein.

FIG. 24C illustrates an overall configuration of the dado groove channels, drilled single holes in all corners, the woven metal retention stop material and the woven metal canvas according to at least one embodiment described herein.

FIG. 24D illustrates a front view of a woven magnet board configuration. In this image the vertical metal pieces have been painted black, the horizontal piece are sanded raw pieces of metal. The image illustrates a final look and configuration of the woven effect of the said pieces according to at least one embodiment described herein.

FIG. 24E illustrates a front view of a woven magnet board configuration along with a number of different magnetic accessory pieces that are magnetically attached to the woven metal canvas according to at least one embodiment described herein.

FIG. 24F illustrates an image of a magnetically anchored small woven metal shelf according to at least one embodiment described herein.

FIG. 24G illustrates a close up view of the woven detail of the woven metal canvas and it tries to depict the patina of the metal according to at least one embodiment described herein.

FIG. 24H illustrates a woven magnet board overall look and feel according to at least one embodiment described herein.

FIG. 24I illustrates a woven magnet board overall look and feel according to at least one embodiment described herein.

FIG. 24J illustrates a woven magnet board overall look and feel according to at least one embodiment described herein.

FIG. 24K illustrates a woven magnet board overall look and feel according to at least one embodiment described herein.

FIG. 24L illustrates a close up image of the painted pigmented woven metal canvas according to at least one embodiment described herein.

FIG. 24M illustrates a woven magnet board overall look and feel according to at least one embodiment described herein.

FIG. 24N illustrates a woven magnet boards according to at least one embodiment described herein.

FIG. 24O illustrates according to at least one embodiment described herein.

FIG. 24P illustrates a versatility of the dado groove channel on the backside of the frame, by showing the anchoring and attachment of several magnetic accessory pieces magnetically attached to the frame itself according to at least one embodiment described herein.

FIG. 24Q illustrates a close up image of a section of a woven metal canvas with a different rusted patina, which is the result from another patina processing method according to at least one embodiment described herein.

FIG. 24R illustrates a close up image of the corner section of a woven metal canvas with a different rusted patina according to at least one embodiment described herein.

FIG. 24S illustrates a woven magnet boards overall look and feel. It illustrates a woven detail of the woven metal canvas and it tries to depict the patina of the metal according to at least one embodiment described herein.

FIG. 24T illustrates a woven magnet boards overall look and feel according to at least one embodiment described herein.

FIG. 25 illustrates a woven magnet boards according to at least one embodiment described herein.

FIG. 26 illustrates a woven magnet boards according to at least one embodiment described herein.

FIG. 27 illustrates a flowchart of an example process for creating a patina on a metallic canvas according to at least one embodiment described herein.

FIG. 28 illustrates a flowchart of an example process for creating a patina on a metallic canvas according to at least one embodiment described herein.

FIG. 29 illustrates a flowchart of an example process for creating a patina on a metallic canvas according to at least one embodiment described herein.

FIGS. 30, 30A and 30B illustrate various other techniques may be used to mount the woven metal canvas to a frame according to at least one embodiment described herein.

FIG. 31 illustrates a woven magnetic board according to some embodiments described herein.

### DETAILED DESCRIPTION

Embodiments of the invention include a wood frame that surrounds a woven metal canvas made up of both horizontal and vertical strips of metal. In some embodiments, the metal may include, for example, individual strips of cold rolled steel that has been through a patina process and then woven together to create a woven metal canvas. The woven metallic canvas can be placed within a frame. In some embodiments, on the underside of the frame is a network of dado channels, T-Groove channels and/or drilled holes. These dado channels, T-groove channels and/or drilled holes may allow for the placement and/or retention of magnets, for example, Neodymium Magnets. The magnets, for example, may be placed into the channel by either a magnet modular which can contain one magnet or a group of magnets that are preset for the desired display configuration or, a single magnet by its self. These magnets may become the opposing magnets for the magnets the will be displayed and shown on the surface of the frame.

As shown in FIG. 31, a woven metallic canvas 100 may include, for example, a plurality of vertical metallic strips 105 and a plurality of horizontal metallic strips 110 that are woven together. In some embodiments, the plurality of horizontal metallic strips may include metallic strips that are arranged horizontally and woven above and below alternate ones of the plurality of vertical metallic strips. In some embodiments, the plurality of vertical metallic strips may include metallic strips that are arranged vertically and woven above and below alternate ones of the plurality of horizontal metallic strips. In some embodiments, the plurality of vertical metallic strips and/or the plurality of horizontal metallic strips may have the same width. In some embodiments, the plurality of vertical metallic strips and/or the plurality of horizontal metallic strips may be disposed within frame 115.

Embodiments of the invention also include one or more patina processes for creating a rust-like effect on the metal.

In some embodiments, the strength of the magnets and the configuration of the dado channels may create a display environment that permits the display of heavy, odd shaped, long, and/or unique display elements, wood shelves, art, vases, candles, and many more accessories. Resulting in a versatile magnetic board that contains an artistic look and feel which can be proudly displayed anywhere in a home, office, building etc.

Various embodiments are described herein that include specific dimensions. These dimensions are provided as examples only and are not meant to limit the disclosure to the provided dimension. Instead, these dimensions are provided only to describe some useable embodiments. Certainly many other sizes shape, and/or patterns may be used without deviating from what is disclosed herein.

Some embodiments described herein include a frame that may include two stiles and two rails that are coupled together to enclose a metallic canvas of woven metallic strips. The rails and/or stiles may be made a softwood, wood species or hardwood, wood species or engineered MDF or engineered Plywood or engineered plastic compound material or mold casted plastic compound material or forged melted metal casted or forged casted bronze metal or a mixture of metals that are formed and casted or a welded metal or tig welded metal to form the frame configuration. In some embodiments the 2 stile pieces and/or 2 rail pieces may be the same width and/or thickness.

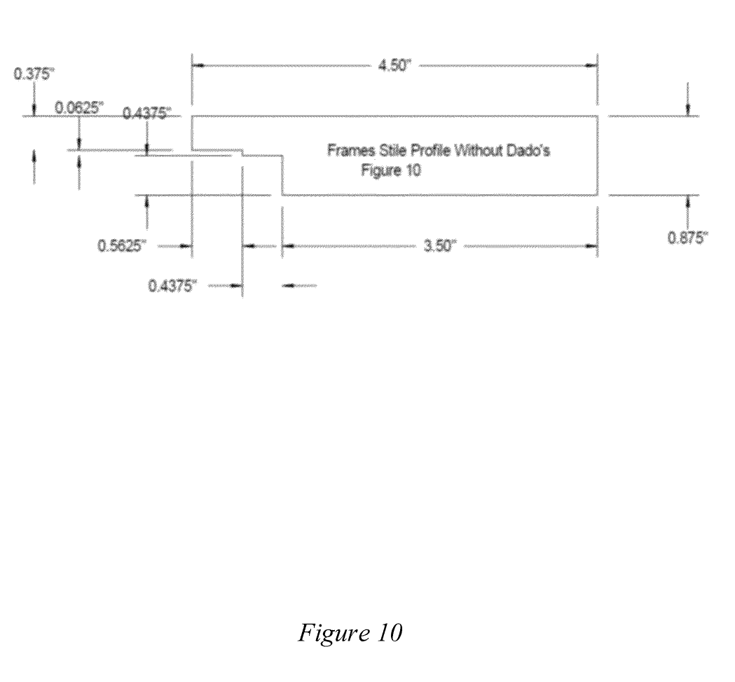

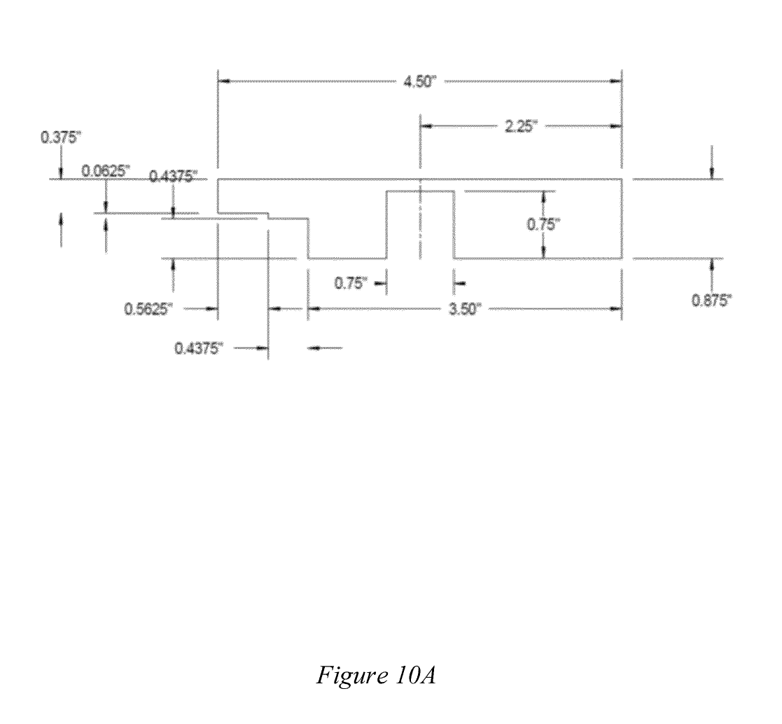

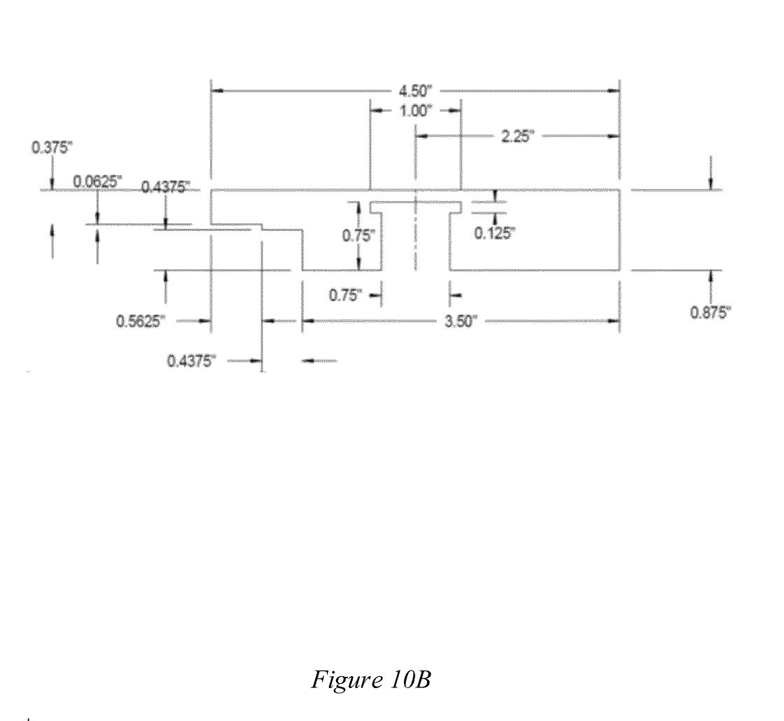

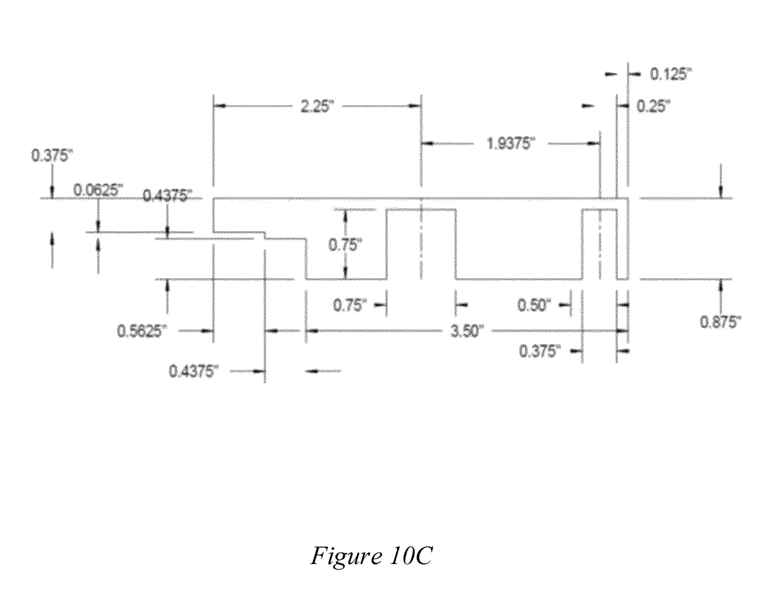

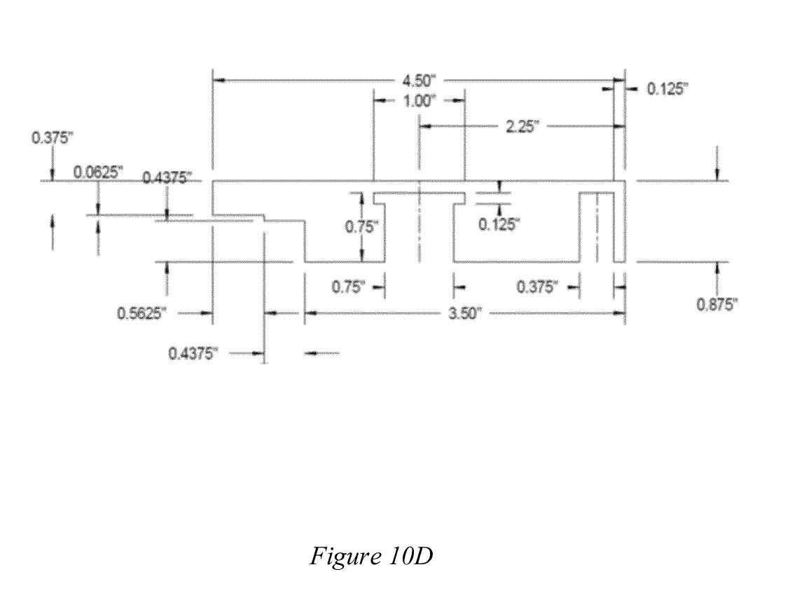

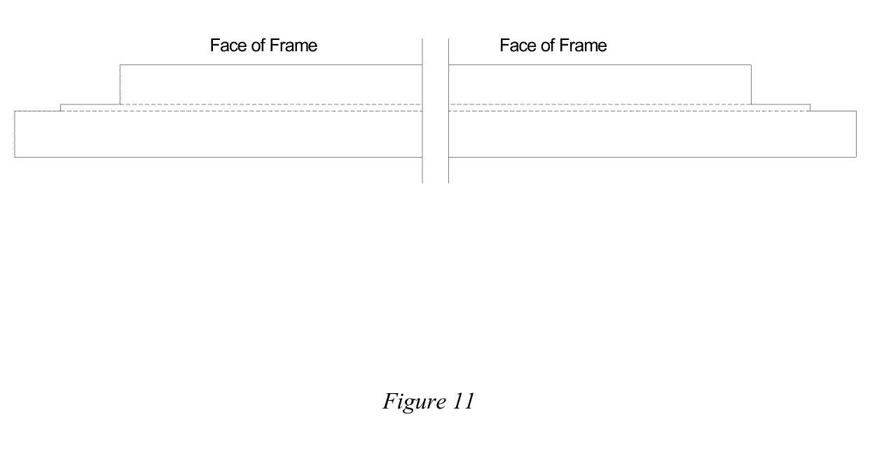

In some embodiments, the backside of each stile and/or rail may include a dado groove (or cut). This dado groove may include two parts of a single dado groove. For example, the dado groove may have a width of 1 inch wide by ½ inch deep. As another example, the dado groove may be located and milled into one long edge of the frame pieces beginning with the outside dado groove which measures 9/16″×½″. This dado groove may be milled, for example, along the whole length of all boards of the frame. The remaining part of the dado groove may be milled, for example, at the 1″ mark next to the dado groove mention above at a depth of, for example, 7/16″× 7/16″. This dado groove is milled along the whole length of all boards of the frame as shown, for example, in FIG. 10.

In some embodiments, on the front face and at both distal ends of each rail piece(s), is a dado groove that mates and fits into the dado groove of the stile pieces. This dado groove may be the reverse of the above mentioned stile dado groove, which when milled into the distal ends of each rail piece may fit snug and tight to the adjoining stile pieces. The dado groove may be, for example, 1 inch wide, it may include two parts, an outside dado groove being milled at, for example, 7/16″ deep by 7/16″ on each distal end of said boards face side and the inner most dado groove being milled and cut, for example, at ½″ deep by 9/16″ wide on each distal end of said boards.

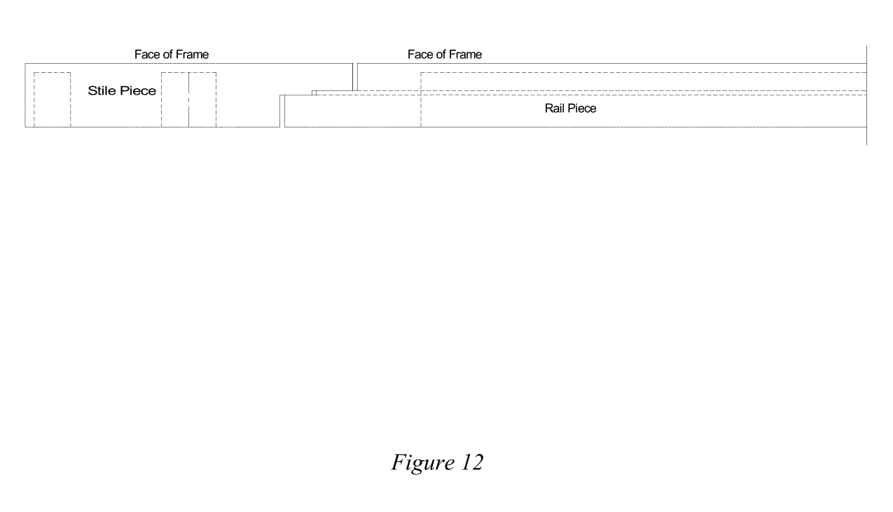

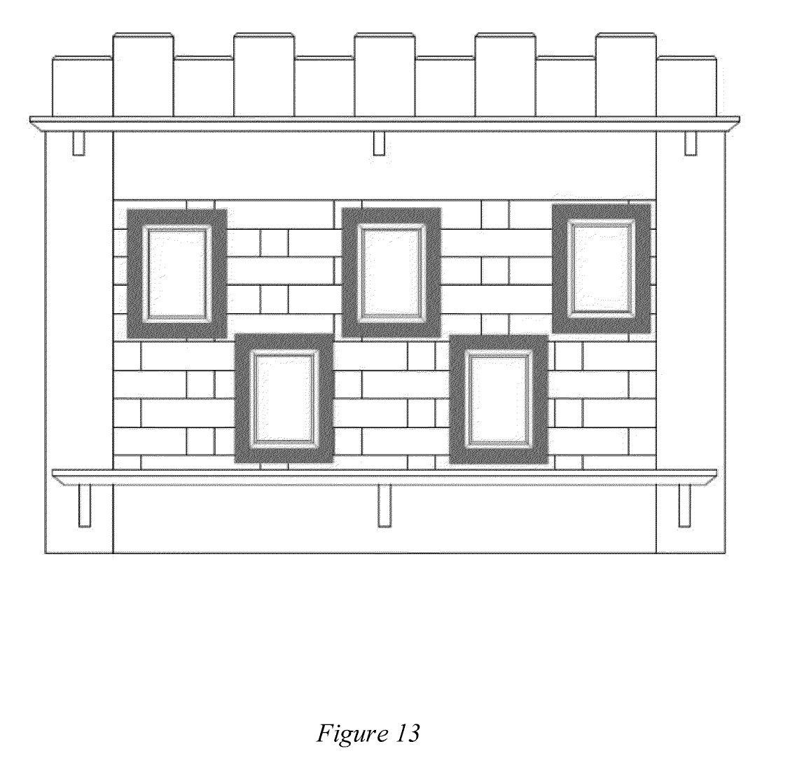

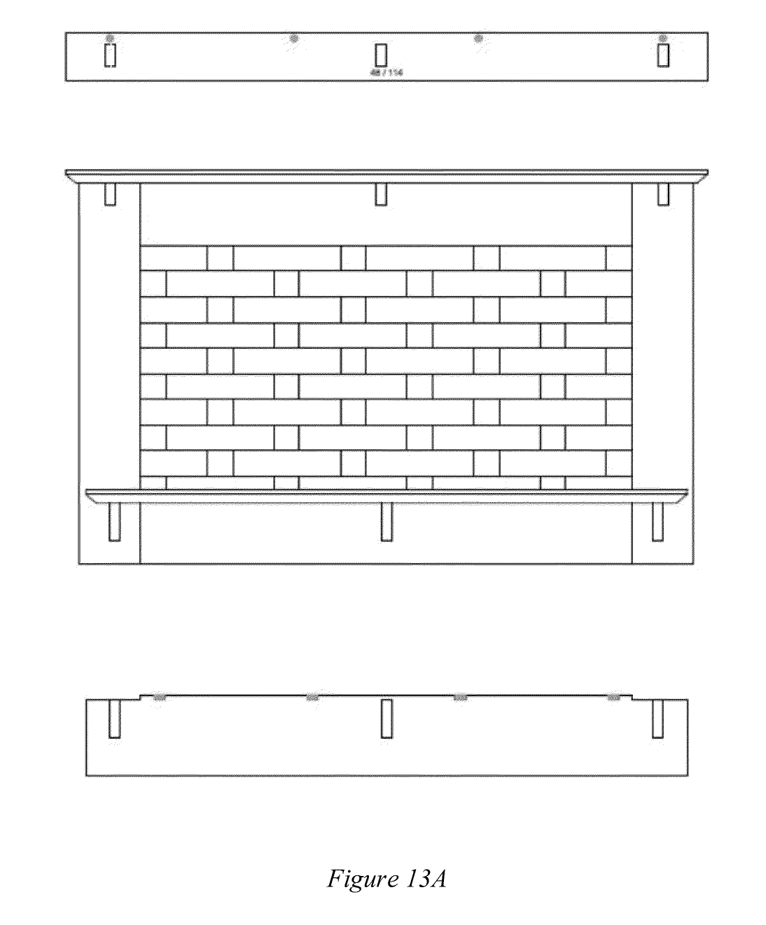

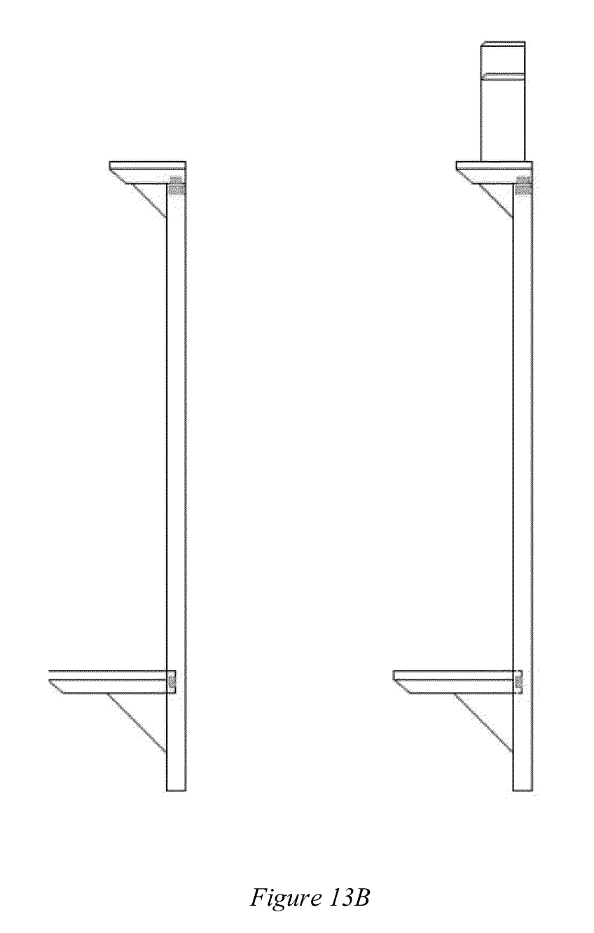

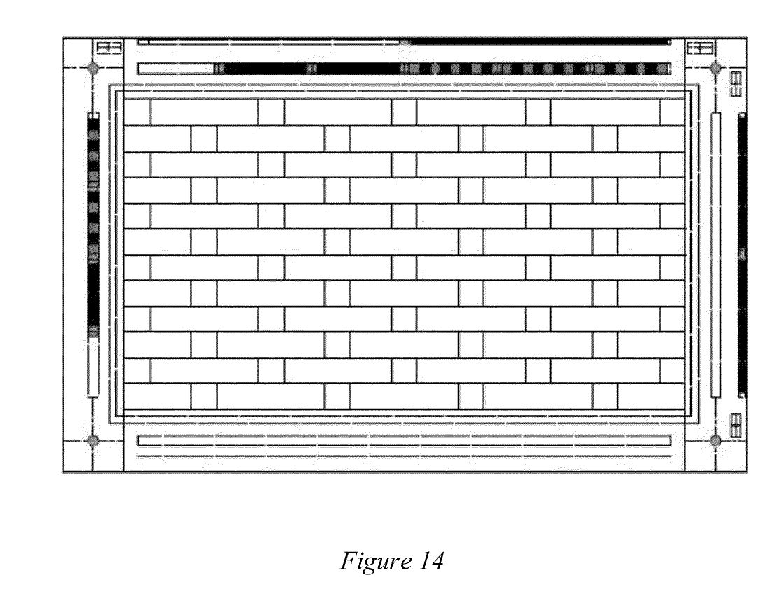

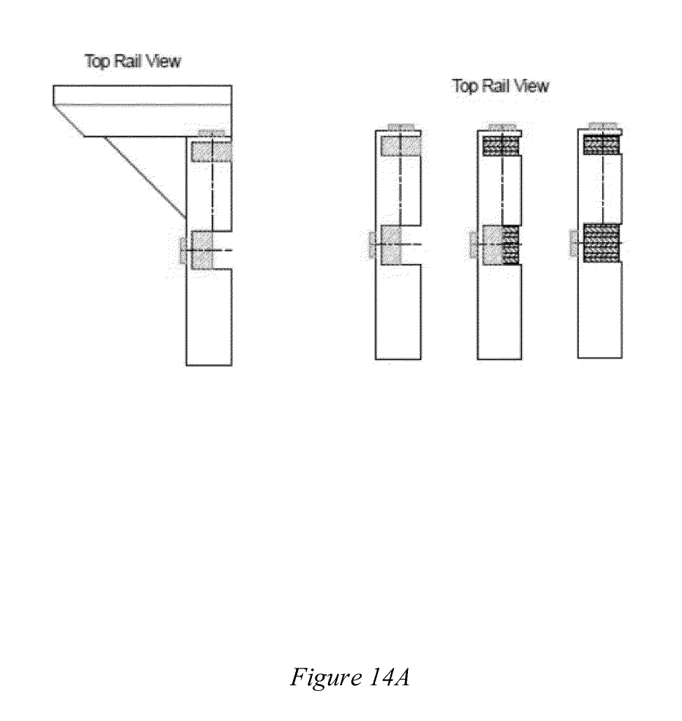

In some embodiments, the 2 rail pieces one being the upper rail and the other being the lower rail may be joined to the 2 side stile pieces distal ends with the above mention dado groove which looks and acts like a typical stile and rail joinery, this joint resembles a butt joint, but is in fact a joint similar to a tongue and groove joint. The configuration of the joint is such that the 2 side stile pieces are the pieces that the upper and lower rail pieces mate into. This joint is glued and pressure clamped to form a solid no void glued joint and a final frame configuration as shown, for example, in FIG. 12.

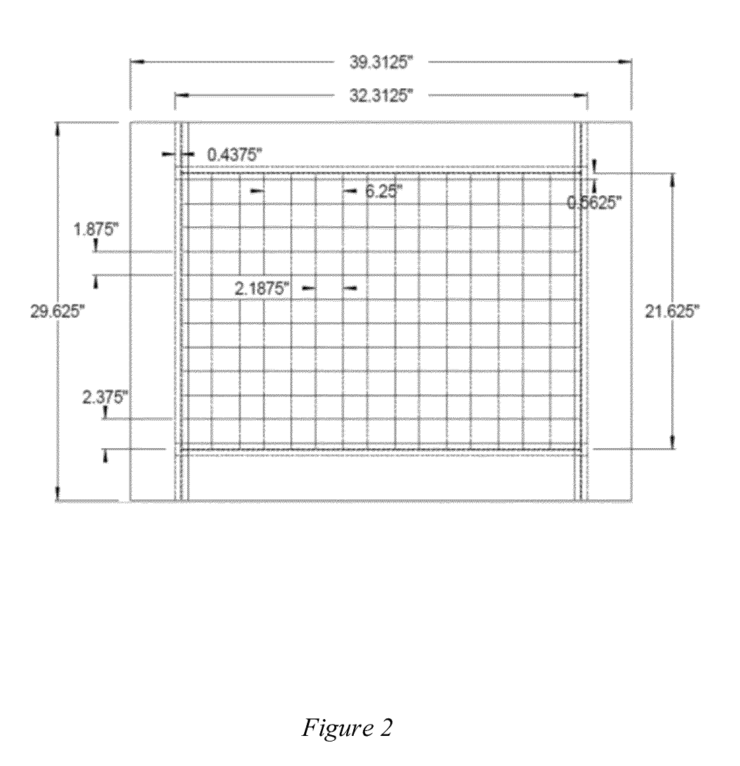

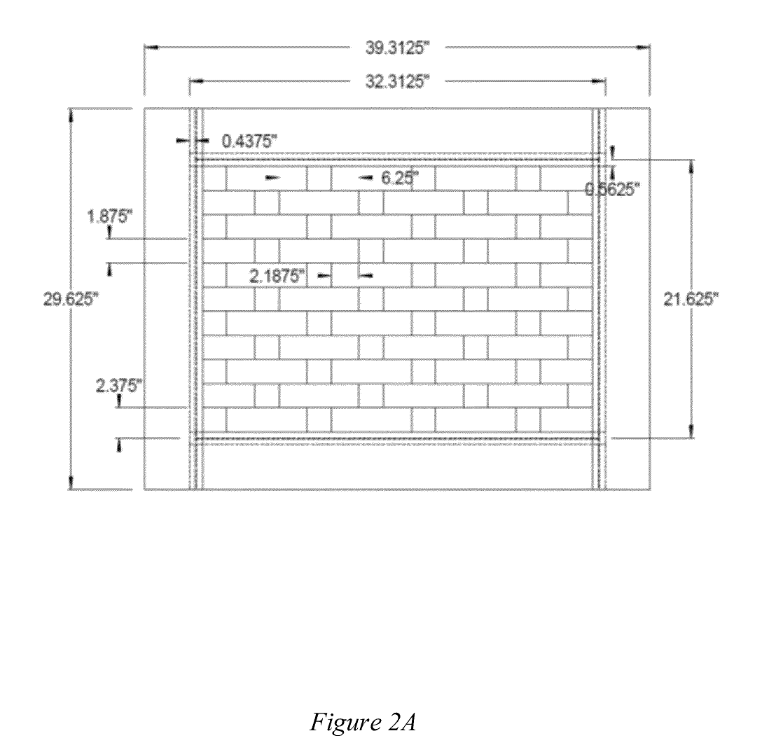

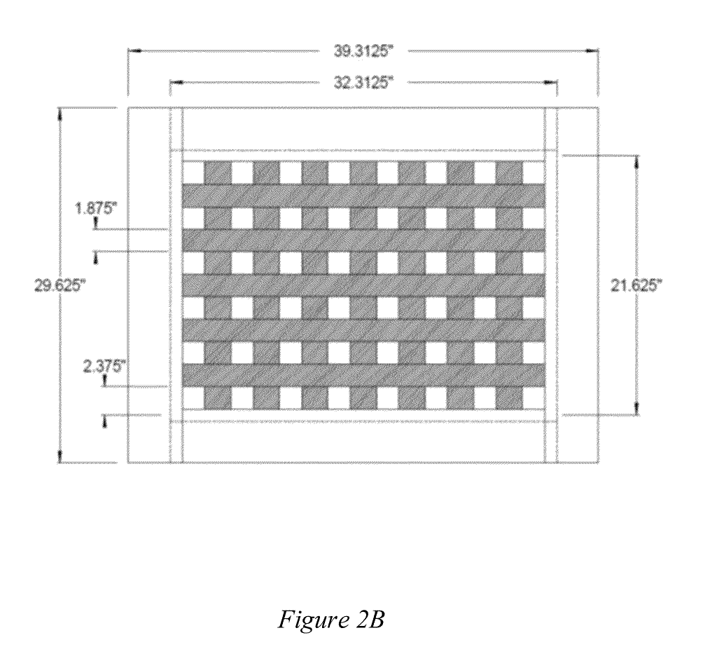

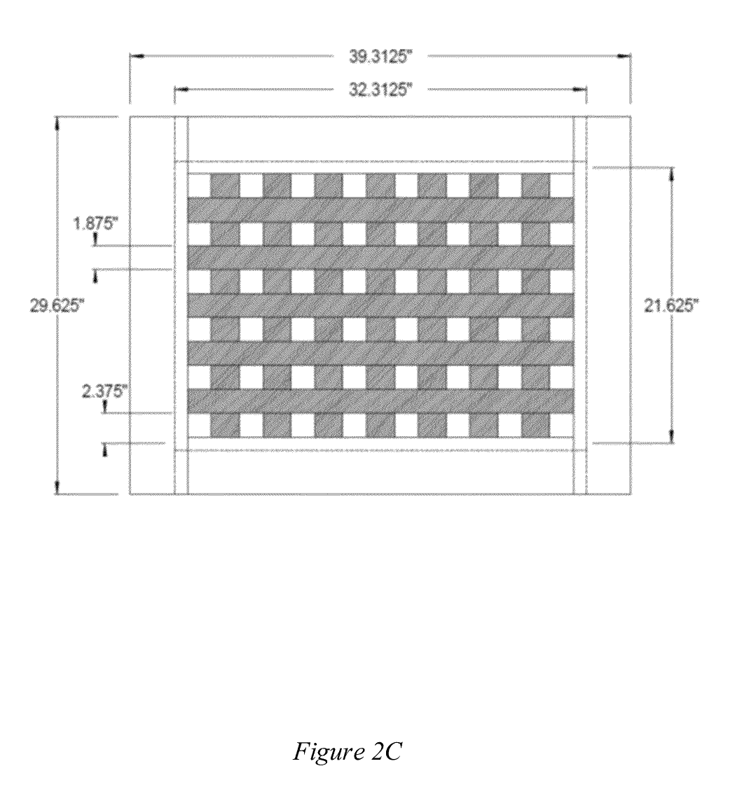

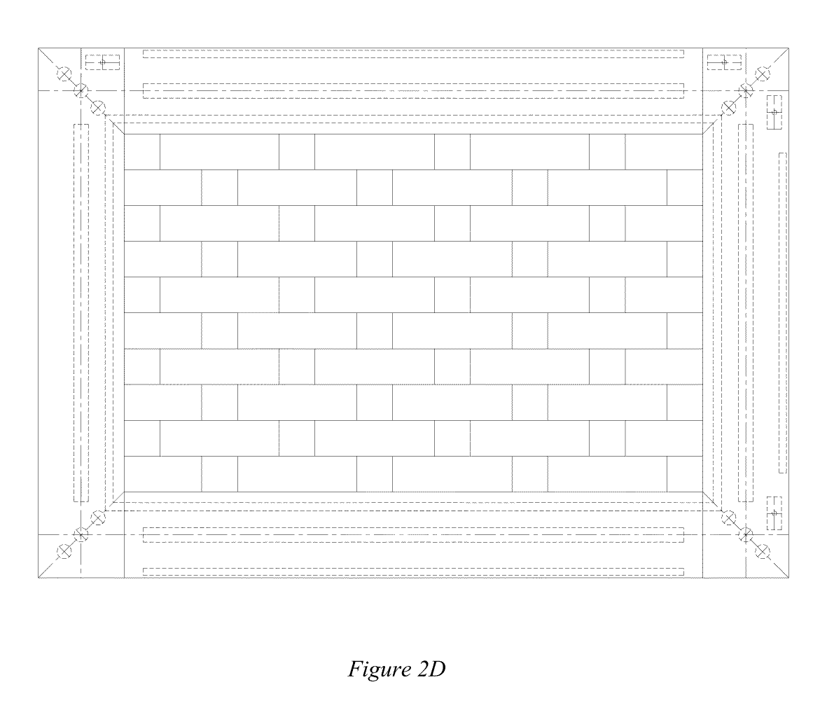

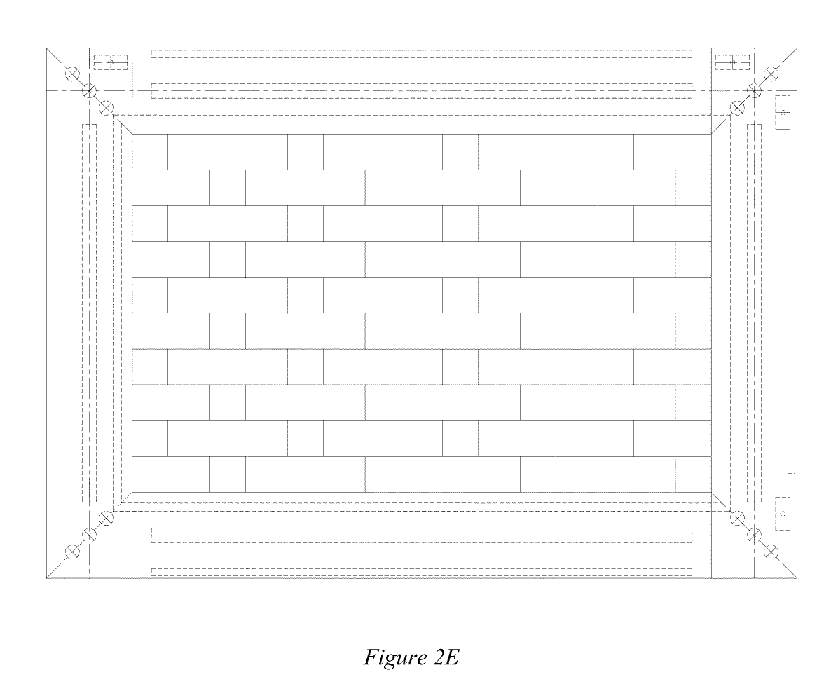

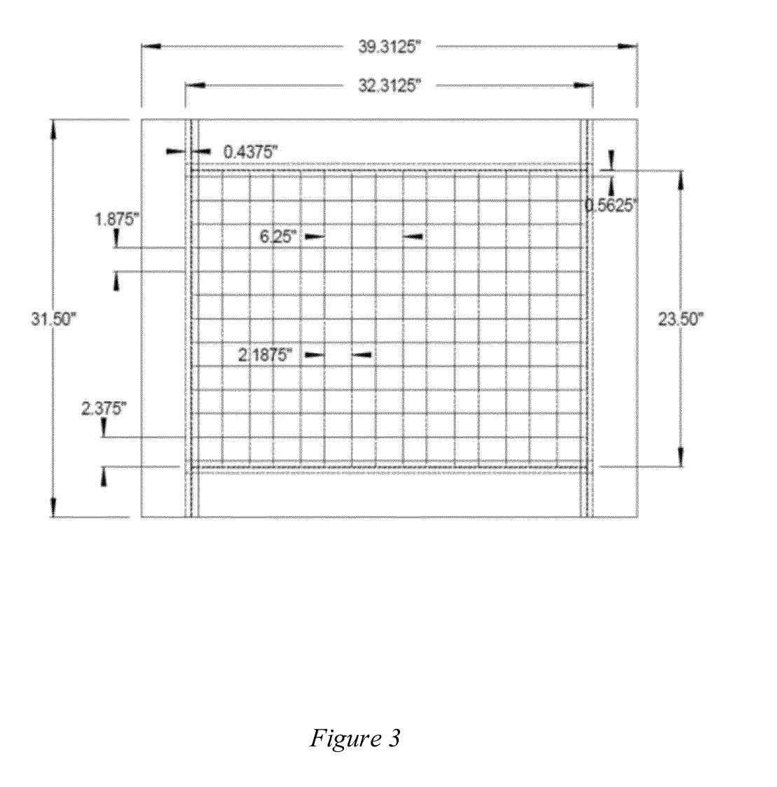

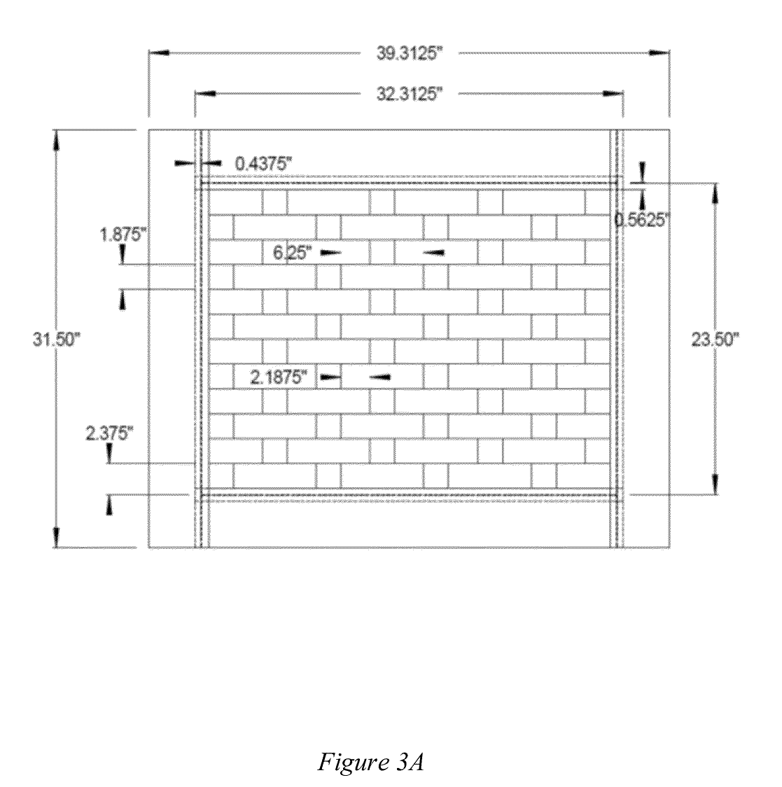

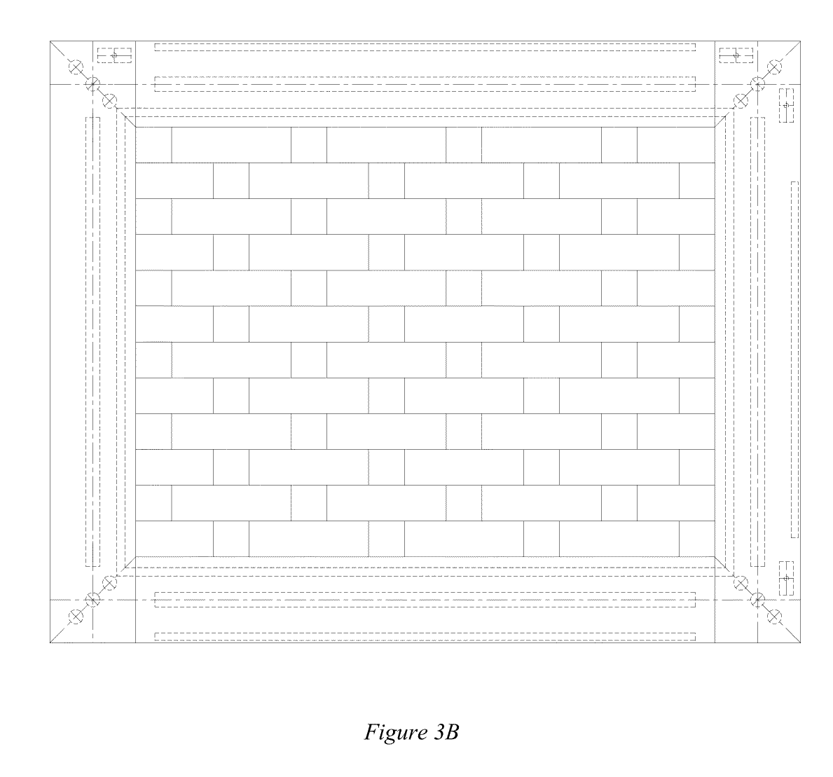

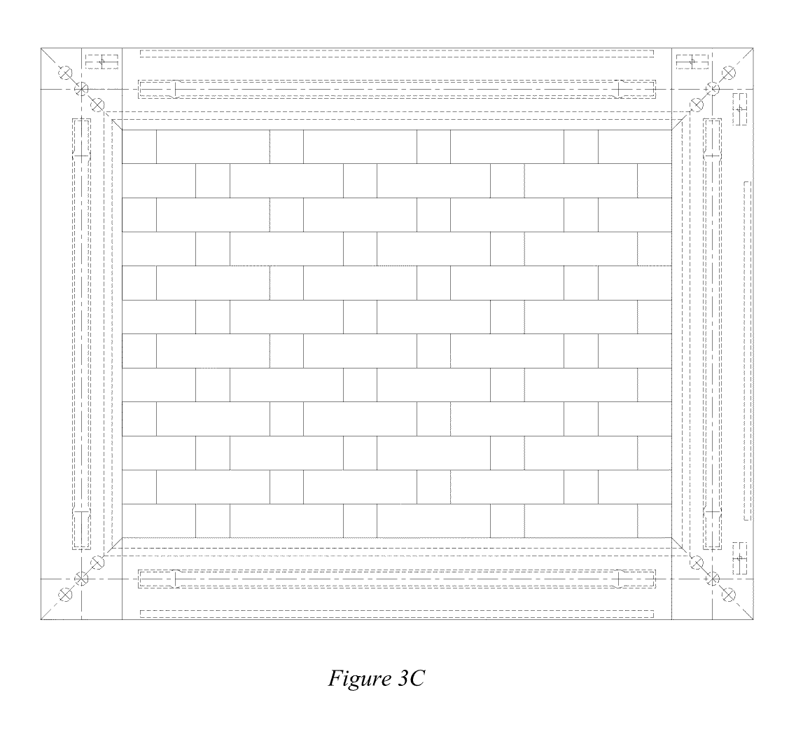

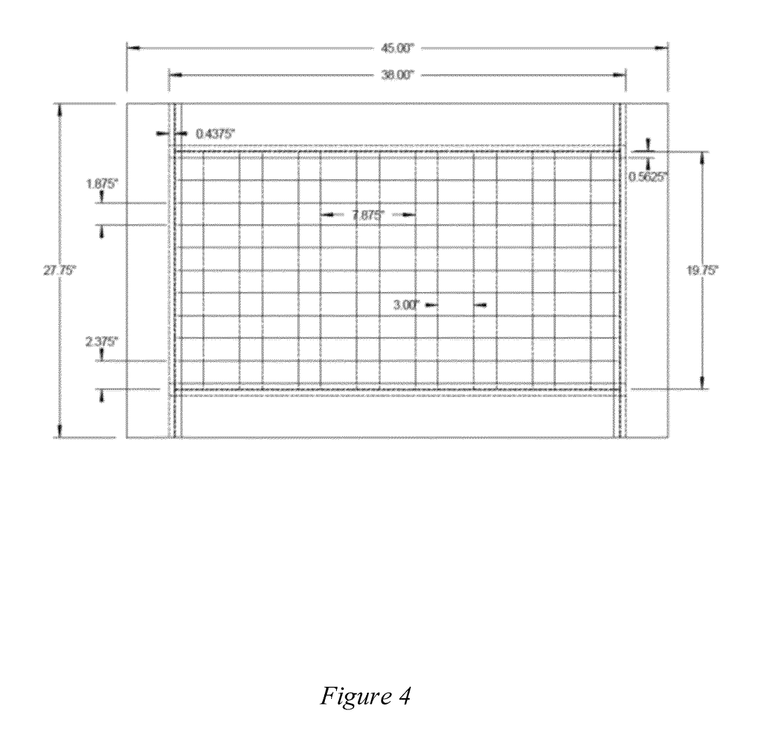

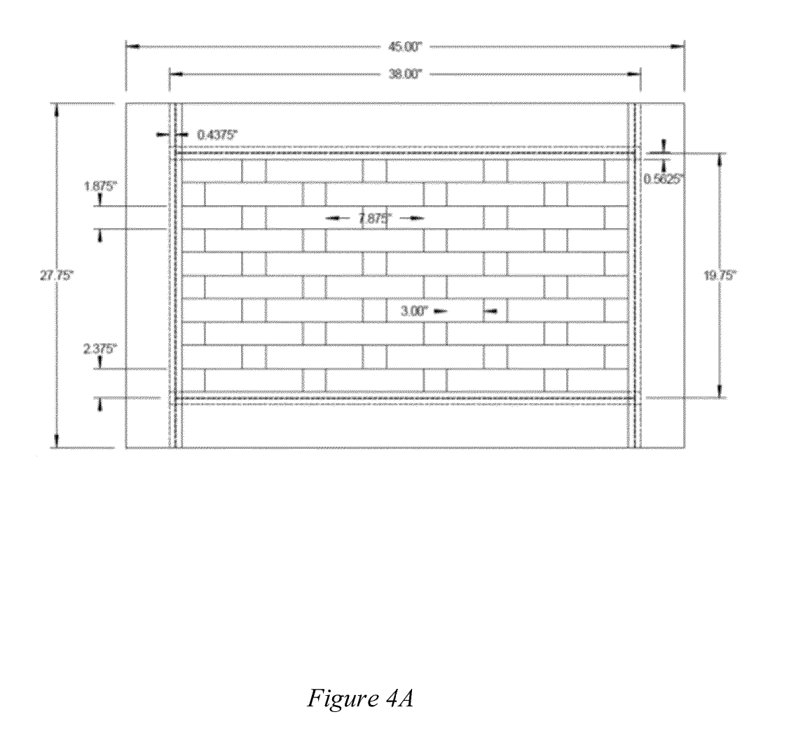

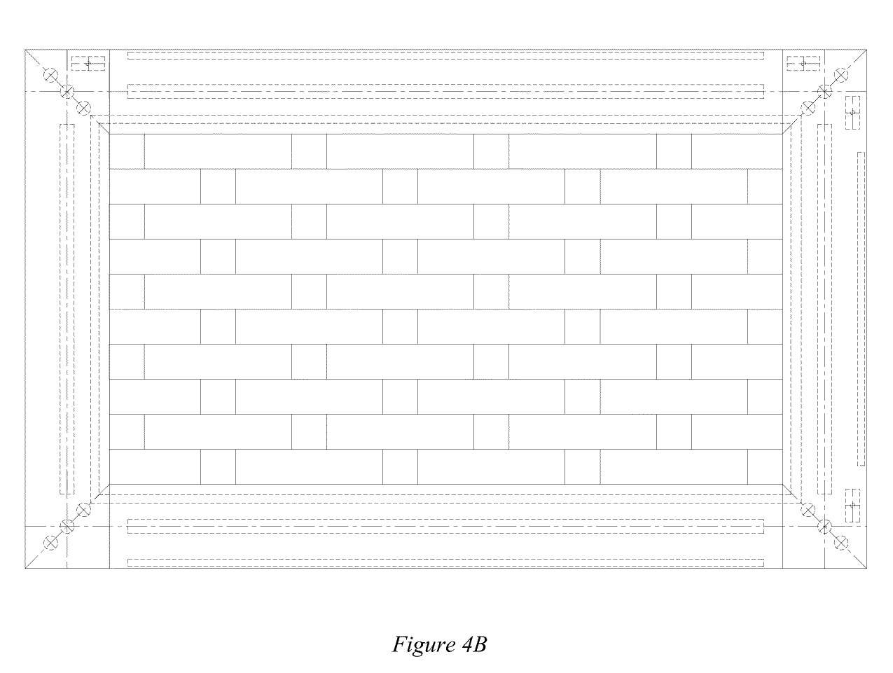

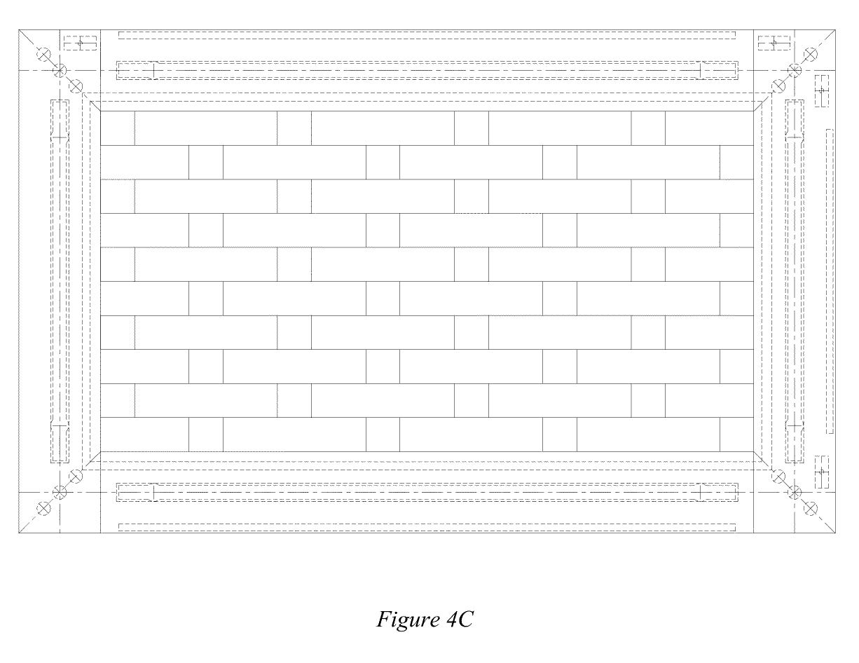

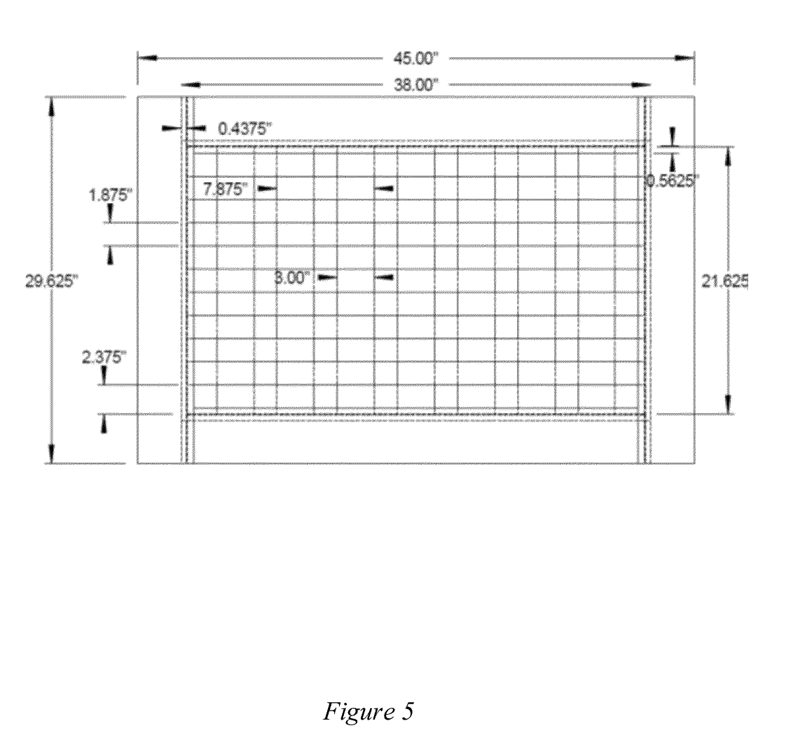

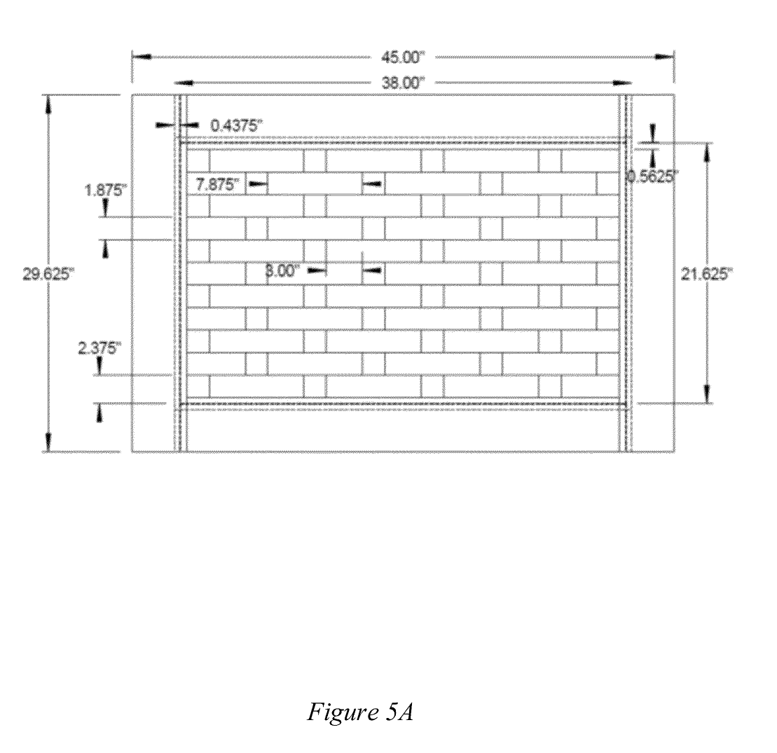

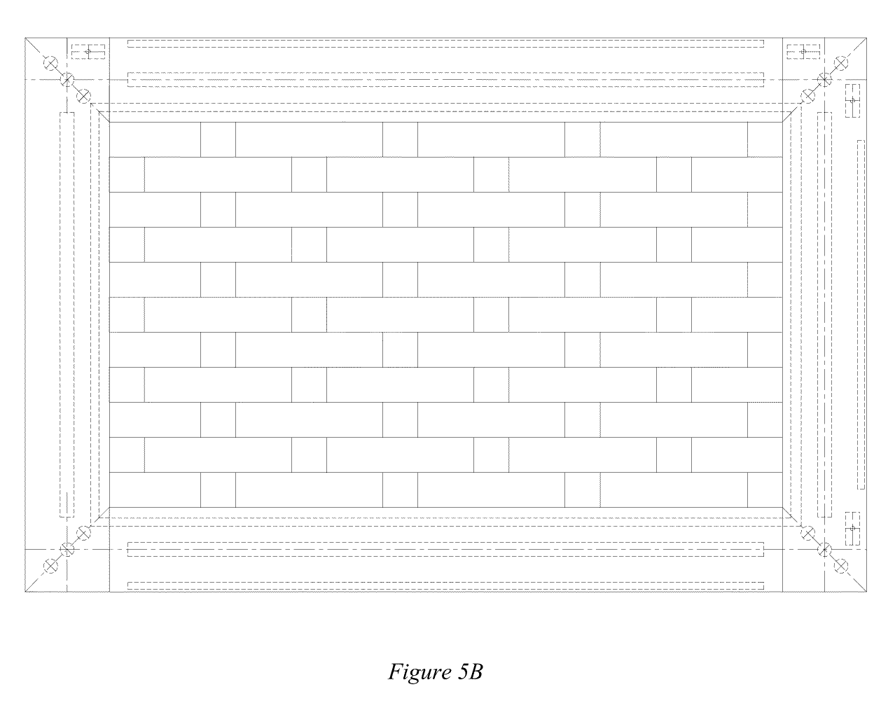

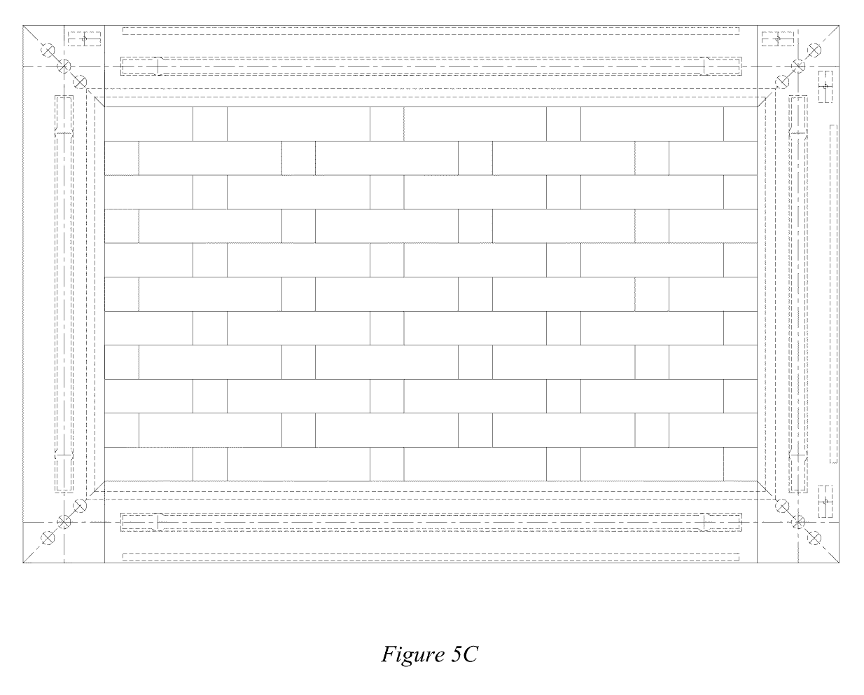

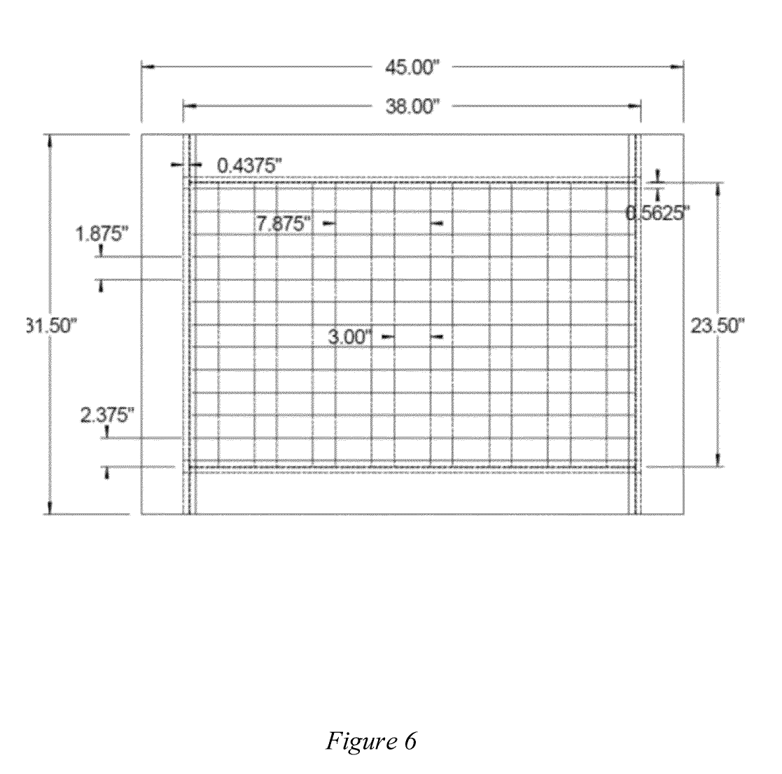

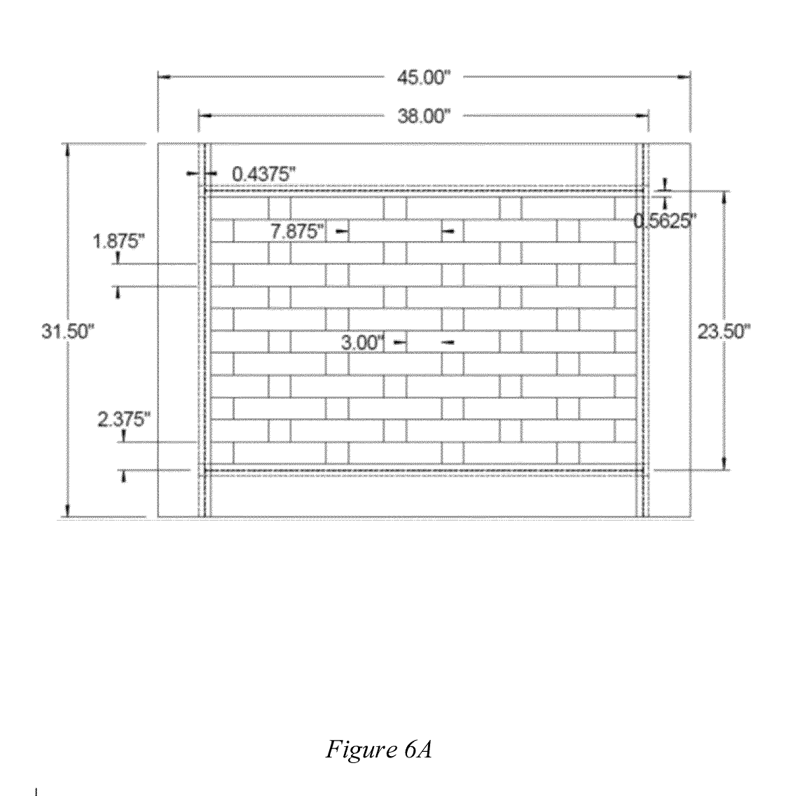

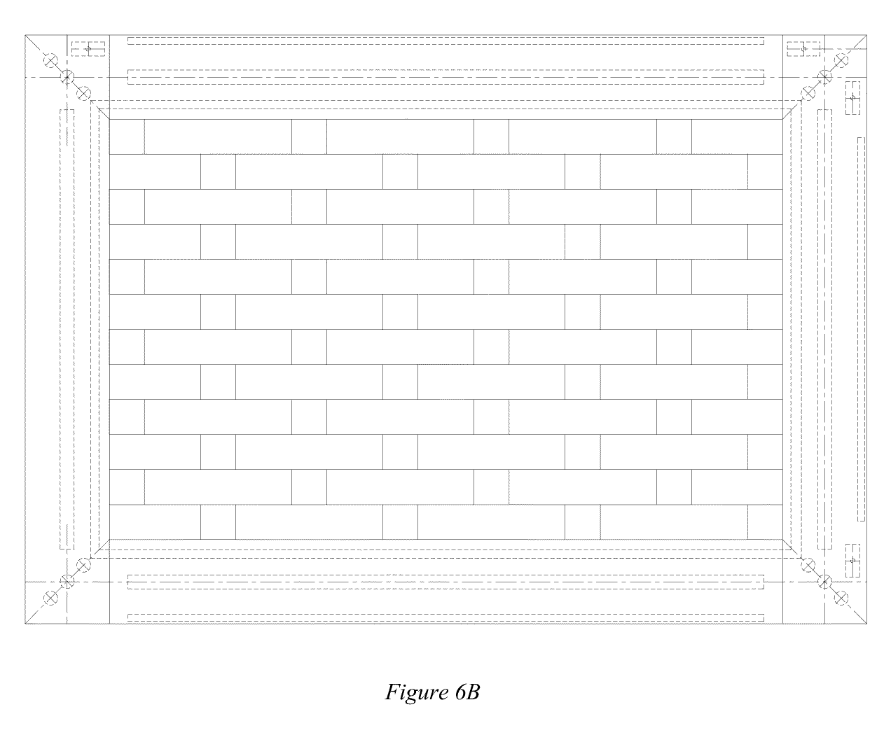

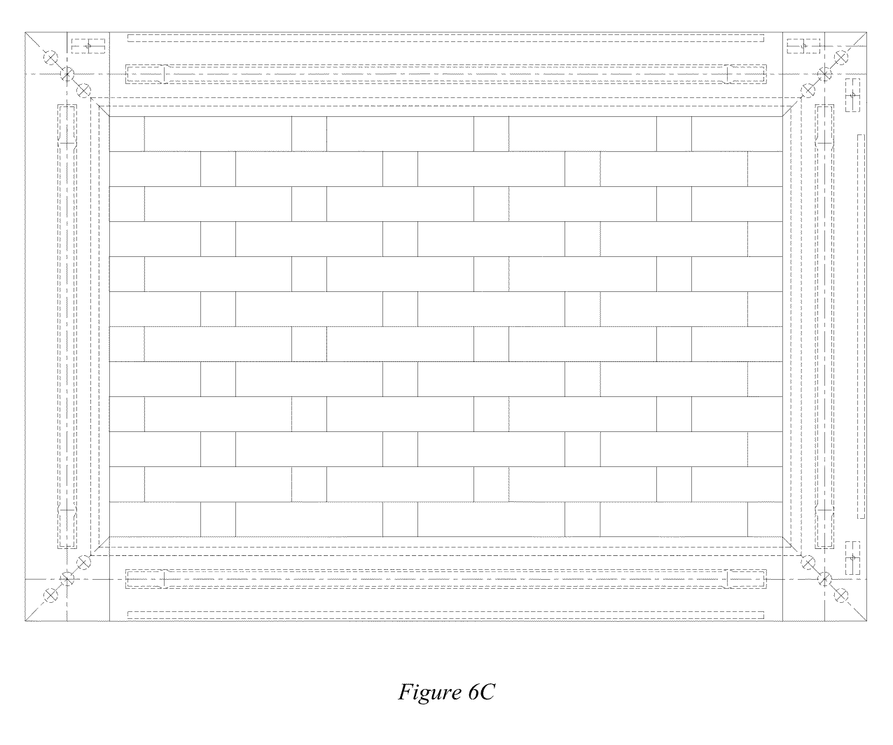

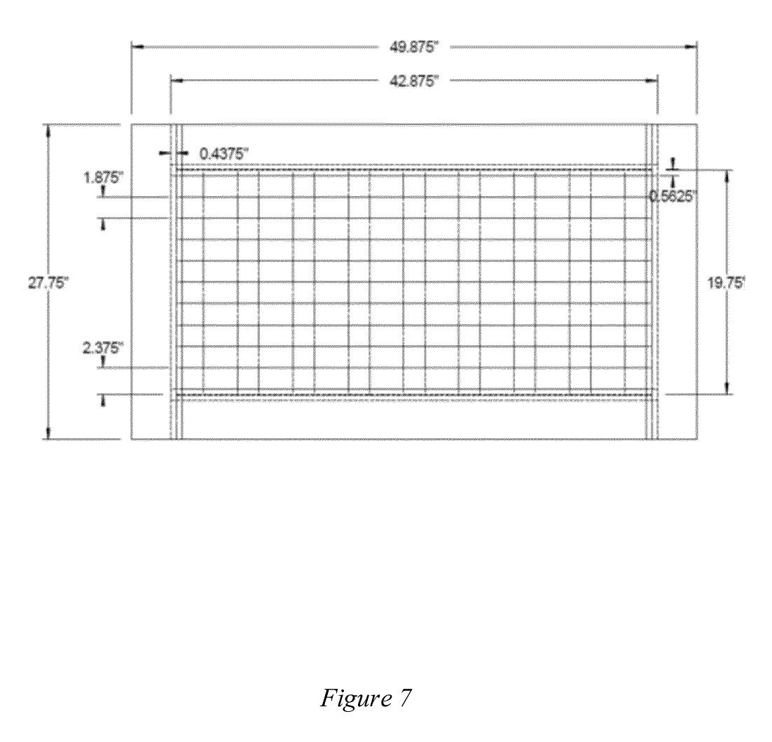

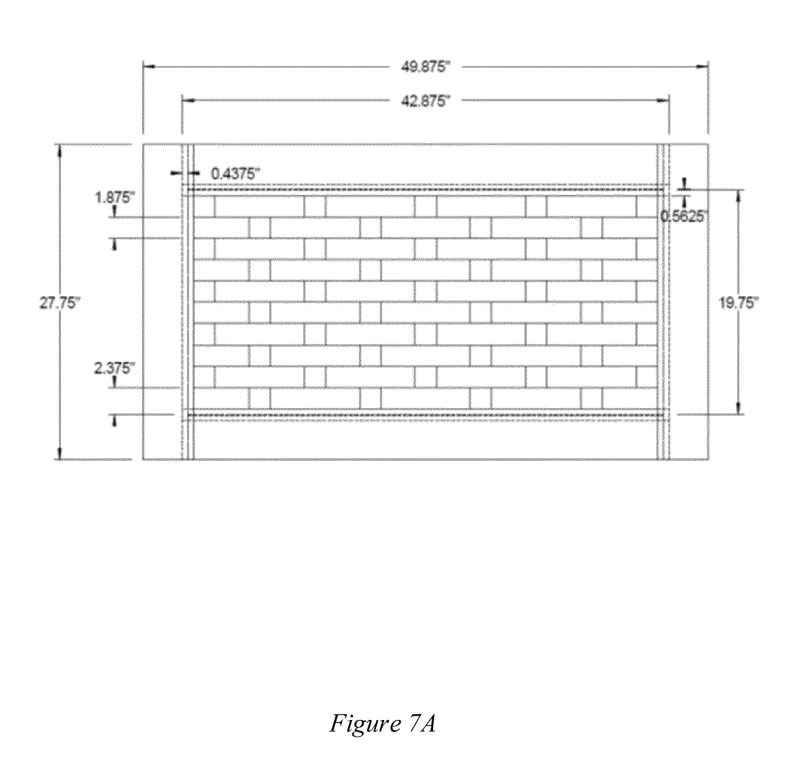

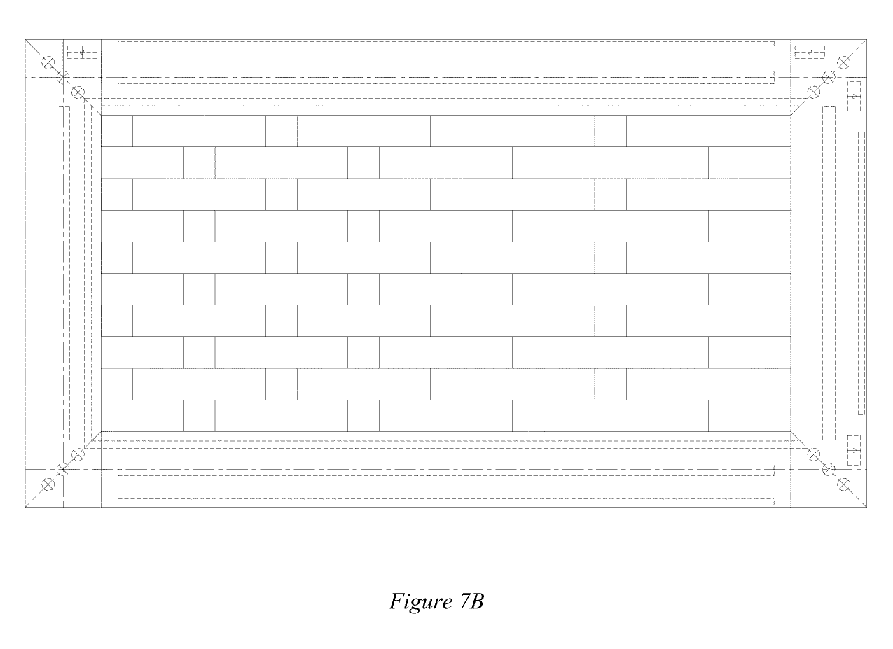

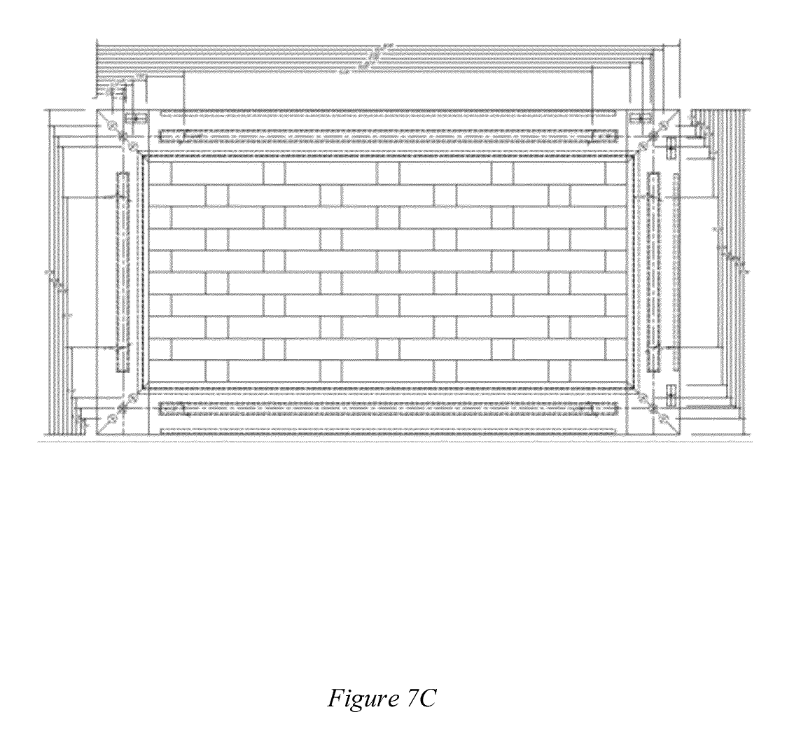

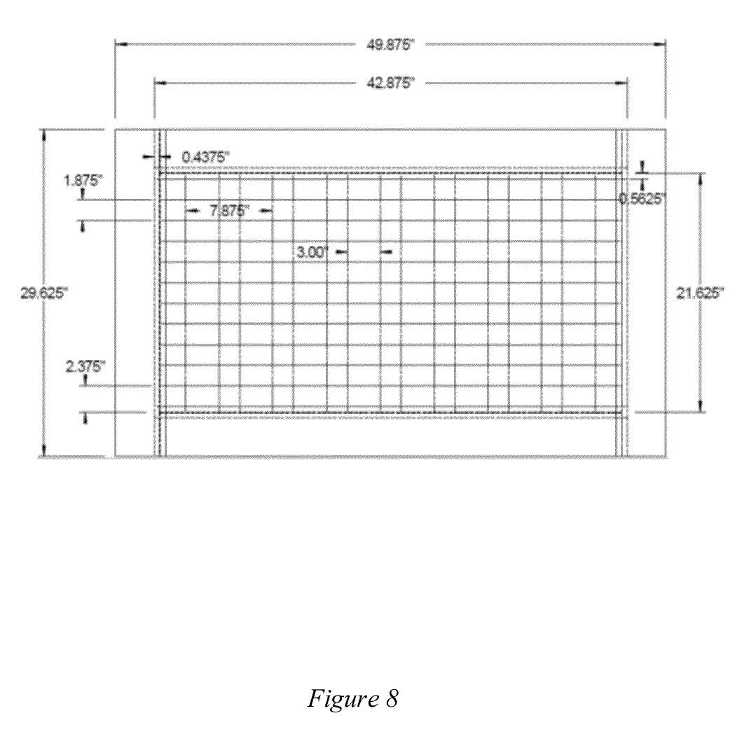

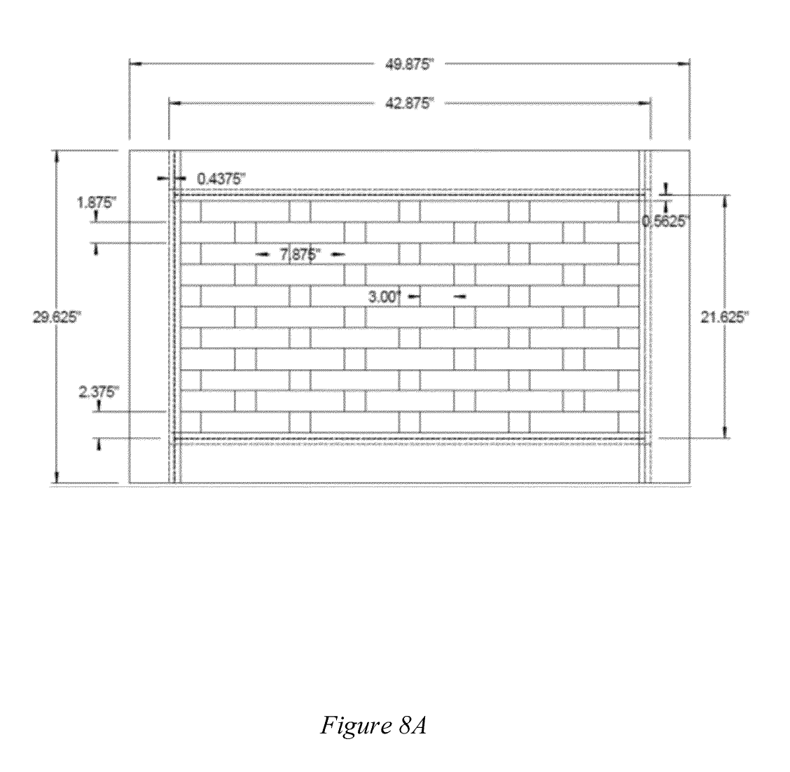

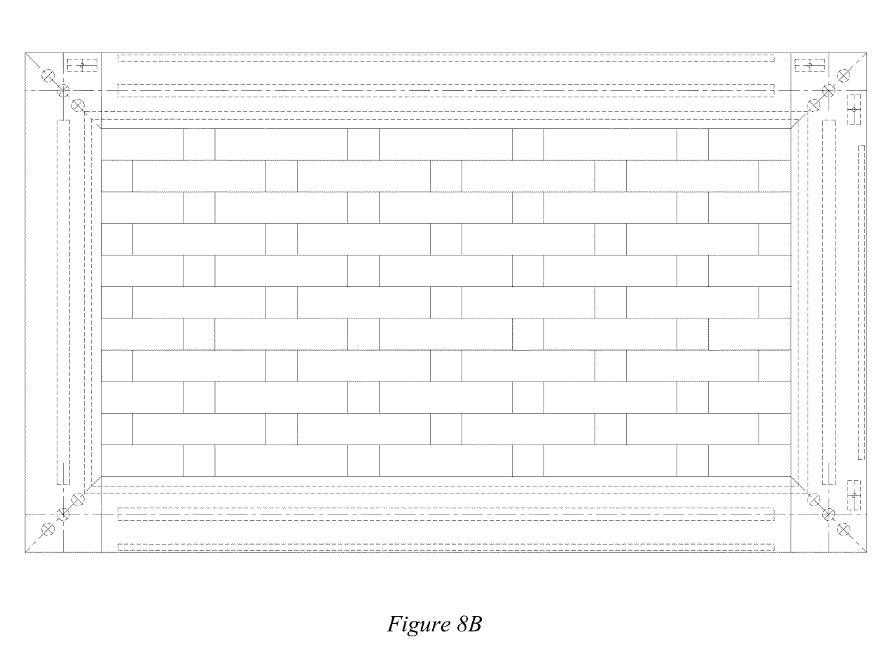

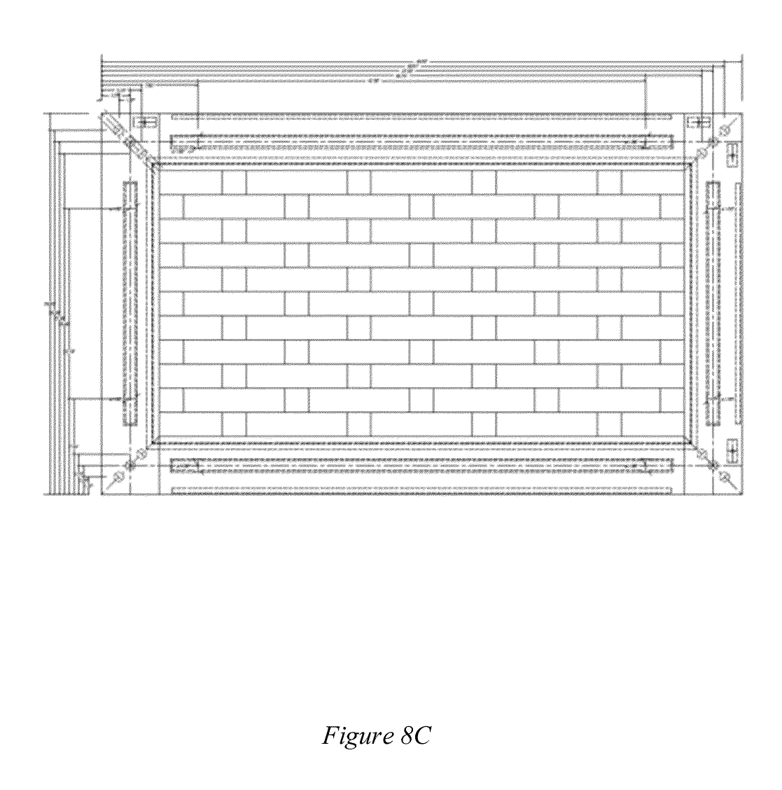

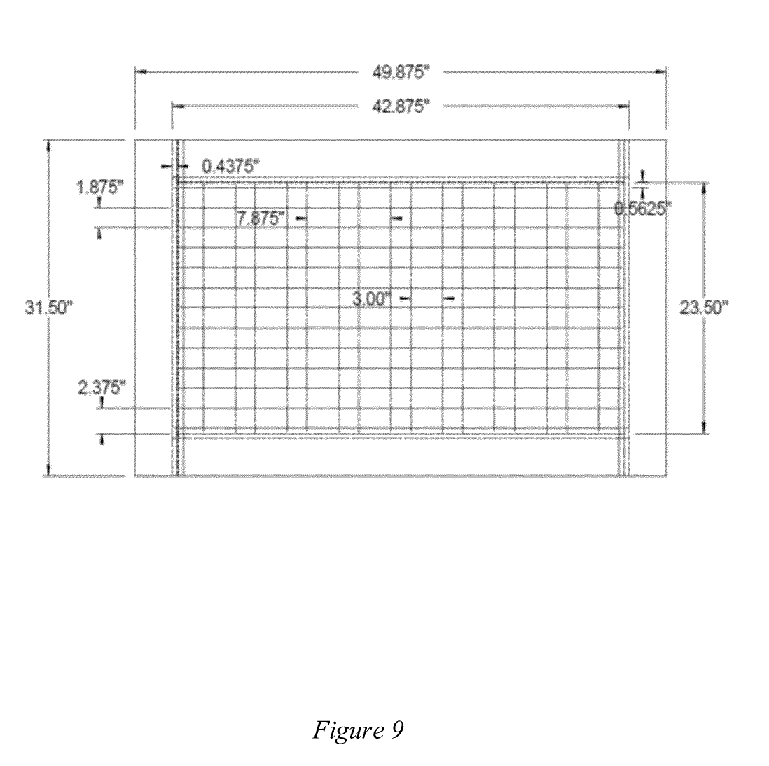

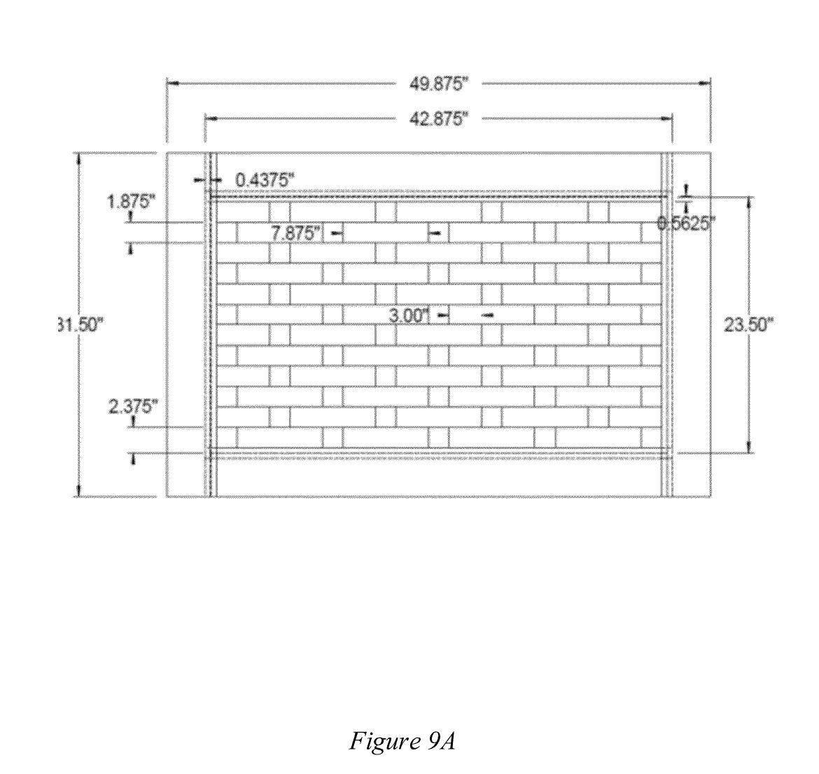

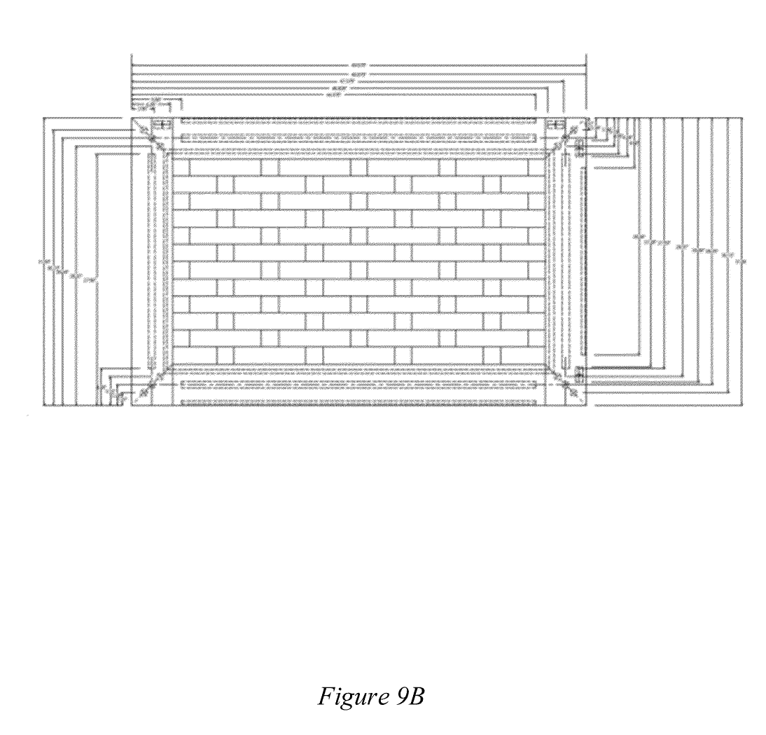

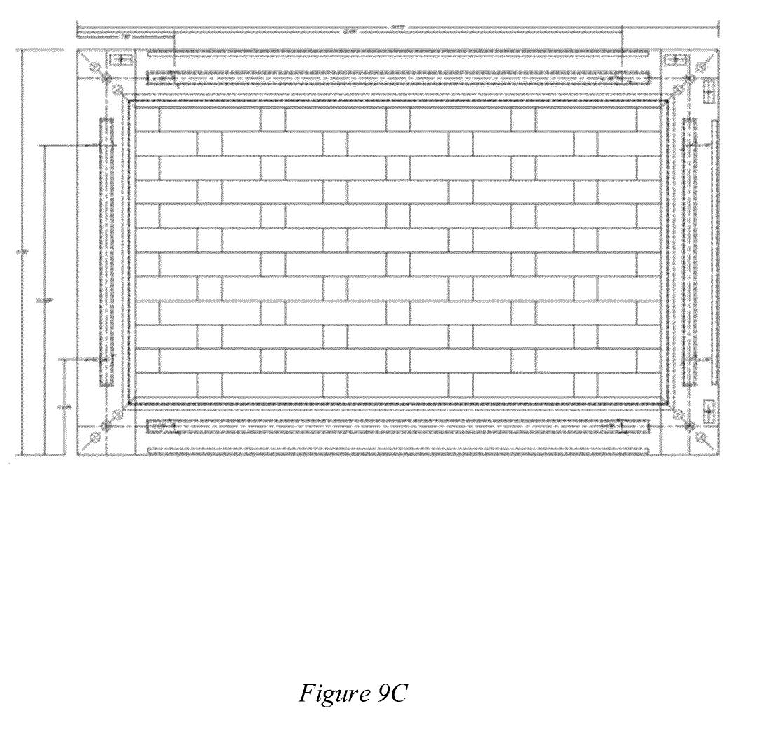

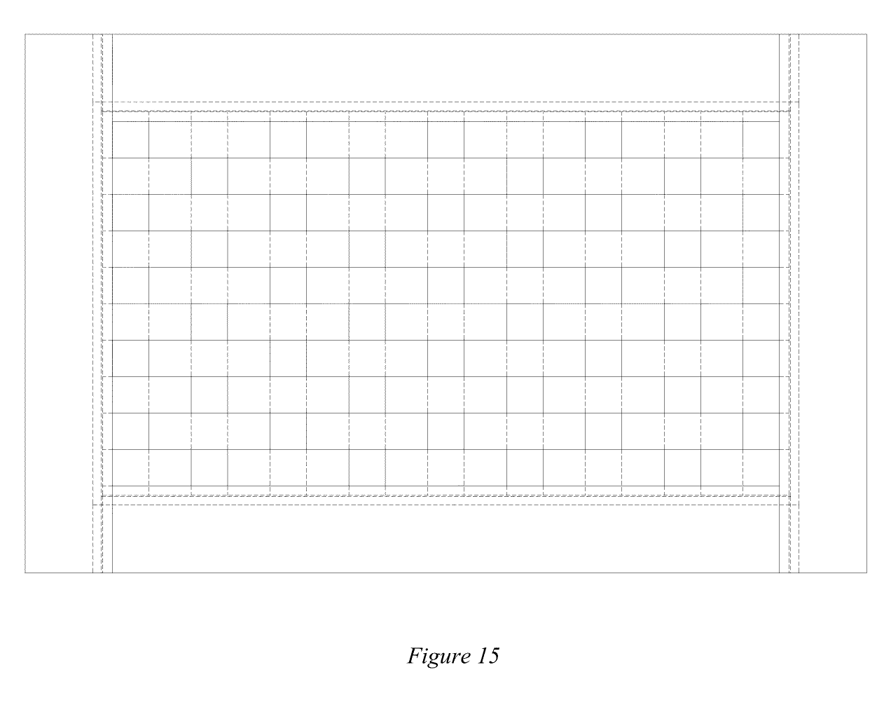

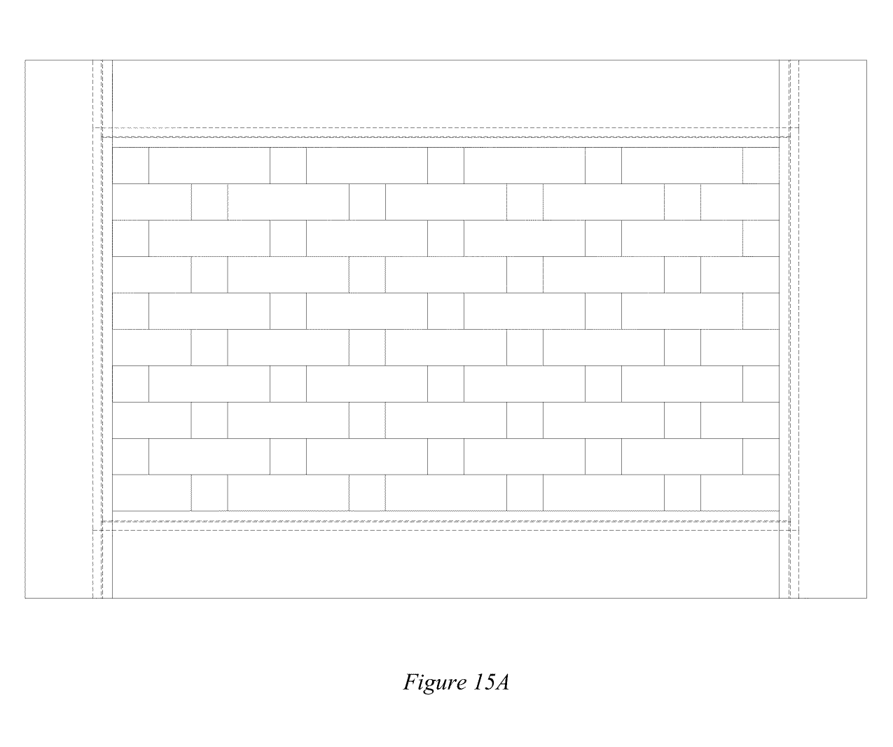

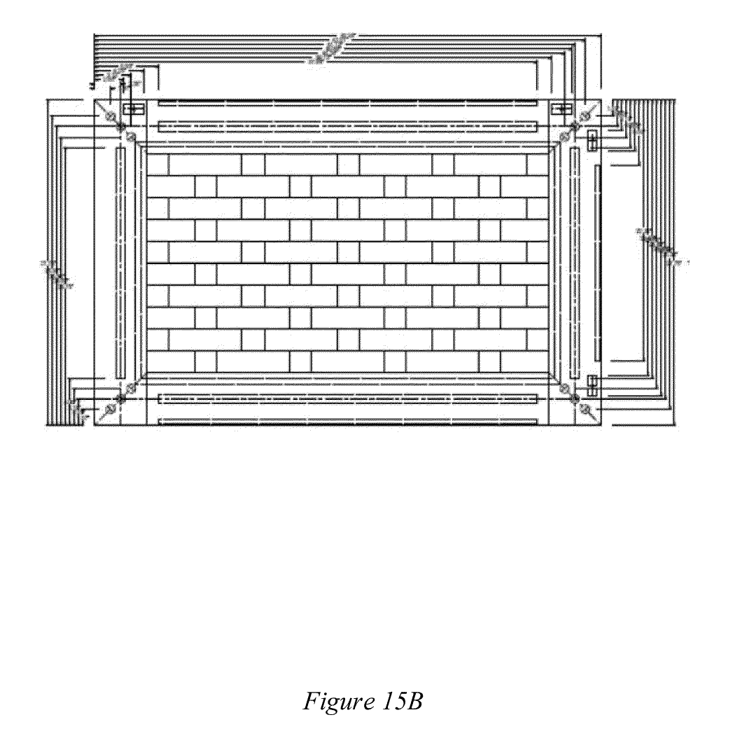

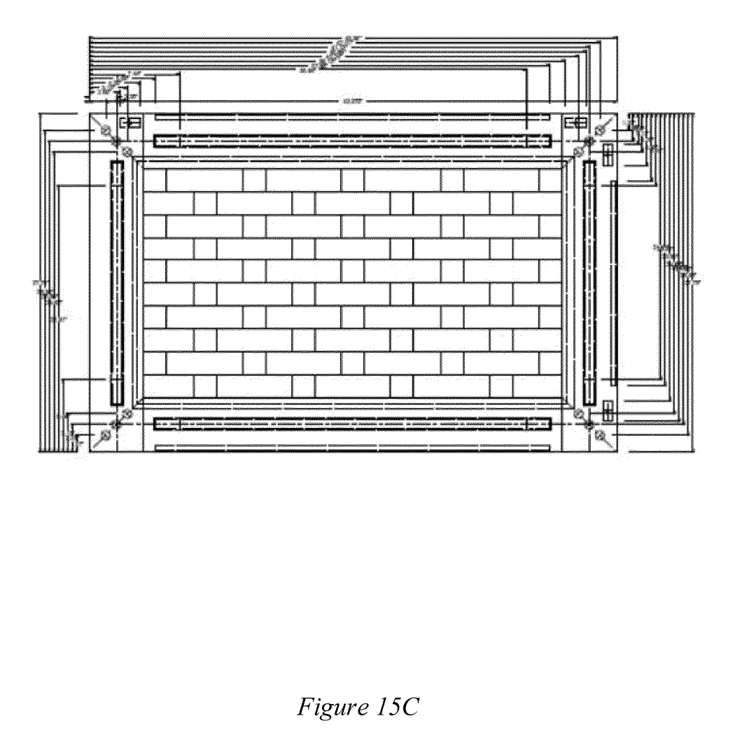

In some embodiments, on the under backside of the frame configuration may include a number of plowed out dado groove channel(s) or a number of both plowed out dado groove channel(s) and plowed out T-grooved dado groove channel(s). These may be seen, for example, in FIGS. 18, 18A, 10A, 10B, 10C, 10D. 2 channels may be on each upper and lower rail piece(s) as shown, for example, in FIG. 18 or 18A and 2 on one side stile a shown in FIG. 10C or 10D and one on the other side stile piece as shown, for example, in FIG. 10A or 10B. For example, a combination found on the under backside of said frame are 7 plowed out dado groove channel(s) or a combination of both plowed out dado groove channel(s) and plowed out T-Groove dado channel(s). Each dado groove channel or T-groove channel may be used for the placement of one or more magnets, such as, for example, a Neodymium Magnet(s). In some embodiments, one or more magnets (e.g., Neodymium Magnets) may be used in each dado groove channel or T-Groove dado channel, based upon the desired magnet configuration needed for the design and configuration of the products over all display and show. These grooves and/or magnets are illustrated in FIGS. 1B thru 9B, FIGS. 15B thru 17B, FIGS. 1C thru 9C, FIGS. 15C thru 17C, FIG. 10A, FIG. 10B, FIG. 10C, FIG. 10D, FIG. 18, FIG. 18A, FIG. 23B and FIG. 23C.

In some embodiments, a magnet module may be preconfigured placement modular may be used within the plowed out dado groove channel(s) as shown, for example, in FIG. 19, and FIG. 19C.

In some embodiments, a magnet module for placement of single Neodymium Magnets within the T-Groove dado channels as shown, for example, in FIG. 19A.

In some embodiments, a number of drilled out, for example, ¾ inch by ¾ inch round holes can be found on the under backside of said frame. These holes, for example, may be located on a diagonal 45 degree line with one hole being drilled and centered within said frame. One hole being drilled diagonally above the centered hole and the other hole being drilled diagonally below the centered hole. The above mentioned hole configuration may be found located within the four corners of said frame. These holes may be used for the placement and retention of magnets, for example, Neodymium Magnets. This above mentioned drilled out round holes configuration may be present in all 4 corners or said frame or it may be present only in select corners, which selection would be determined by the needs of the desired display configurations design or it may not be present at all or one hole in each corner, two holes in each corner, or a combination of holes in two of the corners with the remaining corners having no holes etc. as shown, for example, in FIG. 19D.

In some embodiments, one or two hanging bracket dado grooves may be located on the under backside of said frame and/or located upon the upper rail piece. One or two hanging bracket dado grooves may also be located upon the one side stile piece and may include, for example, ⅜″×¾″ plowed out dado groove channel(s). These dado grooves may contain a pair or two pairs of hanging brackets for the said frame as shown, for example, in FIGS. 1B thru 9B, FIGS. 15B thru 17B, FIGS. 1C thru 9C, FIGS. 15C thru 17C and FIGS. 23B and 23C.

In some embodiments, on the under backside of said frame may be a number of removable stop materials which may be used to anchor and secure a woven metal canvas within said frame. Installed and anchored with set screws as shown, for example, in FIG. 20. Various other techniques may be used to mount the woven metal canvas as shown in FIGS. 30, 30A and 30B.

In some embodiments, a woven metal canvas as shown, for example, in FIGS. 1 thru 9, FIGS. 15 thru 17, Figures lA thru 9A, FIGS. 15A thru 17A, FIGS. 23 and 23A may be held within the frame.

A Dado Channel Frame Configuration:

In some embodiments, two plowed out dado groove channels may be made within either or both the stiles and/or rails as shown, for example, in FIG. 18. The furthest most outside plowed out dado groove channel may be, for example, ⅜ of an inch wide by ¾ of an inch deep but varies in length, which length is dependent upon the current length of the rail pieces(s). Accompanying this dado groove channel may be numerous pieces of frame material that are made to fit the width and depth of the said dado groove channel, cut into different lengths. These lengths of frame material are such that one can use them in any combination for the placement and retention of and use of magnets, for example, Neodymium Magnets. These material pieces may be, for example, 1″ others being, for example, 2″ and so on. The said pieces are used and placed such that a Neodymium Magnet or many magnets, for example, Neodymium Magnets, may be placed within the plowed out dado groove channel, the said pieces of frame material also work as a magnetic barrier which when used prevent 2 magnets, for example, Neodymium Magnets, from attracting to each other while found in the plowed out dado groove channel as shown, for example, in FIG. 19E, FIGS. 1B thru 9B, FIGS. 15B thru 17B and FIG. 23B.

In some embodiments, a magnet module may be preconfigured and setup to retain and hold pre-determined placement positioned magnets (e.g., Neodymium Magnets) within the dado groove channel(s). The magnet module may contain any number of need magnets. The modular can hold, for example, ¾″×¾″×⅛″, 3/16″ and ¼″ thick Neodymium Magnets pre-positioned and contained within magnet modular. Any size of magnets may be used depending on the size of the groove. The magnet modular may be made to be placed within said dado groove channel and removed when modular is not needed as shown, for example, in FIG. 19.

In some embodiments, the inner most plowed out dado groove channel may be, for example, ¾ of an inch wide by ¾ of an inch deep but varies in length, which length is dependent upon the current length of the rail piece(s) found centered in the rail pieces, as shown, for example, in FIG. 18. Accompanying this dado groove channel are numerous pieces of frame material that are made to fit the width and depth of the said dado groove channel, cut into different lengths. These lengths of frame material are such that one can use them in any combination for the placement and retention of and use of the Neodymium Magnets, some being, for example, 1″ others being, for example, 2″ and so on. The said pieces are used and placed such that a Neodymium Magnet or many magnets, for example, Neodymium Magnets, may be placed within the plowed out dado groove channel, the said pieces of frame material also work as a magnetic barrier which when used prevent 2 magnets, for example, Neodymium Magnets, from attracting to each other while found in the plowed out dado groove channel as shown, for example, in FIG. 19B, FIGS. 1B thru 9B, FIGS. 15B thru 17B and FIG. 23B.

In some embodiments, a magnet module may be preconfigured and setup to retain and hold pre-determined placement position of magnets, for example, Neodymium Magnets, within, for example, the dado groove channel. In some embodiments, the magnet module contains the use, for example, ⅛″×¾″ Neodymium magnets or a ¼″×¾″ Neodymium Magnets. The desired configuration of said magnet module is dependent upon the overall needs, design, layout and/or functionality of the final products display, show, and configuration. This magnet modular may be made to be placed within said dado groove channel and removed when modular is not needed as shown, for example, in FIG. 19C.

In some embodiments, FIG. 10C illustrates 2 plowed out dado groove channels as shown in on the under backside of one of the side stiles. The furthest most outside plowed out dado groove channel may be, for example, ⅜ of an inch wide by ¾ of an inch deep but varies in length, which length is dependent upon the current length of the stile pieces(s). Accompanying this dado groove channel are numerous pieces of frame material that are made to fit the width and depth of the said dado groove channel, cut into different lengths. These lengths of frame material are such that one can use them in any combination for the placement and retention of and use of magnets, for example, Neodymium Magnets. These material pieces may be, for example, 1″ others may be, for example, 2″ and so on. The said pieces are used and placed such that a Neodymium Magnet or many magnets, for example, Neodymium Magnets, may be placed within the plowed out dado groove channel, the said pieces of frame material also work as a magnetic barrier which when used prevent 2 magnets, for example, Neodymium Magnets, from attracting to each other while found in the plowed out dado groove channel as shown, for example, in FIG. 19E, FIGS. 1B thru 9B, FIGS. 15B thru 17B and FIG. 23B.

In some embodiments, a magnet module may be preconfigured and setup to retain and hold pre-determined placement positioned magnets, for example, Neodymium Magnets within the dado groove channel. In some embodiments, the magnet module can contain any number of need magnets. The modular can hold, for example, ¾″×¾″×⅛″, 3/16″ and ¼″ thick magnets, for example, Neodymium Magnets pre-positioned and contained within magnet modular. This magnet modular may be made to be placed within said dado groove channel and removed when modular is not needed as shown, for example, in FIG. 19.

In some embodiments, the inner most plowed out dado groove channel may be, for example, ¾ of an inch wide by ¾ of an inch deep but varies in length, which length is dependent upon the current length of the stile piece(s) found centered in the stile piece as shown, for example, in FIG. 10C. Accompanying this dado groove channel are numerous pieces of frame material that are made to fit the width and depth of the said dado groove channel, cut into different lengths. These lengths of frame material are such that one can use them in any combination for the placement and retention of and use of the magnets, for example, Neodymium Magnets, some may be, for example, 1″ others may be, for example, 2″ and so on. The said pieces are used and placed such that a Neodymium Magnet or many magnets, for example, Neodymium Magnets, may be placed within the plowed out dado groove channel, the said pieces of frame material also work as a magnetic barrier which when used prevent 2 magnets, for example, Neodymium Magnets, from attracting to each other while found in the plowed out dado groove channel as shown, for example, in FIG. 19B, FIGS. 1B thru 9B, FIGS. 15B thru 17B and FIG. 23B.

In some embodiments, a magnet module may be preconfigured and setup to retain and hold pre-determined placement position of magnets, for example, Neodymium Magnets, within the dado groove channel. The magnet module may hold the magnets. The desired configuration of said magnet module is dependent on the overall needs, design, layout and/or functionality of final products display, show, and configuration. This magnet modular may be made to be placed within said dado groove channel and removed when modular is not needed as shown, for example, in FIG. 19C.

As shown in FIG. 10A a single plowed out dado groove channel may be formed Found on the under backside of the remaining side stile piece. This centered plowed out dado groove channel may be, for example, ¾ of an inch wide by ¾ of an inch deep but varies in length, which length is dependent upon the current length of the stile piece(s) found centered in the stile piece. Accompanying this dado groove channel are numerous pieces of frame material that are made to fit the width and depth of the said dado groove channel, cut into different lengths. These lengths of frame material are such that one can use them in any combination for the placement and retention of and use of the magnets, for example, Neodymium Magnets, some may be, for example, 1″ others may be, for example, 2″ and so on. The said pieces are used and placed such that a Neodymium Magnet or many magnets, for example, Neodymium Magnets, may be placed within the plowed out dado groove channel, the said pieces of frame material also work as a magnetic barrier which when used prevent 2 magnets, for example, Neodymium Magnets, from attracting to each other while found in the plowed out dado groove channel as shown, for example, in FIG. 19B, FIGS. 1B thru 9B, FIGS. 15B thru 17B and FIG. 23B.

A magnet module may be preconfigured and setup to retain and hold pre-determined placement position of magnets, for example, Neodymium Magnets, within the dado groove channel. The magnet module may hold the magnets. The desired configuration of said magnet module is dependent on the overall needs, design, layout and/or functionality of final products display, show, and configuration. This magnet modular may be made to be placed within said dado groove channel and removed when modular is not needed as shown, for example, in FIG. 19C.

FIG. 19D illustrates holes drilled into the under backside of the frame according to some embodiments. These holes, for example, may be located in the 4 corners of said frame are, for example, (3) ¾″×¾″ round holes drilled and found at a 45 degree angle to the corner s 90 degree corners, drilled into the frames backside, with one hole being drilled and centered within said frame, one hole being drilled diagonally above the centered hole and the other hole being drilled diagonally below the centered hole. The above mentioned drilled round holes configuration is found located within the four corners of said frame. These holes are used for the placement and retention of magnets, for example, Neodymium Magnets. This said mention drilled hole(s) configuration may be present on said frame. It might not be present at all on this said frame or it may be hat only one round drilled hole is present in each corner or said frame, or it may be that only 2 drilled round holes are present in each corner. The overall final drilled round holes configuration is depended upon the overall needed design and needed configuration and final display and look.

In some embodiments, the frame material may be found rough non-sanded, weathered, sanded smooth, lightly distressed, medium distressed, heavy distressed.

In some embodiments, the frame is sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze, Mod Podge with a paper pattern, wrapped in fabric materials, metal bronzing if frame is metal, A lacquer final coat is applied as a final top coat if the frame may include this step being done. It may be either a, High Gloss Finish, a Semi-Gloss finish, a Satin Finish or a Flat Finish.

In some embodiments, a woven metal canvas. Contained within the inside border of said frame is a woven metal canvas. This said woven metal canvas is a metal configuration that may be made up of a number of vertical and horizontal piece of metal, which are woven together to form and create the woven metal canvas as shown, for example, in FIGS. 1 thru 9, FIGS. 15 thru 17, FIGS. 1A thru 9A, FIGS. 15A thru 17A and FIGS. 23 and 23A.

In some embodiments, the metal associated with this said woven metal canvas can be found in its natural form and finished state, or all the metal associated with this said woven metal canvas can be found hand sanded, or all the metal associated with this said woven metal canvas can be found sandblasted, or all the metal associated with this said woven metal canvas can be found powder coated or painted with a pigmented paint, or all the metal associated with this said woven metal canvas can be found with a chemically created patina or a naturally produced patina (rust), or the vertical metal pieces can be found in its natural form and finished state, or all the vertical metal pieces can be found hand sanded, or all the vertical metal pieces can be found sandblasted, or all the vertical metal pieces can be found powder coated or painted with a pigmented paint, or all the vertical metal pieces can be found with a chemically created patina or a naturally produced patina (rust), or the horizontal metal pieces can be found in its natural form and finished state, or all the horizontal metal pieces can be found hand sanded, or all the horizontal metal pieces can be found sandblasted, or all the horizontal metal pieces can be found powder coated or painted with a pigmented paint, or all the horizontal metal pieces can be found with a chemically created patina or a naturally produced patina (rust) as shown, for example, in FIGS. 24 thru 24T.

In some embodiments, the resulting patina created from either the chemical or natural patina processes, may be different each and every time the patina finish process is used to create the patina. Many factors can affect the patina process and the overall outcome. The patina process is a natural process using waters, chemicals, water holding materials, chemical holding materials, the natural effects upon the metal alloys natural formulation, characteristic, etc. All these factors create a patina environment that affects the overall process and ultimately the final patina look and feel. This results in many different colors and shades though out the metal pieces. When all the pieces associated with the said woven canvas are woven together the said woven metal canvas resembles and looks like a canvas of different colored tiles as shown, for example, in FIG. 24 thru 24T.

In some embodiments, the said metal associated with the woven metal canvas will need to be thin enough and pliable enough to be woven together; the gauge and thickness of this metal being used may be determined by the ease of weaving, the weight of the overall final frames configuration and the final design, needs and overall appearance.

In some embodiments, the said metal before its woven together is found as individual small pieces of metal. The vertical metal pieces are such that 2 of the vertical pieces are ½″ wider then all the other remaining vertical pieces. All the vertical pieces are all the same length and thickness. The horizontal metal pieces are such that 2 of the horizontal pieces are ½″ wider then all the other remaining horizontal pieces. All the horizontal pieces are all the same length and thickness. This said woven metal canvas after being weaved together and assembled is spot welded together and placed within the above mentioned frames precut dado groove found on the under backside of the said frame and is placed and installed within said frame with the removable stop material pieces mentioned above as shown, for example, in FIG. 20.

In some embodiments, the above said frame configuration makes for a frame and woven metal canvas board that can be customized by the placement of magnets, for example, Neodymium Magnets, to the frame and woven metal canvas by the end users. Many magnetized accessory pieces can be placed upon the said woven metal canvas and said mentioned frame.

In some embodiments, the said dado groove channel and/or dado groove channel and T-Groove dado channel and the drilled holes and the Neodymium Magnet Modelers and the magnets, for example, Neodymium Magnets makes a frame and woven metal canvas capable of holding and supporting many magnetized, light weight, medium weight and heavy weight accessory pieces. Due to the characteristics and behavior of magnets, for example, Neodymium Magnets, the strength and holding power of the larger magnets, for example, Neodymium Magnets, makes the said dado groove so important in the overall design and function of the said frame and said woven metal canvas. It also makes the placement of magnets, for example, Neodymium Magnets, throughout the frame customizable to any configuration the end user would need or want.

FIG. 18A illustrates a plowed dado groove that may be cut into the rails or the stiles according to some embodiments of the invention. The furthest most outside plowed out dado groove channel may be, for example, ⅜ of an inch wide by ¾ of an inch deep but varies in length, which length is dependent upon the current length of the rail piece(s). Accompanying this dado groove channel are numerous pieces of frame material that are made to fit the width and depth of the said dado groove channel, cut into different lengths. These lengths of frame material are such that one can use them in any combination for the placement and retention of and use of magnets, for example, Neodymium Magnets. These material pieces may be, for example, 1″ others may be, for example, 2″ and so on. The said pieces are used and placed such that a Neodymium Magnet or many magnets, for example, Neodymium Magnets, may be placed within the plowed out dado groove channel, the said pieces of frame material also work as a magnetic barrier which when used prevent 2 magnets, for example, Neodymium Magnets, from attracting to each other while found in the plowed out dado groove channel as shown, for example, in FIG. 19E, FIGS. 1C thru 9C, FIGS. 15C thru 17C and FIG. 23C.

In some embodiments, the magnet module may be preconfigured and setup to retain and hold pre-determined placement positioned magnets, for example, Neodymium Magnets, within said above, for example, ⅜ inch by ¾ inch dado groove channel. In some embodiments, the magnet module can contain any number of need magnets. The modular can hold ¾″×¾″×⅛″, 3/16″ and ¼″ thick magnets, for example, Neodymium Magnets, pre-positioned and contained within magnet modular. This magnet modular may be made to be placed within said dado groove channel and removed when modular is not needed as shown, for example, in FIG. 19.

In some embodiments, the inner most plowed out T-Groove dado channel may be, for example, 1 inch wide at the T part of the dado groove channel by ⅛ inch deep and ¾ of an inch wide by ¾ of an inch deep overall but varies in length, which length is dependent upon the current length of the rail piece(s) found centered in the rail pieces as shown, for example, in FIG. 18A.

In some embodiments, accompanying this plowed out T-Groove dado channel are numerous pieces of frame material that are made to fit the width and depth of the said T-Groove dado channel, cut into different lengths. These lengths of frame material are such that one can use them in any combination for the placement and retention of and use of the Magnets, for example, Neodymium Magnets, some may be, for example, 1″ others may be, for example, 2″ and so on. The said pieces are used and placed such that a Neodymium Magnet or many magnets, for example, Neodymium Magnets, may be placed within the plowed out T-Groove dado channel, the said pieces of frame material also work as a magnetic barrier which when used prevent 2 magnets, for example, Neodymium Magnets, from attracting to each other while found in the plowed out T-Groove dado channel as shown, for example, in FIG. 19B, FIGS. 1C thru 9C, FIGS. 15C thru 17C and FIG. 23C.

In some embodiments, a single magnet module designed for use within the T-Groove dado channel. Designed as a single magnet module. This will hold a ¾″×¾″, either a ⅛″, or a 3/16″ or a ¼″ thick Neodymium Magnet. Designed to slide in either direction within the T-Groove dado channel. The magnet module slides into desired position and is locked into place by a setscrew that tights and loosens for this placement of said single magnet module holder as shown, for example, in FIG. 19A.

In some embodiments, this single magnet module can be used either by itself or in combination with other single Neodymium Magnet Modelers found within the same T-Groove dado channel giving the functionality of multiple magnets, for example, Neodymium Magnets, found within said plowed out T-Groove dado channel.

In some embodiments, a magnet module may be preconfigured and setup to retain and hold pre-determined placement position of magnets, for example, Neodymium Magnets, within the dado groove channel. The magnet module may hold the magnets. The desired configuration of said magnet module is dependent on the overall needs, design, layout and/or functionality of final products display, show, and configuration. This magnet modular may be made to be placed within said dado groove channel and removed when modular is not needed as shown, for example, in FIG. 19C.

FIG. 18A illustrates a plowed out dado groove channel and a plowed out T-Groove dado channel on the under backside of one of the side stile pieces according to some embodiments of the invention. The furthest most outside plowed out dado groove channel may be, for example, ⅜ of an inch wide by ¾ of an inch deep but varies in length, which length is dependent upon the current length of the stile piece(s). Accompanying this dado groove channel are numerous pieces of frame material that are made to fit the width and depth of the said dado groove channel, cut into different lengths. These lengths of frame material are such that one can use them in any combination for the placement and retention of and use of magnets, for example, Neodymium Magnets. These material pieces may be, for example, 1″ others may be, for example, 2″ and so on. The said pieces are used and placed such that a Neodymium Magnet or many magnets, for example, Neodymium Magnets, may be placed within the plowed out dado groove channel, the said pieces of frame material also work as a magnetic barrier which when used prevent 2 magnets, for example, Neodymium Magnets, from attracting to each other while found in the plowed out dado groove channel as shown, for example, in FIG. 19E, FIGS. 1C thru 9C, FIGS. 15C thru 17C and FIG. 23C.

In some embodiments, the magnet module may be preconfigured and setup to retain and hold pre-determined placement positioned magnets, for example, Neodymium Magnets, within the dado groove channel. The magnet module may contain any number of need magnets. The modular can hold, for example, ¾″×¾″×⅛″, 3/16″ and ¼″ thick magnets, for example, Neodymium Magnets, pre-positioned and contained within magnet modular. This magnet modular may be made to be placed within said dado groove channel and removed when modular is not needed as shown, for example, in FIG. 19.

In some embodiments, the inner most plowed out T-Groove dado channel may be, for example, 1 inch wide at the T part of the dado groove channel by, for example, ⅛ inch deep and ¾ of an inch wide by ¾ of an inch deep overall but varies in length, which length is dependent upon the current length of the rail piece(s) found centered in the rail pieces as shown, for example, in FIG. 18A.

In some embodiments, accompanying this plowed out T-Groove dado channel may be, for example, numerous pieces of frame material that are made to fit the width and depth of the said T-Groove dado channel, cut into different lengths. These lengths of frame material are such that one can use them in any combination for the placement and retention of and use of the magnets, for example, Neodymium Magnets, some may be, for example, 1″ others may be, for example, 2″ and so on. The said pieces are used and placed such that a Neodymium Magnet or many magnets, for example, Neodymium Magnets, may be placed within the plowed out T-Groove dado channel, the said pieces of frame material also work as a magnetic barrier which when used prevent 2 magnets, for example, Neodymium Magnets, from attracting to each other while found in the plowed out T-Groove dado channel as shown, for example, in FIG. 19B, FIGS. 1C thru 9C, FIGS. 15C thru 17C and FIG. 23C.

In some embodiments, a single magnet module may be used use within the T-Groove dado channel. It may be a single magnet module that holds, for example, a ¾″×¾″, either a ⅛″, or a 3/16″ or a ¼″ thick Neodymium Magnet. It may be designed to slide in either direction within the T-Groove dado channel. The magnet module slides into desired position and is locked into place by a setscrew that tights and loosens for this placement of said single magnet module holder as shown, for example, in FIG. 19A.

In some embodiments, this single magnet module can be used either by itself or in combination with other single Neodymium Magnet Modelers found within the same T-Groove dado channel giving the functionality of multiple magnets, for example, Neodymium Magnets, found within said plowed out T-Groove dado channel.

In some embodiments, the magnet module may be preconfigured and setup to retain and hold pre-determined placement position of magnets, for example, Neodymium Magnets, within the dado groove channel. The magnet module may hold the magnets. The desired configuration of said magnet module is dependent on the overall needs, design, layout and/or functionality of final products display, show, and configuration. This magnet modular may be made to be placed within said dado groove channel and removed when modular is not needed as shown, for example, in FIG. 19C.

As shown in FIG. 10B a plowed out T-Groove dado channel may be formed on the under backside of the remaining side stile. This centered plowed out T-Groove dado channel may be, for example, 1 inch wide at the T part of the dado groove channel by ⅛ inch deep and ¾ of an inch wide by ¾ of an inch deep overall but varies in length, which length is dependent upon the current length of the stile piece(s) as shown, for example, in FIG. 18A.

In some embodiments, a single magnet module designed for use within the T-Groove dado channel. Designed as a single magnet module. This will hold a ¾″×¾″, either a ⅛″, or a 3/16″ or a ¼″ thick Neodymium Magnet. Designed to slide in either direction within the T-Groove dado channel. The magnet module slides into desired position and is locked into place by a setscrew that tights and loosens for this placement of said single magnet module holder as shown, for example, in FIG. 19A.

In some embodiments, this single magnet module can be used either by itself or in combination with other single Neodymium Magnet Modelers found within the same T-Groove dado channel giving the functionality of multiple magnets, for example, Neodymium Magnets, found within said plowed out T-Groove dado channel.

In some embodiments, a magnet module may be preconfigured and setup to retain and hold pre-determined placement position of magnets, for example, Neodymium Magnets, within the dado groove channel. The magnet module may hold the magnets. The desired configuration of said magnet module is dependent on the overall needs, design, layout and/or functionality of final products display, show, and configuration. This magnet modular may be made to be placed within said dado groove channel and removed when modular is not needed as shown, for example, in FIG. 19C.

FIG. 19D illustrates holes drilled into the under backside of the frame according to some embodiments of the invention. These holes, for example, may be located in the 4 corners of said frame and may be, for example, (3) ¾″×¾″ round holes drilled and found at a 45 degree angle to the corner s 90 degree corners, drilled into the frames backside, with one hole being drilled and centered within said frame, one hole being drilled diagonally above the centered hole and the other hole being drilled diagonally below the centered hole. The above mentioned drilled round holes configuration is found located within the four corners of said frame. These holes are used for the placement and retention of magnets, for example, Neodymium Magnets. This said mention drilled hole(s) configuration may be present on said frame. It might not be present at all on this said frame or it may be hat only one round drilled hole is present in each corner or said frame, or it may be that only 2 drilled round holes are present in each corner. The overall final drilled round holes configuration is depended upon the overall needed design and needed configuration and final display and look.

In some embodiments, the frame material may be found rough non-sanded, weathered, sanded smooth, lightly distressed, medium distressed, heavy distressed.

In some embodiments, the frame is sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze, Mod Podge with a paper pattern, wrapped in fabric materials, metal bronzing if frame is metal, . A lacquer final coat may be applied as a final top coat. It may be either a, High Gloss Finish, a Semi-Gloss finish, a Satin Finish or a Flat Finish.

In some embodiments, a woven metal canvas. Contained within the inside border of said frame may be a woven metal canvas. This said woven metal canvas may be a metal configuration that may be made up of a number of vertical and horizontal piece of metal, which are woven together to form and create the woven metal canvas as shown, for example, in FIGS. 1 thru 9, FIGS. 15 thru 17, FIGS. 1A thru 9A, FIGS. 15A thru 17A and FIGS. 23 and 23A.

In some embodiments, the metal associated with this said woven metal canvas can be found in its natural form and finished state, or all the metal associated with this said woven metal canvas can be found hand sanded, or all the metal associated with this said woven metal canvas can be found sandblasted, or all the metal associated with this said woven metal canvas can be found powder coated or painted with a pigmented paint, or all the metal associated with this said woven metal canvas can be found with a chemically created patina or a naturally produced patina (rust), or the vertical metal pieces can be found in its natural form and finished state, or all the vertical metal pieces can be found hand sanded, or all the vertical metal pieces can be found sandblasted, or all the vertical metal pieces can be found powder coated or painted with a pigmented paint, or all the vertical metal pieces can be found with a chemically created patina or a naturally produced patina (rust), or the horizontal metal pieces can be found in its natural form and finished state, or all the horizontal metal pieces can be found hand sanded, or all the horizontal metal pieces can be found sandblasted, or all the horizontal metal pieces can be found powder coated or painted with a pigmented paint, or all the horizontal metal pieces can be found with a chemically created patina or a naturally produced patina (rust) as shown, for example, in FIGS. 24 thru 24T.

In some embodiments, the resulting patina created from either the chemical or natural patina processes, may be different each and every time the patina finish process may be used to create the patina. Many factors can affect the patina process and the overall outcome. The patina process may be a natural process using waters, chemicals, water holding materials, chemical holding materials, the natural effects upon the metal alloys natural formulation, characteristic, etc. All these factors create a patina environment that affects the overall process and ultimately the final patina look and feel. This results in many different colors and shades though out the metal pieces. When all the pieces associated with the said woven canvas are woven together the said woven metal canvas resembles and looks like a canvas of different colored tiles. This look may never be the same; it can never be duplicated as shown, for example, in FIG. 24 thru 24T.

In some embodiments, the metal before its woven together may be individual small pieces of metal. The vertical metal pieces are such that 2 of the vertical pieces are ½″ wider then all the other remaining vertical pieces. All the vertical pieces are all the same length and thickness. The horizontal metal pieces are such that 2 of the horizontal pieces are ½″ wider then all the other remaining horizontal pieces. All the horizontal pieces are all the same length and thickness. This said woven metal canvas after being weaved together and assembled may be spot welded together and placed within the above mentioned frames precut dado groove found on the under backside of the said frame and may be placed and installed within said frame with the removable stop material pieces mentioned above as shown, for example, in FIG. 20.

In some embodiments, the above said frame configuration makes for a frame and woven metal canvas board that can be customized by the placement of magnets, for example, Neodymium Magnets, to the frame and woven metal canvas by the end users. Many magnetized accessory pieces can be placed upon the said woven metal canvas and said mentioned frame.

In some embodiments, the dado groove channel and/or dado groove channel and T-Groove dado channel and the drilled holes and the Neodymium Magnet Modelers and the magnets, for example, Neodymium Magnets makes a frame and woven metal canvas capable of holding and supporting many magnetized, light weight, medium weight and heavy weight accessory pieces. Due to the characteristics and behavior of magnets, for example, Neodymium Magnets, the strength and holding power of the larger magnets, for example, Neodymium Magnets, makes the said dado groove so important in the overall design and function of the said frame and said woven metal canvas. It also makes the placement of magnets, for example, Neodymium Magnets, throughout the frame customizable to any configuration the end user would need or want

Embodiments described herein may be used in conjunction with various accessories. For example, a top wood shelf may be coupled with the top rail using magnets (e.g., Neodymium magnets) found on the underside of said shelf as shown, for example, in FIGS. 21 and 21C and/or by the magnets (e.g., Neodymium magnets) located and positioned in dado groove channel. The top wood shelf may be, for example wider than the final length of the frame. It may be wider, for example, than the total measurement calculation of the 2 widths of stiles and the length of one rail piece (stile width+stile width+rail length+2″=final length of said top wood shelf). In some embodiments, the top wood shelf may be, for example, 3½″ wide by ¾″ thick by the final length of said top wood shelf measurement, with (2) support corbels may be, for example, 2″×2″×¾″, found glued, nailed and attached onto the underside of said top wood shelf.

For example, drilled and countersunk into the underside of said top wood shelf located 7/16″ of an inch from the underside back edge centered at the 7/16 point are (4) 3/4″ of an inch countersunk drilled out holes ⅛″ of an inch deep spaced apart and positioned to line up with the magnet module placement jig for the ⅜″×¾″ deep dado groove channel of the said frames rail piece. Found contained within the (4) drilled holes are (4) ⅛″×¾″ countersunk magnets, for example, Neodymium Magnets attached and anchored by (4) #6 screws.

In some embodiments, the top wood shelf may be found rough non-sanded, weathered, sanded smooth, lightly distressed, medium distressed, heavy distressed.

In some embodiments, the top wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the top wood shelf may be designed to magnetically anchor to above mentioned magnet module placement jig for the ⅜″×¾″ deep dado groove channel of the said frames rail piece. In some embodiments, the top wood shelf may be designed to support and show shelf accessory pieces which are designed and manufacture to fit, weigh and work according to the magnetic capabilities associated with the magnets, for example, Neodymium Magnets being used in the magnet module.

A top wood shelf can be located on the top rail, anchored by Neodymium magnets found on the underside of said shelf (Refer to: FIGS. 21A, 21C) and by the Neodymium magnets located and positioned in dado groove channel. The top wood shelf measuring, for example, 2 inches more than the final length of the total measurement calculation of the 2 widths of stiles and the length of one rail piece (stile width+stile width+rail length+2″=final length of said top wood shelf). In some embodiments, the top wood shelf may be, for example, 4⅜″ wide by ¾″ thick by the final length of said top wood shelf measurement, with (2) support corbels may be, for example, 2¾″×2¾″×¾″, found glued, nailed and attached onto the underside of said top wood shelf.

Drilled and countersunk into the underside of said top wood shelf located 7/16″ of an inch from the underside back edge centered at the 7/16 point are (4) ¾″ of an inch countersunk drilled out holes ⅛″ of an inch deep spaced apart and positioned to line up with the magnet module placement jig for the ⅜″×¾″ deep dado groove channel of the said frames rail piece. Found contained within the (4) drilled holes are (4) ⅛″×¾″ countersunk magnets, for example, Neodymium Magnets attached and anchored by (4) #6 screws.

In some embodiments, the top wood shelf may be found rough non-sanded, weathered, sanded smooth, lightly distressed, medium distressed, heavy distressed.

In some embodiments, the top wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the top wood shelf may be designed to magnetically anchor to above mentioned magnet module placement jig for the ⅜″×¾″ deep dado groove channel of the said frames rail piece. In some embodiments, the top wood shelf may be designed to support and show shelf accessory pieces which are designed and manufacture to fit, weigh and work according to the magnetic capabilities associated with the magnets, for example, Neodymium Magnets being used in the magnet module.

A top wood shelf can be disposed on the top rail, anchored by Neodymium magnets found on the underside of said shelf (Refer to: FIGS. 21, 21C) and by the Neodymium magnets located and positioned in dado groove channel. The top wood shelf measuring, for example, 2 inches more than the final length of the total measurement calculation of the 2 widths of stiles and the length of one rail piece (stile width+stile width+rail length+2″=final length of said top wood shelf). In some embodiments, the top wood shelf may be, for example, 3½″ wide by 1″ thick by the final length of said top wood shelf measurement, with (2) support corbels may be, for example, 2″×2″×1″, found glued, nailed and attached onto the underside of said top wood shelf.

Drilled and countersunk into the underside of said top wood shelf located 7/16″ of an inch from the underside back edge centered at the 7/16 point are (4) ¾″ of an inch countersunk drilled out holes ⅛″ of an inch deep spaced apart and positioned to line up with the magnet module placement jig for the ⅜″×¾″ deep dado groove channel of the said frames rail piece. Found contained within the (4) drilled holes are (4) ⅛″×¾″ countersunk magnets, for example, Neodymium Magnets attached and anchored by (4) #6 screws.

In some embodiments, the top wood shelf may be found rough non-sanded, weathered, sanded smooth, lightly distressed, medium distressed, heavy distressed.

In some embodiments, the top wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the top wood shelf may be designed to magnetically anchor to above mentioned magnet module placement jig for the ⅜″×¾″ deep dado groove channel of the said frames rail piece. In some embodiments, the top wood shelf may be designed to support and show shelf accessory pieces which are designed and manufacture to fit, weigh and work according to the magnetic capabilities associated with the magnets, for example, Neodymium Magnets being used in the magnet module.

A top wood shelf can be disposed on the top rail, anchored by Neodymium magnets found on the underside of said shelf (Refer to: FIGS. 21A, 21C) and by the Neodymium magnets located and positioned in dado groove channel. The top wood shelf measuring, for example, 2 inches more than the final length of the total measurement calculation of the 2 widths of stiles and the length of one rail piece (stile width+stile width+rail length+2″=final length of said top wood shelf). In some embodiments, the top wood shelf may be, for example, 4⅜″ wide by 1″ thick by the final length of said top wood shelf measurement, with (2) support corbels may be, for example, 2¾″×2¾″×1″, found glued, nailed and attached onto the underside of said top wood shelf.

Drilled and countersunk into the underside of said top wood shelf located 7/16″ of an inch from the underside back edge centered at the 7/16 point are (4) 3/4″ of an inch countersunk drilled out holes ⅛″ of an inch deep spaced apart and positioned to line up with the magnet module placement jig for the ⅜″×¾″ deep dado groove channel of the said frames rail piece. Found contained within the (4) drilled holes are (4) ⅛″×¾″ countersunk magnets, for example, Neodymium Magnets attached and anchored by (4) #6 screws.

In some embodiments, the top wood shelf may be found rough non-sanded, weathered, sanded smooth, lightly distressed, medium distressed, heavy distressed.

In some embodiments, the top wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the top wood shelf may be designed to magnetically anchor to above mentioned magnet module placement jig for the ⅜″×¾″ deep dado groove channel of the said frames rail piece. In some embodiments, the top wood shelf may be designed to support and show shelf accessory pieces which are designed and manufacture to fit, weigh and work according to the magnetic capabilities associated with the magnets, for example, Neodymium Magnets being used in the magnet module.

A top wood shelf can be disposed on the top stile piece (The rotation of the frame creates this side stile application condition; rotating the frame a quarter turn either clockwise of counter clockwise will create this frame layout scenario. It becomes the orientation of the frame because of the rotation of the frame from one display orientation to the other possible display orientation for the frame. This design aspect of the frame may be found on each frame anchored by Neodymium magnets found located on the underside of said shelf (Refer to: FIGS. 21, 21C), and by the Neodymium magnets located and positioned in dado groove channel. The top wood shelf measures 2 inches more than the final length of the stile piece which contains dado groove channel plowed into it. In some embodiments, the top wood shelf may be, for example, 3½″ wide by ¾″ thick by the final length of said top wood shelf measurement, with (2) support corbels may be, for example, 2″×2″×¾″, found glued, nailed and attached onto the underside of said top wood shelf.

Drilled and countersunk into the underside of said top wood shelf located 7/16″ of an inch from the underside back edge centered at the 7/16 point are (4) 3/4″ of an inch countersunk drilled out holes ⅛″ of an inch deep spaced apart and positioned to line up with the magnet module placement jig for the ⅜″×¾″ deep dado groove channel of the said frames stile piece. Found contained within the (4) drilled holes are (4) ⅛″×¾″ countersunk magnets, for example, Neodymium Magnets attached and anchored by (4) #6 screws.

In some embodiments, the top wood shelf may be found rough non-sanded, weathered, sanded smooth, lightly distressed, medium distressed, heavy distressed.

In some embodiments, the top wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the top wood shelf may be designed to magnetically anchor to above mentioned magnet module placement jig for the ⅜″×¾″ deep dado groove channel of the said frames stile piece. In some embodiments, the top wood shelf may be designed to support and show shelf accessory pieces which are designed and manufacture to fit, weigh and work according to the magnetic capabilities associated with the magnets, for example, Neodymium Magnets being used in the magnet module.

A top wood shelf can be disposed onto the top stile piece (The rotation of the frame creates this side stile application condition; rotating the frame a quarter turn either clockwise of counter clockwise will create this frame layout scenario. It becomes the orientation of the frame because of the rotation of the frame from one display orientation to the other possible display orientation for the frame. This design aspect of the frame may be found on each frame anchored by Neodymium magnets found located on the underside of said shelf (Refer to: FIGS. 21, 21C), and by the Neodymium magnets located and positioned in dado groove channel. The top wood shelf measures 2 inches more than the final length of the stile piece which contains dado groove channel plowed into it. In some embodiments, the top wood shelf may be, for example, 4⅜″ wide by ¾″ thick by the final length of said top wood shelf measurement, with (2) support corbels may be, for example, 2¾″×2¾″×¾″, found glued, nailed and attached onto the underside of said top wood shelf.

Drilled and countersunk into the underside of said top wood shelf located 7/16″ of an inch from the underside back edge centered at the 7/16 point are (4) 3/4″ of an inch countersunk drilled out holes ⅛″ of an inch deep spaced apart and positioned to line up with the magnet module placement jig for the ⅜″×¾″ deep dado groove channel of the said frames stile piece. Found contained within the (4) drilled holes are (4) ⅛″×¾″ countersunk magnets, for example, Neodymium Magnets attached and anchored by (4) #6 screws.

In some embodiments, the top wood shelf may be found rough non-sanded, weathered, sanded smooth, lightly distressed, medium distressed, heavy distressed.

In some embodiments, the top wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the top wood shelf may be designed to magnetically anchor to above mentioned magnet module placement jig for the ⅜″×¾″ deep dado groove channel of the said frames stile piece. In some embodiments, the top wood shelf may be designed to support and show shelf accessory pieces which are designed and manufacture to fit, weigh and work according to the magnetic capabilities associated with the magnets, for example, Neodymium Magnets being used in the magnet module.

A top wood shelf can be disposed onto the top stile piece (The rotation of the frame creates this side stile application condition; rotating the frame a quarter turn either clockwise of counter clockwise will create this frame layout scenario. It becomes the orientation of the frame because of the rotation of the frame from one display orientation to the other possible display orientation for the frame. This design aspect of the frame may be found on each frame anchored by Neodymium magnets found located on the underside of said shelf (Refer to: FIGS. 21, 21C), and by the Neodymium magnets located and positioned in dado groove channel. The top wood shelf measures 2 inches more than the final length of the stile piece which contains dado groove channel plowed into it. In some embodiments, the top wood shelf may be, for example, 3½″ wide by 1″ thick by the final length of said top wood shelf measurement, with (2) support corbels may be, for example, 2″×2″×1″, found glued, nailed and attached onto the underside of said top wood shelf.

Drilled and countersunk into the underside of said top wood shelf located 7/16″ of an inch from the underside back edge centered at the 7/16 point are (4) ¾″ of an inch countersunk drilled out holes ⅛″ of an inch deep spaced apart and positioned to line up with the magnet module placement jig for the ⅜″×¾″ deep dado groove channel of the said frames stile piece. Found contained within the (4) drilled holes are (4) ⅛″×¾″ countersunk magnets, for example, Neodymium Magnets attached and anchored by (4) #6 screws.

In some embodiments, the top wood shelf may be found rough non-sanded, weathered, sanded smooth, lightly distressed, medium distressed, heavy distressed.

In some embodiments, the top wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the top wood shelf may be designed to magnetically anchor to above mentioned magnet module placement jig for the ⅜″×¾″ deep dado groove channel of the said frames stile piece. In some embodiments, the top wood shelf may be designed to support and show shelf accessory pieces which are designed and manufacture to fit, weigh and work according to the magnetic capabilities associated with the magnets, for example, Neodymium Magnets being used in the magnet module.

A top wood shelf can be disposed onto the top stile piece (The rotation of the frame creates this side stile application condition; rotating the frame a quarter turn either clockwise of counter clockwise will create this frame layout scenario. It becomes the orientation of the frame because of the rotation of the frame from one display orientation to the other possible display orientation for the frame. This design aspect of the frame may be found on each frame anchored by Neodymium magnets found located on the underside of said shelf (Refer to: FIGS. 21, 21C), and by the Neodymium magnets located and positioned in dado groove channel. The top wood shelf measures 2 inches more than the final length of the stile piece which contains dado groove channel plowed into it. In some embodiments, the top wood shelf may be, for example, 4⅜″ wide by 1″ thick by the final length of said top wood shelf measurement, with (2) support corbels may be, for example, 2¾″×2¾″×1″, found glued, nailed and attached onto the underside of said top wood shelf.

Drilled and countersunk into the underside of said top wood shelf located 7/16″ of an inch from the underside back edge centered at the 7/16 point are (4) 3/4″ of an inch countersunk drilled out holes ⅛″ of an inch deep spaced apart and positioned to line up with the magnet module placement jig for the ⅜″×¾″ deep dado groove channel of the said frames stile piece. Found contained within the (4) drilled holes are (4) ⅛″×¾″ countersunk magnets, for example, Neodymium Magnets attached and anchored by (4) #6 screws.

In some embodiments, the top wood shelf may be found rough non-sanded, weathered, sanded smooth, lightly distressed, medium distressed, heavy distressed.

In some embodiments, the top wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the top wood shelf may be designed to magnetically anchor to above mentioned magnet module placement jig for the ⅜″×¾″ deep dado groove channel of the said frames stile piece. In some embodiments, the top wood shelf may be designed to support and show shelf accessory pieces which are designed and manufacture to fit, weigh and work according to the magnetic capabilities associated with the magnets, for example, Neodymium Magnets being used in the magnet module

A top wood shelf can be disposed above the lower stile (The rotation of the frame creates this lower stile application condition; rotating the frame a quarter turn either clockwise of counter clockwise will create this frame layout scenario. It becomes the orientation of the frame because of the rotation of the frame from one display orientation to the other possible display orientation for the frame. This design aspect of the frame may be found on each frame and anchored to the woven metal canvas by Neodymium magnets found on the back edge of said shelf as shown, for example, in FIGS. 21B and 21C, measuring, for example, one inch less than the total length of the side stile piece. In some embodiments, the bottom wood shelf may be, for example, 5⅜″ wide by ¾″ thick by the final length of said bottom wood shelf, with (2) support corbels may be, for example, 3¾″×3¾″×¾″ as shown, for example, in FIGS. 21B and 21C, found nailed, glued and attached onto the underside of said bottom wood shelf.

In some embodiments, drilled into the back edge of said bottom wood shelf, centered within the thickness of said bottom wood shelf are (5) ¾ inch countersunk drilled holes measuring ⅛″ of an inch deep spaced apart and positioned to line up with the above mentioned woven metal canvas. Found contained within the (5) countersunk drilled holes are (5) ⅛″×¾″ countersunk magnets, for example, Neodymium Magnets attached and anchored by (5) #6 screws.

In some embodiments, said bottom wood shelf may be found rough non-sanded, weathered, sanded smooth, lightly distressed, medium distressed, heavy distressed.

In some embodiments, said bottom wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, said bottom wood shelf may be designed to magnetically anchor to above mentioned woven metal canvas and to support and show shelf accessory pieces which are designed and manufacture to fit, weigh and work according to the magnetic capabilities associated with the magnets, for example, Neodymium Magnets being used.

In some embodiments, magnets found in said shelf work in combination with the said woven metal canvas. When the magnets come into contact with the said woven metal canvas a magnetic force may be created, a force which may be an extremely strong holding strength. This magnetic force which when present results in the availability of said shelf being placed and held onto the surface of said woven metal canvas. This said shelf then becomes an accessory piece to the said frame and said woven metal canvas, which can and will support and hold many different accessory pieces placed for show, display, and arrangement etc. The Magnets also create a magnetic force which also allows for the placement of heavy accessory piece on said shelf

10A bottom wood shelf found located above the lower stile (The rotation of the frame creates this lower stile application condition; rotating the frame a quarter turn either clockwise of counter clockwise will create this frame layout scenario. It becomes the orientation of the frame because of the rotation of the frame from one display orientation to the other possible display orientation for the frame. This design aspect of the frame may be found on each frame and anchored to the woven metal canvas by Neodymium magnets found on the back edge of said shelf as shown, for example, in FIGS. 21B, 21C, measuring, for example, one inch less than the total length of the side stile piece. In some embodiments, the bottom wood shelf may be, for example, 5⅜″ wide by 1″ thick by the final length of said bottom wood shelf, with (2) support corbels may be, for example, 3¾″×3¾″×1″ as shown, for example, in FIGS. 21B and 21C, found nailed, glued and attached onto the underside of said bottom wood shelf.

Drilled into the back edge of said bottom wood shelf, centered within the thickness of said bottom wood shelf are (5) ¾ inch countersunk drilled holes measuring, for example, ⅛″ of an inch deep spaced apart and positioned to line up with the above mentioned woven metal canvas. Found contained within the (5) countersunk drilled holes are (5) ⅛″×¾″ countersunk magnets, for example, Neodymium Magnets attached and anchored by (5) #6 screws.

In some embodiments, the bottom wood shelf may be found rough non-sanded, weathered, sanded smooth, lightly distressed, medium distressed, heavy distressed.

In some embodiments, the bottom wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the bottom wood shelf may be designed to magnetically anchor to above mentioned woven metal canvas and to support and show shelf accessory pieces which are designed and manufacture to fit, weigh and work according to the magnetic capabilities associated with the magnets, for example, Neodymium Magnets being used.

In some embodiments, the magnets found in said shelf work in combination with the said woven metal canvas. When the Neodymium magnets come into contact with the said woven metal canvas a magnetic force may be created, a force which may be an extremely strong holding strength. This magnetic force which when present results in the availability of said shelf being placed and held onto the surface of said woven metal canvas. This said shelf then becomes an accessory piece to the said frame and said woven metal canvas, which can and will support and hold many different accessory pieces placed for show, display, and arrangement etc. The magnets, for example, Neodymium Magnets also create a magnetic force which also allows for the placement of heavy accessory piece on said shelf

11A bottom wood shelf found located above the lower stile (The rotation of the frame creates this lower stile application condition; rotating the frame a quarter turn either clockwise of counter clockwise will create this frame layout scenario. It becomes the orientation of the frame because of the rotation of the frame from one display orientation to the other possible display orientation for the frame. This design aspect of the frame may be found on each frame and anchored to the woven metal canvas by Neodymium magnets found on the back edge of said shelf (Refer to: FIGS. 21B, 21E, measuring, for example, 7 inches less than the total length of the side stile piece. In some embodiments, the bottom wood shelf may be, for example, 5⅜″ wide by ¾″ thick by the final length of said bottom wood shelf, with (2) support corbels may be, for example, 3¾″×3¾″×¾″ as shown, for example, in FIGS. 21B, 21E, found nailed, glued and attached onto the underside of said bottom wood shelf.

Drilled into the back edge of said bottom wood shelf, centered within the thickness of said bottom wood shelf are (5) ¾ inch countersunk drilled holes measuring, for example, ⅛″ of an inch deep spaced apart and positioned to line up with the above mentioned woven metal canvas. Found contained within the (5) countersunk drilled holes are (5) ⅛″×¾″ countersunk magnets, for example, Neodymium Magnets attached and anchored by (5) #6 screws.

In some embodiments, the bottom wood shelf may be found rough non-sanded, weathered, sanded smooth, lightly distressed, medium distressed, heavy distressed.

In some embodiments, the bottom wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the bottom wood shelf may be designed to magnetically anchor to above mentioned woven metal canvas and to support and show shelf accessory pieces which are designed and manufacture to fit, weigh and work according to the magnetic capabilities associated with the magnets, for example, Neodymium Magnets being used.

In some embodiments, the magnets found in said shelf work in combination with the said woven metal canvas. When the Neodymium magnets come into contact with the said woven metal canvas a magnetic force may be created, a force which may be an extremely strong holding strength. This magnetic force which when present results in the availability of said shelf being placed and held onto the surface of said woven metal canvas. This said shelf then becomes an accessory piece to the said frame and said woven metal canvas, which can and will support and hold many different accessory pieces placed for show, display, and arrangement etc. The magnets, for example, Neodymium Magnets also create a magnetic force which also allows for the placement of heavy accessory piece on said shelf.

A top wood shelf can be disposed above the lower stile (The rotation of the frame creates this lower stile application condition; rotating the frame a quarter turn either clockwise of counter clockwise will create this frame layout scenario. It becomes the orientation of the frame because of the rotation of the frame from one display orientation to the other possible display orientation for the frame. This design aspect of the frame may be found on each frame and anchored to the woven metal canvas by Neodymium magnets found on the back edge of said shelf (Refer to: FIGS. 21B, 21, measuring 7 inches less than the total length of the side stile piece. In some embodiments, the bottom wood shelf may be, for example, 5⅜″ wide by 1″ thick by the final length of said bottom wood shelf, with (2) support corbels may be, for example, 3¾″×3¾″×1″ as shown, for example, in FIGS. 21B, 21E, found nailed, glued and attached onto the underside of said bottom wood shelf.

In some embodiments, the top wood shelf may be designed to magnetically anchor to above mentioned magnet module placement jig for the ⅜″×¾″ deep dado groove channel of the said frames rail piece. In some embodiments, the top wood shelf may be designed to support and show shelf accessory pieces which are designed and manufacture to fit, weigh and work according to the magnetic capabilities associated with the magnets, for example, Neodymium Magnets being used in the magnet module. In some embodiments, the bottom wood shelf may be found rough non-sanded, weathered, sanded smooth, lightly distressed, medium distressed, heavy distressed.

In some embodiments, the bottom wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the bottom wood shelf may be designed to magnetically anchor to above mentioned woven metal canvas and to support and show shelf accessory pieces which are designed and manufacture to fit, weigh and work according to the magnetic capabilities associated with the magnets, for example, Neodymium Magnets being used.

In some embodiments, the magnets found in said shelf work in combination with the said woven metal canvas. When the magnets come into contact with the said woven metal canvas a magnetic force may be created, a force which may be an extremely strong holding strength. This magnetic force which when present results in the availability of said shelf being placed and held onto the surface of said woven metal canvas. This said shelf then becomes an accessory piece to the said frame and said woven metal canvas, which can and will support and hold many different accessory pieces placed for show, display, and arrangement etc. The Magnets also create a magnetic force which also allows for the placement of heavy accessory piece on said shelf

A top wood shelf can be disposed above the lower rail and anchored to the woven metal canvas by Neodymium magnets found on the back edge of said bottom wood shelf as shown, for example, in FIGS. 21B, 21E. The bottom wood shelf measuring, for example, 7 inches less than the final length of the total measurement calculation of the 2 widths of stiles and the length of one rail piece (stile width+stile width+rail length−7″=final length of said bottom wood shelf). In some embodiments, the bottom wood shelf may be, for example, 5⅜″ wide by ¾″ thick by the final length of said bottom wood shelf measurement, with (2) support corbels may be, for example, 3¾″×3¾″×¾″, found nailed, glued and attached onto the underside of said bottom wood shelf.

Drilled into the back edge of said bottom wood shelf, centered within the thickness of said bottom wood shelf are (5) ¾ inch countersunk drilled holes measuring, for example, ⅛″ of an inch deep spaced apart and positioned to line up with the above mentioned woven metal canvas. Found contained within the (5) countersunk drilled holes are (5) ⅛″×¾″ countersunk magnets, for example, Neodymium Magnets attached and anchored by (5) #6 screws.

In some embodiments, the bottom wood shelf may be found rough non-sanded, weathered, sanded smooth, lightly distressed, medium distressed, heavy distressed.

In some embodiments, the bottom wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the bottom wood shelf may be designed to magnetically anchor to above mentioned woven metal canvas and to support and show shelf accessory pieces which are designed and manufacture to fit, weigh and work according to the magnetic capabilities associated with the magnets, for example, Neodymium Magnets being used.

In some embodiments, the magnets found in said shelf work in combination with the said woven metal canvas. When the Neodymium magnets come into contact with the said woven metal canvas a magnetic force may be created, a force which may be an extremely strong holding strength. This magnetic force which when present results in the availability of said shelf being placed and held onto the surface of said woven metal canvas. This said shelf then becomes an accessory piece to the said frame and said woven metal canvas, which can and will support and hold many different accessory pieces placed for show, display, and arrangement etc. The magnets, for example, Neodymium Magnets also create a magnetic force which also allows for the placement of heavy accessory piece on said shelf

A top wood shelf can be disposed above the lower rail and anchored to the woven metal canvas by Neodymium magnets found on the back edge of said bottom wood shelf as shown, for example, in FIGS. 21B, 21E. The bottom wood shelf measuring, for example, 7 inches less than the final length of the total measurement calculation of the 2 widths of stiles and the length of one rail piece (stile width+stile width+rail length−7″=final length of said bottom wood shelf). In some embodiments, the bottom wood shelf may be, for example, 5⅜″ wide by 1″ thick by the final length of said bottom wood shelf measurement, with (2) support corbels may be, for example, 3¾″×3¾″×1″, found nailed, glued and attached onto the underside of said bottom wood shelf.

Drilled into the back edge of said bottom wood shelf, centered within the thickness of said bottom wood shelf are (5) ¾ inch countersunk drilled holes measuring, for example, ⅛″ of an inch deep spaced apart and positioned to line up with the above mentioned woven metal canvas. Found contained within the (5) countersunk drilled holes are (5) ⅛″×¾″ countersunk magnets, for example, Neodymium Magnets attached and anchored by (5) #6 screws.

In some embodiments, the bottom wood shelf may be found rough non-sanded, weathered, sanded smooth, lightly distressed, medium distressed, heavy distressed.

In some embodiments, the bottom wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the bottom wood shelf may be designed to magnetically anchor to above mentioned woven metal canvas and to support and show shelf accessory pieces which are designed and manufacture to fit, weigh and work according to the magnetic capabilities associated with the magnets, for example, Neodymium Magnets being used.

In some embodiments, the magnets found in said shelf work in combination with the said woven metal canvas. When the Neodymium magnets come into contact with the said woven metal canvas a magnetic force may be created, a force which may be an extremely strong holding strength. This magnetic force which when present results in the availability of said shelf being placed and held onto the surface of said woven metal canvas. This said shelf then becomes an accessory piece to the said frame and said woven metal canvas, which can and will support and hold many different accessory pieces placed for show, display, and arrangement etc. The magnets, for example, Neodymium Magnets also create a magnetic force which also allows for the placement of heavy accessory piece on said shelf

A top wood shelf can be disposed above the lower rail and anchored to the woven metal canvas by Neodymium magnets found on the back edge of said bottom wood shelf as shown, for example, in FIGS. 21B, 21C. The bottom wood shelf measuring, for example, 1 inches less than the final length of the total measurement calculation of the 2 widths of stiles and the length of one rail piece (stile width+stile width+rail length−1″=final length of said bottom wood shelf). In some embodiments, the bottom wood shelf may be, for example, 5⅜″ wide by ¾″ thick by the final length of said bottom wood shelf measurement, with (2) support corbels may be, for example, 3¾″×3¾″×¾″, found nailed, glued and attached onto the underside of said bottom wood shelf.

Drilled into the back edge of said bottom wood shelf, centered within the thickness of said bottom wood shelf are (5) ¾ inch countersunk drilled holes measuring, for example, ⅛″ of an inch deep spaced apart and positioned to line up with the above mentioned woven metal canvas. Found contained within the (5) countersunk drilled holes are (5) ⅛″×¾″ countersunk magnets, for example, Neodymium Magnets attached and anchored by (5) #6 screws.

In some embodiments, the bottom wood shelf may be found rough non-sanded, weathered, sanded smooth, lightly distressed, medium distressed, heavy distressed.

In some embodiments, the bottom wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the bottom wood shelf may be designed to magnetically anchor to above mentioned woven metal canvas and to support and show shelf accessory pieces which are designed and manufacture to fit, weigh and work according to the magnetic capabilities associated with the magnets, for example, Neodymium Magnets being used.

In some embodiments, the magnets found in said shelf work in combination with the said woven metal canvas. When the Neodymium magnets come into contact with the said woven metal canvas a magnetic force may be created, a force which may be an extremely strong holding strength. This magnetic force which when present results in the availability of said shelf being placed and held onto the surface of said woven metal canvas. This said shelf then becomes an accessory piece to the said frame and said woven metal canvas, which can and will support and hold many different accessory pieces placed for show, display, and arrangement etc. The magnets, for example, Neodymium Magnets also create a magnetic force which also allows for the placement of heavy accessory piece on said shelf

A top wood shelf can be disposed above the lower rail and anchored to the woven metal canvas by Neodymium magnets found on the back edge of said bottom wood shelf as shown, for example, in FIGS. 21B, 21C. The bottom wood shelf measuring, for example, 1 inches less than the final length of the total measurement calculation of the 2 widths of stiles and the length of one rail piece (stile width+stile width+rail length−1″=final length of said bottom wood shelf). In some embodiments, the bottom wood shelf may be, for example, 5⅜″ wide by 1″ thick by the final length of said bottom wood shelf measurement, with (2) support corbels may be, for example, 3¾″×3¾″×1″, found nailed, glued and attached onto the underside of said bottom wood shelf.

Drilled into the back edge of said bottom wood shelf, centered within the thickness of said bottom wood shelf are (5) ¾ inch countersunk drilled holes measuring, for example, ⅛″ of an inch deep spaced apart and positioned to line up with the above mentioned woven metal canvas. Found contained within the (5) countersunk drilled holes are (5) ⅛″×¾″ countersunk magnets, for example, Neodymium Magnets attached and anchored by (5) #6 screws.

In some embodiments, the bottom wood shelf may be found rough non-sanded, weathered, sanded smooth, lightly distressed, medium distressed, heavy distressed.

In some embodiments, the bottom wood shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the bottom wood shelf may be designed to magnetically anchor to above mentioned woven metal canvas and to support and show shelf accessory pieces which are designed and manufacture to fit, weigh and work according to the magnetic capabilities associated with the magnets, for example, Neodymium Magnets being used.

In some embodiments, the magnets found in said shelf work in combination with the said woven metal canvas. When the Neodymium magnets come into contact with the said woven metal canvas a magnetic force may be created, a force which may be an extremely strong holding strength. This magnetic force which when present results in the availability of said shelf being placed and held onto the surface of said woven metal canvas. This said shelf then becomes an accessory piece to the said frame and said woven metal canvas, which can and will support and hold many different accessory pieces placed for show, display, and arrangement etc. The magnets, for example, Neodymium Magnets also create a magnetic force which also allows for the placement of heavy accessory piece on said shelf

In some embodiments, a Wood Woven Metal Canvas Shelf can be used, as shown, for example, in FIG. 21D. In some embodiments, the wood woven metal canvas shelf may be, for example, 5½″ wide by 1″ thick by 11 inch in length, with (2) support corbels may be, for example, 2¾″×2¾″×¾″, found nailed, glued and attached onto the underside of said wood woven metal canvas shelf.

Drilled into the back edge of said bottom wood shelf, centered within the thickness of said wood woven metal shelf are, for example, (3) ¾ inch countersunk drilled holes measuring, for example, ⅛″ of an inch deep spaced apart and positioned to line up with the above mentioned woven metal canvas. Found contained within the (3) countersunk drilled holes are (3) ⅛″×¾″ countersunk magnets, for example, Neodymium Magnets attached and anchored by (5) #6 screws.

In some embodiments, the wood woven metal canvas shelf may be found rough non-sanded, weathered, sanded smooth, lightly distressed, medium distressed, heavy distressed.

In some embodiments, the wood woven metal canvas shelf may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the wood woven metal canvas shelf may be designed to magnetically anchor to above mentioned woven metal canvas and to support and show shelf accessory pieces which are designed and manufacture to fit, weigh and work according to the magnetic capabilities associated with the magnets, for example, Neodymium Magnets being used.

In some embodiments, the magnets found in said shelf work in combination with the said woven metal canvas. When the Neodymium magnets come into contact with the said woven metal canvas a magnetic force may be created, a force which may be an extremely strong holding strength. This magnetic force which when present results in the availability of said shelf being placed and held onto the surface of said woven metal canvas. This said shelf then becomes an accessory piece to the said frame and said woven metal canvas, which can and will support and hold many different accessory pieces placed for show, display, and arrangement etc. The magnets, for example, Neodymium Magnets also create a magnetic force which also allows for the placement of heavy accessory piece on said shelf

FIGS. 22 and 22A show a Floral Arrangement magnetic shelf holder according to some embodiments of the invention. The floral arrangement magnetic shelf measuring, for example, 26 inch long by 4¾″ by 4¾″ deep.

For example, drilled into the back of the floral arrangement ledgers, centered within the 1″ ledgers and space according to the cad drawing are (7) ¾ inch countersunk drilled holes measuring, for example, ⅛″ of an inch deep spaced apart and positioned to anchor and line up with the above mentioned woven metal canvas. Found contained within the (7) countersunk drilled holes are (7) ⅛″×¾″ countersunk magnets, for example, Neodymium Magnets attached and anchored by (7) #6 screws.

In some embodiments, the floral arrangement magnetic shelf holder may be found rough non-sanded, weathered, sanded smooth, lightly distressed, medium distressed, heavy distressed.

In some embodiments, the floral arrangement magnetic shelf holder may be sealed and finished with either one or more of the following: a primer paint configuration, a sealer, a pigmented paint(s), a pigmented lacquer(s), a pigmented stain(s), a pigmented stain(s) and glaze, vinyl lacquer(s), vinyl lacquer(s) and glaze. A lacquer finish may be applied as a final top coat in either, High Gloss, Semi-Gloss, Satin or Flat.

In some embodiments, the floral arrangement magnetic shelf holder may be designed to magnetically anchor to above mentioned woven metal canvas and to support and show dried floral arrangements, living plant and flower arrangements, plastic floral arrangements and any other accessory pieces which are designed and manufacture to fit, weigh and work according to the magnetic capabilities associated with the magnets, for example, Neodymium Magnets being used.

In some embodiments, the magnets found in said floral arrangement shelf work in combination with the said woven metal canvas. When the Neodymium magnets come into contact with the said woven metal canvas a magnetic force may be created, a force which may be an extremely strong holding strength. This magnetic force which when present results in the availability of said shelf being placed and held onto the surface of said woven metal canvas. This said shelf then becomes an accessory piece to the said frame and said woven metal canvas, which can and will support and hold many different accessory pieces placed for show, display, and arrangement etc. The magnets, for example, Neodymium Magnets also create a magnetic force which also allows for the placement of heavy accessory piece on and in said shelf.

FIG. 25 illustrates a woven magnet board with vertical strips that are spread out relative to one another according to at least one embodiment described herein.

FIG. 26 illustrates a woven magnet boards with vertical strips positioned next to one another according to at least one embodiment described herein.

FIG. 27 illustrates a flowchart of an example process for creating a patina on a metallic canvas according to at least one embodiment described herein. Any of the following blocks can occur in any order and blocks can be removed and additional blocks added. At block 305, metal strips are formed. The metal strips can be formed from any type of metal and can be formed in any width or length. The metal strips may include any steal or metallic alloy. Fore example the strips may include stainless steel, galvanized steel, cold rolled steel, hot rolled steel, etc.

At block 310, the metal strips can be sand blasted, for example, to remove an outer oxidation layer.

At block 315, the metal strips can be woven together to create a woven board, for example, as shown above. The weave can be made in any pattern. At block 320 some or all of the strips can be secured together, for example, welded or glued together.

At block 325, a pre oxidization treatment can be applied to the woven strips. The pre-oxidization treatment can include water, salt water, acid, vinegar, citric acid, and/or ammonium. Various other oxidation agents may be used.

At block 330, an organic material may be applied to the woven metal. For example, the organic material may include leaves, saw dust, grass clippings, leather, fabric, flowers, dirt, mud, rocks, minerals, herbs, fruit, vegetables, fertilizer, dung, fur, bark, etc. The organic material may be placed on top of the woven metal or pressed on the woven metal. The organic material may be soaked in water and/or the pre-oxidization treatment prior to being placed on the woven metal.

At block 335, the woven metal may be allowed to oxidize. The woven material may be allowed to oxidize with the organic material so that the organic material produces patterns, colors, and/or textures on the woven metal during oxidization. Block 335 may occur in a heated or humidified chamber or room. Various other environmental conditions may also be used to encourage oxidization.

At block 340, after the oxidization period has ended, the organic material and/or any free rust or oxidization material may be removed from the woven metal. For example, the woven metal may be sanded with sand paper, or buffed with steel wool.

At block 345, an oxidation stopper may be applied to the woven metal. Any type of material that is known to stop or slow down the oxidization process may be used; for example, Penetrol or vinegar. A water wash may also be used.

At block 350, a finish can be applied to the woven metal. The finish may be, for example, a lacquer, a sealant, a urethane material, a shellac, varnish, varnish, polyurethane, epoxy, etc.

At block 355, the woven metal may attached with a supportive skeleton. Any type of structural skeleton may be used. In some embodiments, the woven metal may be cut to size prior to being attached with a supportive skeleton.

At block 360, the woven metal may attached with a frame. Any type or size of frame may be used.

As noted above, these blocks may occur in any order. Moreover, some blocks may be omitted and additional blocks added. FIG. 28 is an example of this. This figure illustrates a flowchart of an example process for creating a patina on a metallic canvas according to at least one embodiment described herein. In this process, block 315 is moved between block 345 and 350. That is, much of the process occurs on the metals strips prior to being woven at block 315. In other embodiments, block 315 may be moved to any other location.

FIG. 29 illustrates a flowchart of an example process for creating a patina having a rusted paint look on a metallic canvas according to at least one embodiment described herein. Blocks 305, 310, 315 and 320 may be similar to the blocks described above. At block 525 a water-based paint may be applied to the woven metal. This water-based paint may be applied to the woven strips or to unwoven strips. Blocks 335, 340, 345, 350, 355, and 360 may be the same as the blocks described above. Any of these blocks may be omitted. Moreover, some blocks may be omitted and additional blocks added.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

That which is claimed:

1. A woven metal board comprising:
a frame;
a plurality of horizontal metallic strips disposed within the frame; and
a plurality of vertical metallic strips disposed within the frame and woven together with the horizontal metallic strips.

2. The woven metal board according to claim 1, wherein the horizontal metallic strips and/or the vertical metallic strips have been oxidized.

3. The woven metal board according to claim 1, wherein the horizontal metallic strips and/or the vertical metallic strips have been rust treated.

4. The woven metal board according to claim 1, wherein the horizontal metallic strips and/or the vertical metallic strips have been rust treated with an oxidizing agent and an organic material.

5. The woven metal board according to claim 1, wherein the frame includes a plurality of channels with at least one magnet disposed within the channels.

6. A method of forming a woven metal board, the method comprising:
weaving a plurality of metal strips into a woven metallic canvas;
applying an oxidizing agent to the woven metallic canvas;
allowing the woven metallic canvas to oxidize; and
attaching the woven metallic canvas to a frame.

7. The method according to claim 6, further comprising applying organic material to the woven metallic canvas prior to allowing the woven metallic canvas to oxidize.

8. The method according to claim 6, further comprising applying an oxidization stopper.

9. The method according to claim 6, further comprising, further comprising applying a finish.

10. A method of forming a woven metal board, the method comprising:
weaving a plurality of metal strips into a woven metallic canvas;
applying a paint to the woven metallic canvas;
allowing the woven metallic canvas to oxidize; and
attaching the woven metallic canvas to a frame.

11. The method according to claim 10, wherein the paint comprises at least one of a water based paint, a lacquer, a clear coat, and a polyurethane coating.

12. The method according to claim 10, further comprising applying a sealant coat to the woven metallic canvas after allowing the woven metallic canvas to oxidize.
